(19) United States
(12) Patent Application Publication
(10) Pub. No.: US 2017/0044423 A1
(43) Pub. Date: Feb. 16, 2017

(54) GEMINI EPOXIDE SURFACTANT COMPOSITIONS

(71) Applicant: BOARD OF REGENTS, THE UNIVERSITY OF TEXAS SYSTEM, Austin, TX (US)

(72) Inventors: Upali A. Weerasooriya, Austin, TX (US); Gary A. Pope, Cedar Park, TX (US); Mukul M. Sharma, Austin, TX (US); Jiajia Cai, Austin, TX (US)

(73) Assignee: BOARD OF REGENTS, THE UNIVERSITY OF TEXAS SYSTEM, Austin, TX (US)

(21) Appl. No.: 15/304,703

(22) PCT Filed: Apr. 16, 2015
(86) PCT No.: PCT/US15/26247

§ 371 Date: Oct. 17, 2016

Related U.S. Application Data
(60) Provisional application No. 61/980,511, filed on Apr. 16, 2014.

(51) Int. Cl. C09K 8/584; C07F 9/201; C09K 8/588

(52) U.S. Cl. CPC C09K 8/584; C09K 8/588; C07F 9/2015

(57) ABSTRACT

Provided herein are inter alia novel compositions and methods having application in the field of enhanced oil recovery. In particular, the Gemini compounds disclosed herein and mixtures thereof presented herein can be used, inter alia, for the recovery of a large range of crude oil compositions from challenging reservoirs

### CROSS-REFERENCE TO RELATED APPLICATIONS

This application claims benefit of U.S. Provisional Application No. 61/980,511, filed Apr. 16, 2014, which is hereby incorporated herein by reference in its entirety.

### BACKGROUND

Enhanced Oil Recovery (abbreviated EOR) refers to techniques for increasing the amount of unrefined petroleum, or crude oil that may be extracted from an oil reservoir (e.g. an oil field). Using EOR, 40-60% of the reservoir's original oil can typically be extracted compared with only 20-40% using primary and secondary recovery (e.g. by water injection or natural gas injection). Enhanced oil recovery may also be referred to as improved oil recovery or tertiary recovery (as opposed to primary and secondary recovery).

Enhanced oil recovery may be achieved by a variety of methods including miscible gas injection (which includes carbon dioxide flooding), chemical injection (which includes polymer flooding, alkaline flooding and surfactant flooding), microbial injection, or thermal recovery (which includes cyclic steam, steam flooding, and fire flooding). The injection of various chemicals, usually as dilute aqueous solutions, has been used to improve oil recovery. Injection of alkaline or caustic solutions into reservoirs with oil that has organic acids naturally occurring in the oil will result in the production of soap that may lower the interfacial tension enough to increase production. Injection of a dilute solution of a water soluble polymer to increase the viscosity of the injected water can increase the amount of oil recovered in some formations. Dilute solutions of surfactants such as petroleum sulfonates may be injected to lower the interfacial tension or capillary pressure that impedes oil droplets from moving through a reservoir. Special formulations of oil, water and surfactant microemulsions, have also proven useful. Application of these methods is usually limited by the cost of the chemicals and their adsorption and loss onto the rock of the oil containing formation.

Some unrefined petroleum contains carboxylic acids having, for example, C₁₁ to C₂₀ alkyl chains, including napthenic acid mixtures. The recovery of such “reactive” oils may be performed using alkali (e.g. NaOH or Na₂CO₃) in a surfactant composition. The alkali reacts with the acid in the reactive oil to form soap. These soaps serve as an additional source of surfactants enabling the use of much lower level of surfactants initially added to affect enhanced oil recovery (EOR). However, when the available water supply is hard, the added alkali causes precipitation of cations, such as Ca⁺² or Mg⁺². In order to prevent such precipitation a strong chelant such as EDTA may be required in the surfactant composition. Alternatively, water softening processes may be used. Both of these processes add to the cost of the chemical EOR process in varying degrees.

Therefore, there is a need in the art for cost effective methods for enhanced oil recovery using chemical injection. Provided herein are methods and compositions addressing these and other needs in the art.

### SUMMARY

In one aspect, a compound having the formula:

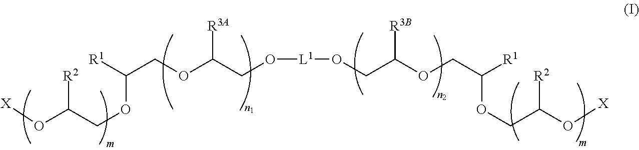

provided. In formula (I) R¹ is substituted or unsubstituted alkyl, substituted or unsubstituted heteroalkyl, substituted or unsubstituted cycloalkyl, substituted or unsubstituted heterocycloalkyl, substituted or unsubstituted aryl or substituted or unsubstituted heteroaryl. R² is hydrogen or substituted or unsubstituted alkyl. R^{3A} and R^{3B} are independently hydrogen or substituted or unsubstituted alkyl. L¹ is substituted or unsubstituted alkylene, substituted or unsubstituted cycloalkylene or substituted or unsubstituted arylene. m is an integer of 1 to 200. n₁ and n₂ are independently integers from 0 to 20. X is —SO₃-M+, —CH₂C(O)O-M⁺, —SO₃H or —CH₂C(O)OH and M⁺ is a monovalent, divalent or trivalent cation.

In another aspect, an aqueous composition including a co-surfactant and a compound as provided herein including embodiments thereof is provided.

In another aspect, an emulsion composition including an unrefined petroleum phase and a compound as provided herein including embodiments thereof is provided.

In another aspect, a method of displacing an unrefined petroleum material in contact with a solid material is provided. The method includes contacting an unrefined petroleum material with an aqueous composition including water, a co-surfactant and a compound as provided herein including embodiments thereof, wherein the unrefined petroleum material is in contact with a natural solid material. The unrefined petroleum material is allowed to separate from the solid material thereby displacing the unrefined petroleum material in contact with the solid material.

In another aspect, a method of converting an unrefined petroleum acid into a surfactant is provided. The method includes contacting a petroleum material with an aqueous composition thereby forming an emulsion in contact with the petroleum material, wherein the aqueous composition includes a compounds as provided herein including embodiments thereof and a co-surfactant. An unrefined petroleum acid within the unrefined petroleum material is allowed to enter into the emulsion, thereby converting the unrefined petroleum acid into a surfactant.

In another aspect, a method of making a compound as provided herein including embodiments thereof is provided. The method includes contacting an epoxide compound with a diol thereby forming an epoxide-diol mixture. The temperature of the epoxide-diol mixture is increased thereby an epoxide-diol adduct is formed. The epoxide-diol adduct is contacted with a C₁-C₄ alkoxide thereby forming an alkoxylated hydrophobe and the alkoxylated hydrophobe is contacted (converted) with one or more anionic functional groups thereby forming the compound.

### DESCRIPTION OF DRAWINGS

FIG. 1. Solubilization ratio plot for oil #1 (30%) at 100° C. after 10 days. The surfactant composition includes 0.8% C₁₈-2EO—C₁₈-10PO-2(SO₄Na) (compound of formula (I), where 2EO refers to diethylene glycol (DEG)) and 0.2% C₂₈-45PO-30EO-carboxylate. The black arrow in the histogram pointing from left to right indicates the aqueous stability at 80,000 ppm (TDS) of 2% Na₂CO₃ and NaCl.

FIG. 2. Solubilization ratio plot for oil #2 (30%) at 78° C. after 6 days. The surfactant composition includes 0.8% C₁₈-2EO—C₁₈-10PO-2(SO₄Na) and 0.2% C₂₈-45PO-30EO-carboxylate. The black arrow in the histogram pointing from left to right indicates the aqueous stability at 95,000 ppm (TDS) of 2% Na₂CO₃ and NaCl.

FIG. 3. Solubilization ratio plot for oil #3 (58%) at 58° C. after 14 days. The surfactant composition includes 1% C₁₈-2EO—C₁₈-10PO-2(SO₄Na). The black arrow in the histogram pointing from left to right indicates the aqueous stability at 85,000 ppm (TDS) of 2% Na₂CO₃ and NaCl.

FIG. 4. Solubilization ratio plot for oil #4 (30%) at 58° C. after 13 days. The surfactant composition includes 0.8% C₁₈-2EO—C₁₈-10PO-2(SO₄Na), 0.2% C₂₈-45PO-30EO-carboxylate and 0.5% IBA. The black arrow in the histogram pointing from left to right indicates the aqueous stability at 10,000 ppm (TDS) of 2% Na₂CO₃ and NaCl.

FIG. 5. Solubilization ratio plot for oil #4 (30%) at 58° C. after 13 days. The surfactant composition includes 0.8% C₁₈-2EO—C₁₈-10PO-2(SO₄Na), 0.2% C₁₆/C₁₆-35PO-20EO-sulfate and 0.5% IBA. The black arrow in the histogram pointing from left to right indicates the aqueous stability at 10,000 ppm (TDS) of 2% Na₂CO₃ and NaCl.

FIG. 6. Solubilization ratio plot for oil #5 (30%) at 55° C. after 20 days. The surfactant composition includes 0.8% C₁₈-2EO—C₁₈-10PO-2(SO₄Na), 0.2% C₂₈-45PO-30EO-carboxylate and 0.5% IBA. The black arrow in the histogram pointing from left to right indicates the aqueous stability at 105,000 ppm (TDS) of 2% Na₂CO₃ and NaCl.

FIG. 7A-B. Surface tension vs. concentration for C₁₂H₂₅—SO₄Na (SDS) (FIG. 7A) and C₁₈-2EO—C₁₈-10PO-2(SO₄Na) (FIG. 7B) in pure water at 25° C.

FIG. 8. Solubilization ratio plot for oil #1 (30%) at 100° C. after 7 days. The surfactant composition includes 0.8% C₁₈-2EO—C₁₈-10PO-2(SO₄Na) and 0.2% C₂₈-45PO-30EO-carboxylate. The black arrow in the histogram pointing from left to right indicates the aqueous stability at 75,000 ppm (TDS) of 2% Na₂CO₃ and NaCl.

FIG. 9. Solubilization ratio plot for oil #2 (30%) at 78° C. after 14 days. The surfactant composition includes 0.8% C₁₈-2EO—C₁₈-10PO-2(SO₄Na) and 0.2% C₂₈-45PO-30EO-carboxylate. The black arrow in the histogram pointing from left to right indicates the aqueous stability at 90,000 ppm (TDS) of 2% Na₂CO₃ and NaCl.

FIG. 10. Solubilization ratio plot for oil #3 (30%) at 58° C. after 18 days. The surfactant composition includes 1% C₁₈-2EO—C₁₈-10PO-2(SO₄Na). The black arrow in the histogram pointing from left to right indicates the aqueous stability at 85,000 ppm (TDS) of 2% Na₂CO₃ and NaCl.

FIG. 11. Solubilization ratio plot for oil #4 (30%) at 58° C. after 17 days. The surfactant composition includes 0.8% C₁₈-2EO—C₁₈-10PO-2(SO₄Na), 0.2% C₂₈-45PO-30EO-carboxylate and 0.5% IBA. The black arrow in the histogram pointing from left to right indicates the aqueous stability at 10,000 ppm (TDS) of 2% Na₂CO₃ and NaCl.

FIG. 12. Solubilization ratio plot for oil #4 (30%) at 58° C. after 17 days. The surfactant composition includes 0.8% C₁₈-2EO—C₁₈-10PO-2(SO₄Na), 0.2% C₁₆/C₁₆-35PO-20EO-sulfate and 0.5% IBA. The black arrow in the histogram pointing from left to right indicates the aqueous stability at 10,000 ppm (TDS) of 2% Na₂CO₃ and NaCl.

FIG. 13. Solubilization ratio plot for oil #4 (30%) at 58° C. after 6 days. The surfactant composition includes 0.8% C₁₈-2EO—C₁₈-10PO-2(SO₄Na), 0.2% C₂₈-45PO-30EO-carboxylate and 0.5% IBA. The black arrow in the histogram pointing from left to right indicates the aqueous stability at 160,000 ppm (TDS) of 2% Na₂CO₃ and NaCl.

FIG. 14. Solubilization ratio plot for oil #5 (30%) at 55° C. after 31 days. The surfactant composition includes 0.8% C₁₈-2EO—C₁₈-10PO-2(SO₄Na), 0.2% C₂₈-45PO-30EO-carboxylate and 0.5% IBA. The black arrow in the histogram pointing from left to right indicates the aqueous stability at 160,000 ppm (TDS) of 2% Na₂CO₃ and NaCl.

FIG. 15. Photographs of phase behavior of 1.0 wt % C₁₈-2EO—C₁₈-10PO-2(SO₄Na) with dodecane showing stable microemulsions for more than 30 days at 55° C.

FIG. 16. Impact of NaCl concentration on IFT for 0.1 wt % C₁₈-2EO—C₁₈-10PO-2(SO₄Na) (Gemini disulfate solutions) at 55° C., with oil phase of dodecane.

FIG. 17. Solubilization ratio plot for oil #1 (30%) at 60° C. after 28 days. The Gemini surfactant formulation includes 0.5 wt. % C₁₈-2EO—C₁₈-10PO-disulfate, 0.5 wt. % branched C₁₂₋₁₃-7PO sulfate (Enordet J771), and 1.0 wt. % DIPA 5EO. The arrow in the histogram pointing from left to right indicates the aqueous stability at 40,313 ppm (TDS) of 2% Na₂CO₃ and NaCl.

FIG. 18. Plot of the pressure drop at 60° C. (20,000 ppm NaCl solution injected at 5 mL/min) across each section of the Gemini-3 core before restoration.

FIG. 19. Plot of the salinity profile during the course of a salinity tracer test conducted by displacing 20,000 ppm NaCl with 60,000 ppm restoration brine (1% sodium dithionite, 1% EDTA, and 4% NaHCO₃ in DI water) at a flow rate of 4 ml/min.

FIG. 20. Plot of the pressure drop during the salinity tracer test conducted by displacing the 20,000 ppm NaCl with 60,000 ppm restoration brine (1% sodium dithionite, 1% EDTA, and 4% NaHCO₃ in DI water) at a flow rate of 4 ml/min.

FIG. 21. Plot of the pressure drop at 60° C. (50,000 ppm NaCl solution injected at 5 mL/min) across each section of the Gemini-3 core after restoration.

FIG. 22. Plot of the pressure drop at 60° C. across each section of the Gemini-3 core during the course of the oil flood.

FIG. 23. Plot of the pressure drop at 60° C. across each section of the Gemini-3 core during the course of the water flood.

FIG. 24. Plot of the total relative mobility and its inverse, the apparent viscosity, at various fluid saturations to determine the viscosity required for a stable displacement of the oil bank. The inverse total mobility plot shows a peak of approximately 10.5 cP.

FIG. 25. Plot of the viscosity of the slug (salinity=35,500 ppm TDS) and polymer drive (salinity=24,500 ppm TDS).

FIG. 26. Plot of Gemini-3 ASP flood oil recovery.

FIG. 27. Plot of Gemini-3 ASP flood pressure drop data across each section of the Gemini-3 core during the course of the flood oil recovery.

FIG. 28. Plot of the concentration of surfactants during the course of Gemini-3 ASP flood oil recovery.

FIG. 29. Plot of the salinity of the effluent during the course of Gemini-3 ASP flood oil recovery.

FIG. 30. Plot of the viscosity of the effluent during the course of Gemini-3 ASP flood oil recovery.

FIG. 31. Plot of the pH of the effluent during the course of Gemini-3 ASP flood oil recovery.

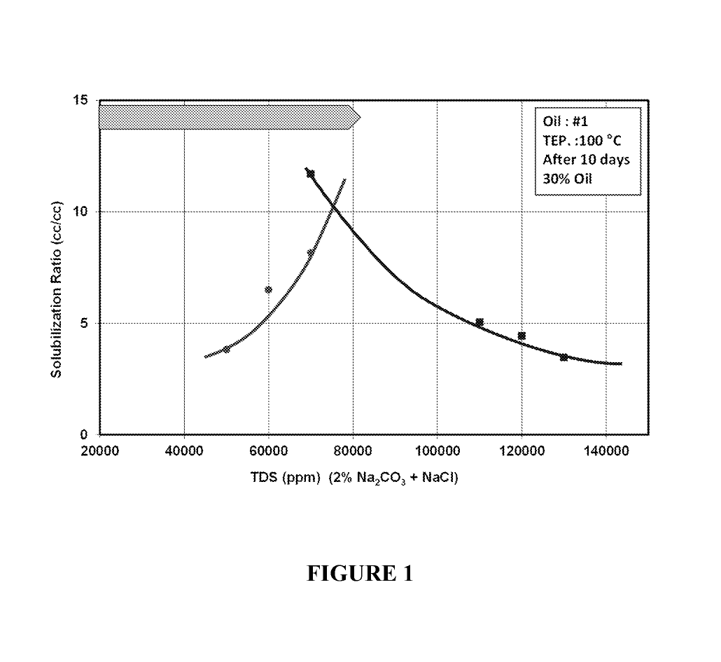

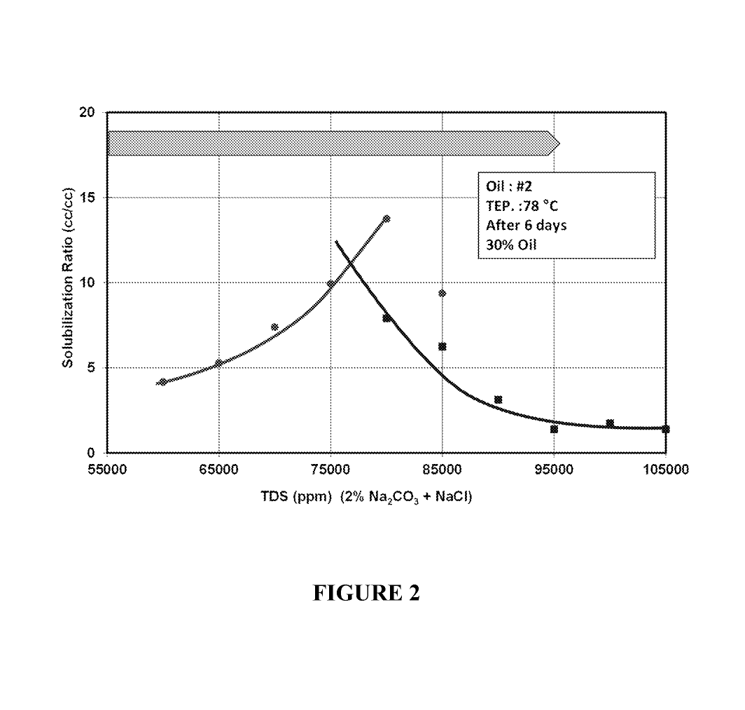

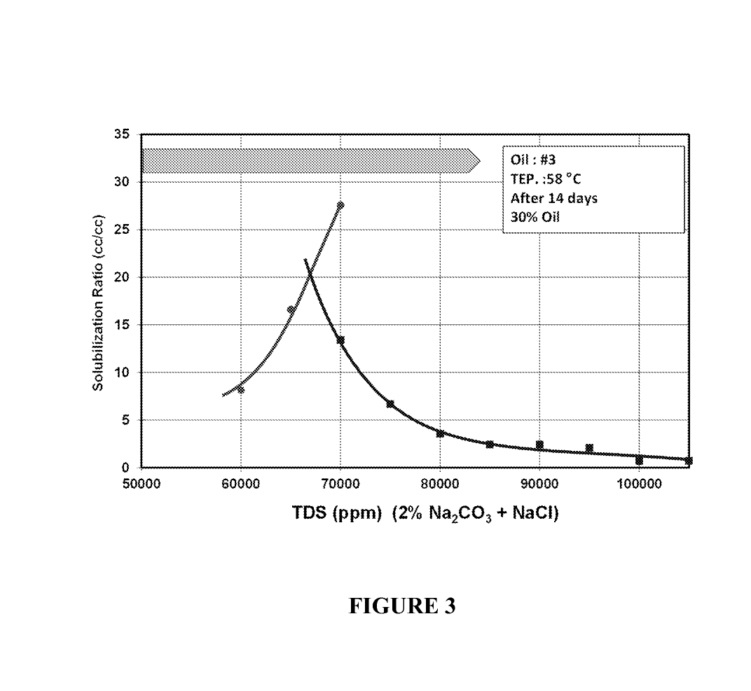

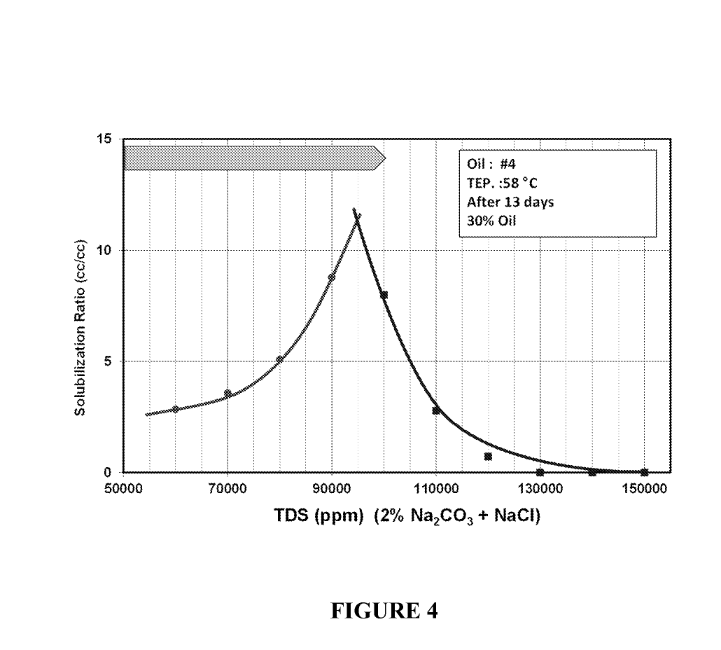

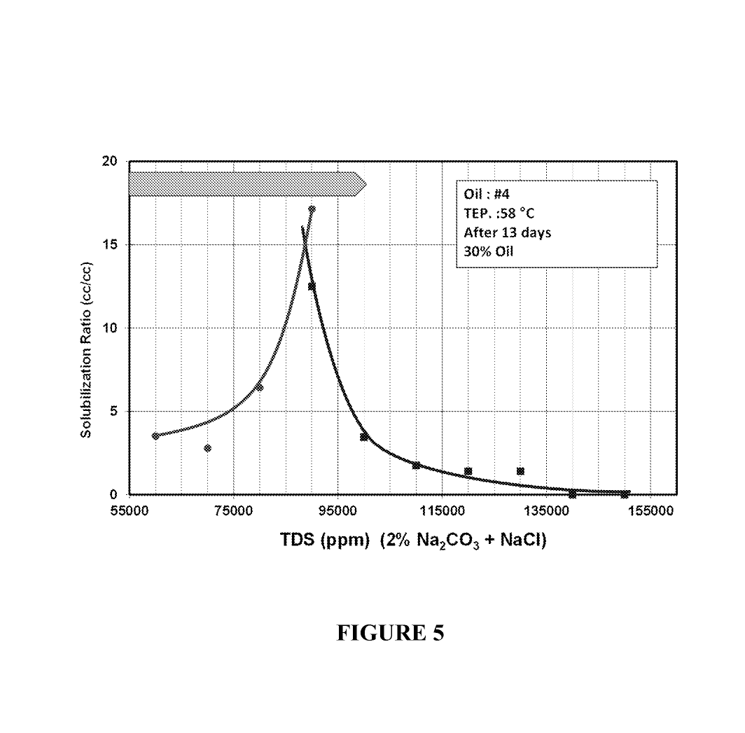

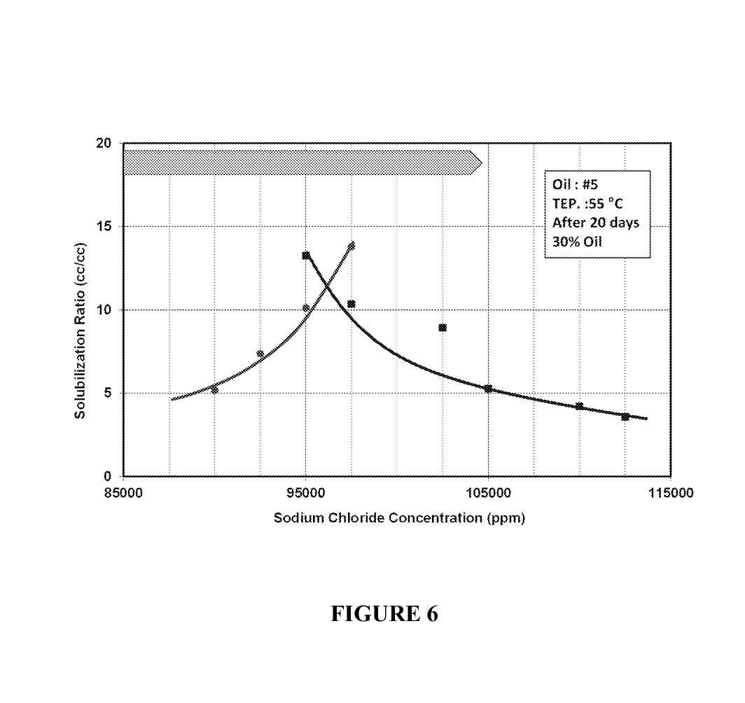

### DETAILED DESCRIPTION

### Definitions

The abbreviations used herein have their conventional meaning within the chemical and biological arts.

Where substituent groups are specified by their conventional chemical formulae, written from left to right, they equally encompass the chemically identical substituents that would result from writing the structure from right to left, e.g., —CH₂O— is equivalent to —OCH₂—.

The term “alkyl,” by itself or as part of another substituent, means, unless otherwise stated, a straight (i.e. unbranched) or branched chain which may be fully saturated, mono- or polyunsaturated and can include di- and multivalent radicals, having the number of carbon atoms designated (i.e. C₁-C₁₀ means one to ten carbons). Examples of saturated hydrocarbon radicals include, but are not limited to, groups such as methyl, ethyl, n-propyl, isopropyl, n-butyl, t-butyl, isobutyl, sec-butyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. Alkyl groups which are limited to hydrocarbon groups are termed “homoalkyl”. An alkoxy is an alkyl attached to the remainder of the molecule via an oxygen linker (—O—).

The term “alkylene” by itself or as part of another substituent means a divalent radical derived from an alkyl, as exemplified, but not limited, by —CH₂CH₂CH₂CH₂—, and further includes those groups described below as “heteroalkylene.” Typically, an alkyl (or alkylene) group will have from 1 to 24 carbon atoms, with those groups having 10 or fewer carbon atoms being preferred in the present invention. A “lower alkyl” or “lower alkylene” is a shorter chain alkyl or alkylene group, generally having eight or fewer carbon atoms.

The term “heteroalkyl,” by itself or in combination with another term, means, unless otherwise stated, a stable straight or branched chain or combinations thereof, consisting of at least one carbon atom and at least one heteroatom selected from the group consisting of O, N, P, Si and S, and wherein the nitrogen and sulfur atoms may optionally be oxidized and the nitrogen heteroatom may optionally be quaternized. The heteroatom(s) O, N, P and S and Si may be placed at any interior position of the heteroalkyl group or at the position at which the alkyl group is attached to the remainder of the molecule. Examples include, but are not limited to, —CH₂—CH₂—O—CH₃, —CH₂—CH₂—NH—CH₃, —CH₂—CH₂—N(CH₃)—CH₃, —CH₂—S—CH₂—CH₃, —CH₂—CH₂, —S(O)—CH₃, —CH₂—CH₂—S(O)₂—CH₃, —CH═CH—O—CH₃, —Si(CH₃)₃, —CH₂—CH═N—OCH₃, —CH═CH—N(CH₃)—CH₃, —O—CH₃, —O—CH₂, —CH₃, and —CN. Up to two heteroatoms may be consecutive, such as, for example, —CH₂—NH—OCH₃. Similarly, the term “heteroalkylene” by itself or as part of another substituent means a divalent radical derived from heteroalkyl, as exemplified, but not limited by, —CH₂—CH₂—S—CH₂—CH₂— and —CH₂—S—CH₂—CH₂—NH—CH₂—. For heteroalkylene groups, heteroatoms can also occupy either or both of the chain termini (e.g., alkyleneoxy, alkylenedioxy, alkyleneamino, alkylenediamino, and the like). Still further, for alkylene and heteroalkylene linking groups, no orientation of the linking group is implied by the direction in which the formula of the linking group is written. For example, the formula —C(O)₂R′— represents both —C(O)₂R′— and —R′C(O)₂—.

The terms “cycloalkyl” and “heterocycloalkyl,” by themselves or in combination with other terms, represent, unless otherwise stated, non-aromatic cyclic versions of “alkyl” and “heteroalkyl”, respectively. Additionally, for heterocycloalkyl, a heteroatom can occupy the position at which the heterocycle is attached to the remainder of the molecule. Examples of cycloalkyl include, but are not limited to, cyclopropyl, cyclobutyl, cyclopentyl, cyclohexyl, 1-cyclohexenyl, 3-cyclohexenyl, cycloheptyl, and the like. Examples of heterocycloalkyl include, but are not limited to, 1-(1,2,5,6-tetrahydropyridyl), 1-piperidinyl, 2-piperidinyl, 3-piperidinyl, 4-morpholinyl, 3-morpholinyl, tetrahydrofuran-2-yl, tetrahydrofuran-3-yl, tetrahydrothien-2-yl, tetrahydrothien-3-yl, 1-piperazinyl, 2-piperazinyl, and the like. A “cycloalkylene” and a “heterocycloalkylene,” alone or as part of another substituent means a divalent radical derived from a cycloalkyl and heterocycloalkyl, respectively.

The term “aryl” means, unless otherwise stated, a polyunsaturated, aromatic, hydrocarbon substituent which can be a single ring or multiple rings (preferably from 1 to 3 rings) which are fused together (i.e. a fused ring aryl) or linked covalently. A fused ring aryl refers to multiple rings fused together wherein at least one of the fused rings is an aryl ring. The term “heteroaryl” refers to aryl groups (or rings) that contain from heteroatom (e.g. one to four heteroatoms) selected from N, O, and S, wherein the nitrogen and sulfur atoms are optionally oxidized, and the nitrogen atom(s) are optionally quaternized. Thus, the term “heteroaryl” includes fused ring heteroaryl groups (i.e. multiple rings fused together wherein at least one of the fused rings is a heteroaromatic ring). A 5,6-fused ring heteroarylene refers to two rings fused together, wherein one ring has 5 members and the other ring has 6 members, and wherein at least one ring is a heteroaryl ring. Likewise, a 6,6-fused ring heteroarylene refers to two rings fused together, wherein one ring has 6 members and the other ring has 6 members, and wherein at least one ring is a heteroaryl ring. And a 6,5-fused ring heteroarylene refers to two rings fused together, wherein one ring has 6 members and the other ring has 5 members, and wherein at least one ring is a heteroaryl ring. A heteroaryl group can be attached to the remainder of the molecule through a carbon or heteroatom. Non-limiting examples of aryl and heteroaryl groups include phenyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Substituents for each of the above noted aryl and heteroaryl ring systems are selected from the group of acceptable substituents described below. An “arylene” and a “heteroarylene,” alone or as part of another substituent means a divalent radical derived from an aryl and heteroaryl, respectively.

Each of the above terms (e.g., “alkyl,” “heteroalkyl,” “aryl,” and “heteroaryl”) includes both substituted and unsubstituted forms of the indicated radical. Preferred substituents for each type of radical are provided below.

Substituents for the alkyl and heteroalkyl radicals (including those groups often referred to as alkylene, alkenyl, heteroalkylene, heteroalkenyl, alkynyl, cycloalkyl, heterocycloalkyl, cycloalkenyl, and heterocycloalkenyl) can be one or more of a variety of groups selected from, but not limited to, —OR′, ═O, ═NR′, ═N—OR′, —NR′R″, —SR′, -halogen, —SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NR—C(NR′R″R′″)═NR″″, —NR—C(NR′R″)═NR′″, —S(O)R′, —S(O)₂R′, —S(O)₂NR′R″, —NRSO₂R′, —NR′NR″R′″, —ONR′R″, —NR′C═(O)NR″NR′″R″″, —CN, —NO₂, in a number ranging from zero to (2m′+1), where m′ is the total number of carbon atoms in such radical. R, R′, R″, R′″, and R″″ each preferably independently refer to hydrogen, substituted or unsubstituted heteroalkyl, substituted or unsubstituted cycloalkyl, substituted or unsubstituted heterocycloalkyl, substituted or unsubstituted aryl (e.g., aryl substituted with 1-3 halogens), substituted or unsubstituted heteroaryl, substituted or unsubstituted alkyl, alkoxy, or thioalkoxy groups, or arylalkyl groups. When a compound of the invention includes more than one R group, for example, each of the R groups is independently selected as are each R′, R″, R′″, and R″″ group when more than one of these groups is present. When R′ and R″ are attached to the same nitrogen atom, they can be combined with the nitrogen atom to form a 4-, 5-, 6-, or 7-membered ring. For example, —NR′R″ includes, but is not limited to, 1-pyrrolidinyl and 4-morpholinyl. From the above discussion of substituents, one of skill in the art will understand that the term “alkyl” is meant to include groups including carbon atoms bound to groups other than hydrogen groups, such as haloalkyl (e.g., —CF₃ and —CH₂CF₃) and acyl (e.g., —C(O)CH₃, —C(O)CF₃, —C(O)CH₂OCH₃, and the like).

Similar to the substituents described for the alkyl radical, substituents for the aryl and heteroaryl groups are varied and are selected from, for example: —OR′, —NR′R″, —SR′, -halogen, —SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NR—C(NR′R″R′″)═NR″″, —NR—C(NR′R″)═NR′″, —S(O)R′, —S(O)₂R′, —S(O)₂NR′R″, —NRSO₂R′, —NR′NR″R′″, —ONR′R″, —NR′C═(O)NR″NR′″R″″, —CN, —NO₂, —R′, —N₃, —CH(Ph)₂, fluoro(C₁-C₄)alkoxy, and fluoro(C₁-C₄)alkyl, in a number ranging from zero to the total number of open valences on the aromatic ring system; and where R′, R″, R′″, and R″″ are preferably independently selected from hydrogen, substituted or unsubstituted alkyl, substituted or unsubstituted heteroalkyl, substituted or unsubstituted cycloalkyl, substituted or unsubstituted heterocycloalkyl, substituted or unsubstituted aryl, and substituted or unsubstituted heteroaryl. When a compound of the invention includes more than one R group, for example, each of the R groups is independently selected as are each R′, R″, R′″, and R″″ groups when more than one of these groups is present.

A heteroaryl group substituent may be a —O⁻ bonded to a ring heteroatom nitrogen.

As used herein, the terms “heteroatom” or “ring heteroatom” are meant to include, oxygen (O), nitrogen (N), sulfur (S), phosphorus (P), and silicon (Si).

In embodiments, the compound is a chemical species set forth in the Examples section below.

A “substituent group,” as used herein, means a group selected from the following moieties:
(A) oxo, halogen, —CF₃, —CN, —OH, —NH₂, —COOH, —CONH₂, —NO₂, —SH, —SO₂Cl, —SO₃H, —SO₄H, —SO₂NH₂, —NHNH₂, —ONH₂, —NHC═(O)NHNH₂, —NHC═(O) NH₂, —NHSO₂H, —NHC═(O)H, —NHC(O)—OH, —NHOH, —OCF₃, —OCHF₂, —NHSO₂CH₃, —N₃, unsubstituted alkyl, unsubstituted heteroalkyl, unsubstituted cycloalkyl, unsubstituted heterocycloalkyl, unsubstituted aryl, unsubstituted heteroaryl, and
(B) alkyl, heteroalkyl, cycloalkyl, heterocycloalkyl, aryl, heteroaryl, substituted with at least one substituent selected from:
   (i) oxo, halogen, —CF₃, —CN, —OH, —NH₂, —COOH, —CONH₂, —NO₂, —SH, —SO₂Cl, —SO₃H, —SO₄H, —SO₂NH₂, —NHNH₂, —ONH₂, —NHC═(O)NHNH₂, —NHC═(O)NH₂, —NHSO₂H, —NHC═(O)H, —NHC(O)—OH, —NHOH, —OCF₃, —OCHF₂, —NHSO₂CH₃, —N₃, unsubstituted alkyl, unsubstituted heteroalkyl, unsubstituted cycloalkyl, unsubstituted heterocycloalkyl, unsubstituted aryl, unsubstituted heteroaryl, and
   (ii) alkyl, heteroalkyl, cycloalkyl, heterocycloalkyl, aryl, heteroaryl, substituted with at least one substituent selected from:
      (a) oxo, halogen, —CF₃, —CN, —OH, —NH₂, —COOH, —CONH₂, —NO₂, —SH, —SO₂Cl, —SO₃H, —SO₄H, —SO₂NH₂, —NHNH₂, —ONH₂, —NHC═(O)NHNH₂, —NHC═(O) NH₂, —NHSO₂H, —NHC═(O)H, —NHC(O)—OH, —NHOH, —OCF₃, —OCHF₂, —NHSO₂CH₃, —N₃, unsubstituted alkyl, unsubstituted heteroalkyl, unsubstituted cycloalkyl, unsubstituted heterocycloalkyl, unsubstituted aryl, unsubstituted heteroaryl, and
      (b) alkyl, heteroalkyl, cycloalkyl, heterocycloalkyl, aryl, heteroaryl, substituted with at least one substituent selected from: oxo, halogen, —CF₃, —CN, —OH, —NH₂, —COOH, —CONH₂, —NO₂, —SH, —SO₂Cl, —SO₃H, —SO₄H, —SO₂NH₂, —NHNH₂, —ONH₂, —NHC═(O)NHNH₂, —NHC═(O) NH₂, —NHSO₂H, —NHC═(O)H, —NHC(O)—OH, —NHOH, —OCF₃, —OCHF₂, —NHSO₂CH₃, —N₃, unsubstituted alkyl, unsubstituted heteroalkyl, unsubstituted cycloalkyl, unsubstituted heterocycloalkyl, unsubstituted aryl, unsubstituted heteroaryl.

A “size-limited substituent” or “size-limited substituent group,” as used herein, means a group selected from all of the substituents described above for a “substituent group,” wherein each substituted or unsubstituted alkyl is a substituted or unsubstituted C₁-C₂₀ alkyl, each substituted or unsubstituted heteroalkyl is a substituted or unsubstituted 2 to 20 membered heteroalkyl, each substituted or unsubstituted cycloalkyl is a substituted or unsubstituted C₃-C₈ cycloalkyl, each substituted or unsubstituted heterocycloalkyl is a substituted or unsubstituted 3 to 8 membered heterocycloalkyl, each substituted or unsubstituted aryl is a substituted or unsubstituted C₆-C₁₀ aryl, and each substituted or unsubstituted heteroaryl is a substituted or unsubstituted 5 to 10 membered heteroaryl.

A “lower substituent” or “lower substituent group,” as used herein, means a group selected from all of the substituents described above for a “substituent group,” wherein each substituted or unsubstituted alkyl is a substituted or unsubstituted C₁-C₈ alkyl, each substituted or unsubstituted heteroalkyl is a substituted or unsubstituted 2 to 8 membered heteroalkyl, each substituted or unsubstituted cycloalkyl is a substituted or unsubstituted C₃-C₇ cycloalkyl, each substituted or unsubstituted heterocycloalkyl is a substituted or unsubstituted 3 to 7 membered heterocycloalkyl, each substituted or unsubstituted aryl is a substituted or unsubstituted C₆-C₁₀ aryl, and each substituted or unsubstituted heteroaryl is a substituted or unsubstituted 5 to 9 membered heteroaryl.

In some embodiments, each substituted group described in the compounds herein is substituted with at least one substituent group. More specifically, in some embodiments, each substituted alkyl, substituted heteroalkyl, substituted cycloalkyl, substituted heterocycloalkyl, substituted aryl, substituted heteroaryl, substituted alkylene, substituted heteroalkylene, substituted cycloalkylene, substituted heterocycloalkylene, substituted arylene, and/or substituted heteroarylene described in the compounds herein are substituted with at least one substituent group. In other embodiments, at least one or all of these groups are substituted with at least one size-limited substituent group. In other embodiments, at least one or all of these groups are substituted with at least one lower substituent group.

In other embodiments of the compounds herein, each substituted or unsubstituted alkyl may be a substituted or unsubstituted C₁-C₂₀ alkyl, each substituted or unsubstituted heteroalkyl is a substituted or unsubstituted 2 to 20 membered heteroalkyl, each substituted or unsubstituted cycloalkyl is a substituted or unsubstituted C₃-C₈ cycloalkyl, each substituted or unsubstituted heterocycloalkyl is a substituted or unsubstituted 3 to 8 membered heterocycloalkyl, each substituted or unsubstituted aryl is a substituted or unsubstituted C₆-C₁₀ aryl, and/or each substituted or unsubstituted heteroaryl is a substituted or unsubstituted 5 to 10 membered heteroaryl. In some embodiments of the compounds herein, each substituted or unsubstituted alkylene is a substituted or unsubstituted C₁-C₂₀ alkylene, each substituted or unsubstituted heteroalkylene is a substituted or unsubstituted 2 to 20 membered heteroalkylene, each substituted or unsubstituted cycloalkylene is a substituted or unsubstituted C₃-C₈ cycloalkylene, each substituted or unsubstituted heterocycloalkylene is a substituted or unsubstituted 3 to 8 membered heterocycloalkylene, each substituted or unsubstituted arylene is a substituted or unsubstituted C₆-C₁₀ arylene, and/or each substituted or unsubstituted heteroarylene is a substituted or unsubstituted 5 to 10 membered heteroarylene.

In some embodiments, each substituted or unsubstituted alkyl is a substituted or unsubstituted C₁-C₈ alkyl, each substituted or unsubstituted heteroalkyl is a substituted or unsubstituted 2 to 8 membered heteroalkyl, each substituted or unsubstituted cycloalkyl is a substituted or unsubstituted C₃-C₇ cycloalkyl, each substituted or unsubstituted heterocycloalkyl is a substituted or unsubstituted 3 to 7 membered heterocycloalkyl, each substituted or unsubstituted aryl is a substituted or unsubstituted C₆-C₁₀ aryl, and/or each substituted or unsubstituted heteroaryl is a substituted or unsubstituted 5 to 9 membered heteroaryl. In some embodiments, each substituted or unsubstituted alkylene is a substituted or unsubstituted C₁-C₈ alkylene, each substituted or unsubstituted heteroalkylene is a substituted or unsubstituted 2 to 8 membered heteroalkylene, each substituted or unsubstituted cycloalkylene is a substituted or unsubstituted C₃-C₇ cycloalkylene, each substituted or unsubstituted heterocycloalkylene is a substituted or unsubstituted 3 to 7 membered heterocycloalkylene, each substituted or unsubstituted arylene is a substituted or unsubstituted C₆-C₁₀ arylene, and/or each substituted or unsubstituted heteroarylene is a substituted or unsubstituted 5 to 9 membered heteroarylene. In some embodiments, the compound is a chemical species set forth in the Examples section below.

Each R-group (e.g., R², R¹) as provided in the formulae provided herein can appear more than once. Where an R-group appears more than once each R group can be optionally different.

Where a substituent of a compound provided herein is “R-substituted” (e.g. R²-substituted), it is meant that the substituent is substituted with one or more of the named R groups (e.g. R²) as appropriate. In embodiments, the substituent is substituted with only one of the named R groups. Where a moiety is R-substituted, the moiety is substituted with at least one R substituent and each R substituent is optionally different. For example, where a moiety herein is R¹²-substituted or unsubstituted alkyl, a plurality of R¹² substituents may be attached to the alkyl moiety wherein each R¹² substituent is optionally different. Where an R-substituted moiety is substituted with a plurality R substituents, each of the R-substituents may be differentiated herein using a prime symbol (′) such as R′, R″, etc. For example, where a moiety is R¹²-substituted or unsubstituted alkyl, and the moiety is substituted with a plurality of R¹² substituents, the plurality of R¹² substituents may be differentiated as R¹²′, R¹²″, R¹²′″, etc. In embodiments, the plurality of R substituents is 3. In embodiments, the plurality of R substituents is 2.

In embodiments, a compound as described herein may include multiple instances of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, R²¹ and/or other variables. In such embodiments, each variable may optional be different and be appropriately labeled to distinguish each group for greater clarity. For example, where each R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, and/or R²¹, is different, they may be referred to, for example, as R^{1.1}, R^{1.2}, R^{1.3}, R^{1.4}, R^{2.1}, R^{2.2}, R^{2.3}, R^{2.4}, R^{3.1}, R^{3.2}, R^{3.3}, R^{3.4}, R^{4.1}, R^{4.2}, R^{4.3}, R^{4.4}, R^{5.1}, R^{5.2}, R^{5.3}, R^{5.4}, R^{6.1}, R^{6.2}, R^{6.3}, R^{6.4}, R^{7.1}, R^{7.2}, R^{7.3}, R^{7.4}, R^{8.1}, R^{8.2}, R^{8.3}, R^{8.4}, R^{9.1}, R^{9.2}, R^{9.3}, R^{9.4}, R^{10.1}, R^{10.2}, R^{10.3}, R^{10.4}, R^{11.1}, R^{11.2}, R^{11.3}, R^{11.4}, R^{12.1}, R^{12.2}, R^{12.3}, R^{12.4}, R^{13.1}, R^{13.2}, R^{13.3}, R^{13.4}, R^{14.1}, R^{14.2}, R^{14.3}, R^{14.4}, R^{15.1}, R^{15.2}, R^{15.3}, R^{15.4}, R^{16.1}, R^{16.2}, R^{16.3}, R^{16.4}, R^{17.1}, R^{17.2}, R^{17.3}, R^{17.4}, R^{18.1}, R^{18.2}, R^{18.3}, R^{18.4}, R^{19.1}, R^{19.2}, R^{19.3}, R^{19.4}, R^{20.1}, R^{20.2}, R^{20.3}, R^{20.4}, R^{21.1}, R^{21.2}, R^{21.3}, and/or R^{21.4}, respectively, wherein the definition of R¹ is assumed by R^{1.1}, R^{1.2}, R^{1.3}, and/or R^{1.4}, the definition of R² is assumed by R^{2.1}, R^{2.2}, R^{2.3}, and/or R^{2.4}, the definition of R³ is assumed by R^{3.1}, R^{3.2}, R^{3.3}, and/or R^{3.4}, the definition of R⁴ is assumed by R^{4.1}, R^{4.2}, R^{4.3}, and/or R^{4.4}, the definition of R⁵ is assumed by R^{5.1}, R^{5.2}, R^{5.3}, and/or R^{5.4}, the definition of R⁶ is assumed by R^{6.1}, R^{6.2}, R^{6.3}, and/or R^{6.4}, the definition of R⁷ is assumed by R^{7.1}, R^{7.2}, R^{7.3}, and/or R^{7.4}, the definition of R⁸ is assumed by R^{8.1}, R^{8.2}, R^{8.3}, and/or R^{8.4}, the definition of R⁹ is assumed by R^{9.1}, R^{9.2}, R^{9.3}, and/or R^{9.4}, the definition of R¹⁰ is assumed by R^{10.1}, R^{10.2}, R^{10.3}, and/or R^{10.4}, the definition of R¹¹ is assumed by R^{11.1}, R^{11.2}, R^{11.3}, and/or R^{11.4}, the definition of R¹² is assumed by R^{12.1}, R^{12.2}, R^{12.3}, and/or R^{12.4}, the definition of R¹³ is assumed by R^{13.1}, R^{13.2}, R^{13.3}, and/or R^{13.4}, the definition of R¹⁴ is assumed by R^{14.1}, R^{14.2}, R^{14.3}, and/or R^{14.4}, the definition of R¹⁵ is assumed by R^{15.1}, R^{15.2}, R^{15.3}, and/or R^{15.4}, the definition of R¹⁶ is assumed by R^{16.1}, R^{16.2}, R^{16.3}, and/or R^{16.4}, the definition of R¹⁷ is assumed by R^{17.1}, R^{17.2}, R^{17.3}, and/or R^{17.4}, the definition of R¹⁸ is assumed by R^{18.1}, R^{18.2}, R^{18.3}, and/or R^{18.4}, the definition of R¹⁹ is assumed by R^{19.1}, R^{19.2}, R^{19.3}, and/or R^{19.4}, the definition of R²⁰ is assumed by R^{20.1}, R^{20.2}, R^{20.3}, and/or R^{20.4}, the definition of R²¹ is assumed by R^{21.1}, R^{21.2}, R^{21.3}, and/or R^{21.4}. The variables used within a definition of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, and/or R²¹, and/or other variables that appear at multiple instances and are different may similarly be appropriately labeled to distinguish each group for greater clarity.

Description of compounds of the present invention are limited by principles of chemical bonding known to those skilled in the art. Accordingly, where a group may be substituted by one or more of a number of substituents, such substitutions are selected so as to comply with principles of chemical bonding and to give compounds which are not inherently unstable and/or would be known to one of ordinary skill in the art as likely to be unstable under ambient conditions, such as aqueous, neutral, and several known physiological conditions. For example, a heterocycloalkyl or heteroaryl is attached to the remainder of the molecule via a ring heteroatom in compliance with principles of chemical bonding known to those skilled in the art thereby avoiding inherently unstable compounds.

The symbol “ [symbol] ” denotes the point of attachment of a chemical moiety to the remainder of a molecule or chemical formula.

The term “contacting” as used herein, refers to materials or compounds being sufficiently close in proximity to react or interact. For example, in methods of contacting a hydrocarbon material bearing formation and/or a well bore, the term “contacting” includes placing an aqueous composition (e. g. chemical, surfactant or polymer) within a hydrocarbon material bearing formation using any suitable manner known in the art (e.g., pumping, injecting, pouring, releasing, displacing, spotting or circulating the chemical into a well, well bore or hydrocarbon bearing formation).

The terms “unrefined petroleum” and “crude oil” are used interchangeably and in keeping with the plain ordinary usage of those terms. “Unrefined petroleum” and “crude oil” may be found in a variety of petroleum reservoirs (also referred to herein as a “reservoir,” “oil field deposit” “deposit” and the like) and in a variety of forms including oleaginous materials, oil shales (i.e. organic-rich fine-grained sedimentary rock), tar sands, light oil deposits, heavy oil deposits, and the like. “Crude oils” or “unrefined petroleums” generally refer to a mixture of naturally occurring hydrocarbons that may be refined into diesel, gasoline, heating oil, jet fuel, kerosene, and other products called fuels or petrochemicals. Crude oils or unrefined petroleums are named according to their contents and origins, and are classified according to their per unit weight (specific gravity). Heavier crudes generally yield more heat upon burning, but have lower gravity as defined by the American Petroleum Institute (API) and market price in comparison to light (or sweet) crude oils. Crude oil may also be characterized by its Equivalent Alkane Carbon Number (EACN).

Crude oils vary widely in appearance and viscosity from field to field. They range in color, odor, and in the properties they contain. While all crude oils are mostly hydrocarbons, the differences in properties, especially the variation in molecular structure, determine whether a crude oil is more or less easy to produce, pipeline, and refine. The variations may even influence its suitability for certain products and the quality of those products. Crude oils are roughly classified into three groups, according to the nature of the hydrocarbons they contain. (i) Paraffin based crude oils contain higher molecular weight paraffins, which are solid at room temperature, but little or no asphaltic (bituminous) matter. They can produce high-grade lubricating oils. (ii) Asphaltene based crude oils contain large proportions of asphaltic matter, and little or no paraffin. Some are predominantly naphthenes and so yield lubricating oils that are sensitive to temperature changes than the paraffin-based crudes. (iii) Mixed based crude oils contain both paraffin and naphthenes, as well as aromatic hydrocarbons. Most crude oils fit this latter category.

“Heavy crude oils” as provided herein are crude oils, with an API gravity of less than 20, or a viscosity of at least 100 cp. The heavy crude oils may have a viscosity greater than 100 cP. In embodiments, the heavy crude oil has a viscosity of at least 100 cP. In embodiments, the heavy crude oil has a viscosity of at least 1,000 cP. In embodiments, the heavy crude oil has a viscosity of at least 10,000 cP. In embodiments, the heavy crude oil has a viscosity of at least 100,000 cP. In embodiments, the heavy crude oil has a viscosity of at least 1,000,000 cP.

“Reactive” or “active” heavy crude oil as referred to herein is crude oil containing natural organic acidic components (also referred to herein as unrefined petroleum acid) or their precursors such as esters or lactones. These active heavy crude oils can generate soaps (carboxylate surfactants) when reacted with alkali or other basic agents (e.g. a basic co-solvent as provided herein). More terms used interchangeably for heavy crude oil throughout this disclosure are active hydrocarbon material or active petroleum material. An “oil bank” or “oil cut” as referred to herein, is the heavy crude oil that does not contain the injected chemicals and is pushed by the injected fluid during an enhanced oil recovery process. A “nonactive oil,” as used herein, refers to an oil that is not substantially reactive or crude oil not containing significant amounts of natural organic acidic components or their precursors such as esters or lactones such that significant amounts of soaps are generated when reacted with alkali or other basic agents (e.g. a basic co-solvent as provided herein). A nonactive oil as referred to herein includes oils having an acid number of less than 0.5 mg KOH/g of oil.

“Unrefined petroleum acids” as referred to herein are carboxylic acids contained in active petroleum material (reactive heavy crude oil). The unrefined petroleum acids contain C₁₁ to C₂₀ alkyl chains, including napthenic acid mixtures. The recovery of such “reactive” oils may be performed using alkali (e.g. NaOH or Na₂CO₃) or other basic agents (e.g. a basic co-solvent as provided herein) in a composition. The alkali or other basic agent (e.g. a basic co-solvent as provided herein) reacts with the acid in the reactive oil to form soap in situ. These in situ generated soaps serve as a source of surfactants enabling efficient oil recovery from the reservoir.

The term “polymer” refers to a molecule having a structure that essentially includes the multiple repetitions of units derived, actually or conceptually, from molecules of low relative molecular mass. In embodiments, the polymer is an oligomer.

The term “bonded” refers to having at least one of covalent bonding, hydrogen bonding, ionic bonding, Van Der Waals interactions, pi interactions, London forces or electrostatic interactions.

The term “productivity” as applied to a petroleum or oil well refers to the capacity of a well to produce hydrocarbons (e.g. unrefined petroleum); that is, the ratio of the hydrocarbon flow rate to the pressure drop, where the pressure drop is the difference between the average reservoir pressure and the flowing bottom hole well pressure (i.e., flow per unit of driving force).

The term “oil solubilization ratio” is defined as the volume of oil solubilized divided by the volume of surfactant in microemulsion. All the surfactant is presumed to be in the microemulsion phase. The oil solubilization ratio is applied for Winsor type I and type III behavior. The volume of oil solubilized is found by reading the change between initial aqueous level and excess oil (top) interface level. The oil solubilization ratio is calculated as follows:

$${σ}_{o} = \frac{{V}_{o}}{{V}_{s}} ,$$

wherein

σₒ=oil solubilization ratio;

Vₒ=volume of oil solubilized;

Vₛ=volume of surfactant.

The term “water solubilization ratio” is defined as the volume of water solubilized divided by the volume of surfactant in microemulsion. All the surfactant is presumed to be in the microemulsion phase. The water solubilization ratio is applied for Winsor type III and type II behavior. The volume of water solubilized is found by reading the change between initial aqueous level and excess water (bottom) interface level. The water solubilization parameter is calculated as follows:

$${σ}_{w} = \frac{{V}_{w}}{{V}_{s}} ,$$

wherein

σ_{w}=water solubilization ratio;

V_{w}=volume of water solubilized.

The optimum solubilization ratio occurs where the oil and water solubilization ratios are equal. The coarse nature of phase behavior screening often does not include a data point at optimum, so the solubilization ratio curves are drawn for the oil and water solubilization ratio data and the intersection of these two curves is defined as the optimum. The following is true for the optimum solubilization ratio:

σₒ=σ_{W}=σ*;

σ*=optimum solubilization ratio.

The term “solubility” or “solubilization” in general refers to the property of a solute, which can be a solid, liquid or gas, to dissolve in a solid, liquid or gaseous solvent thereby forming a homogenous solution of the solute in the solvent. Solubility occurs under dynamic equilibrium, which means that solubility results from the simultaneous and opposing processes of dissolution and phase joining (e.g. precipitation of solids). The solubility equilibrium occurs when the two processes proceed at a constant rate. The solubility of a given solute in a given solvent typically depends on temperature. For many solids dissolved in liquid water, the solubility increases with temperature. In liquid water at high temperatures, the solubility of ionic solutes tends to decrease due to the change of properties and structure of liquid water. In more particular, solubility and solubilization as referred to herein are the properties of oil to dissolve in water and vice versa.

“Viscosity” refers to a fluid's internal resistance to flow or being deformed by shear or tensile stress. In other words, viscosity may be defined as thickness or internal friction of a liquid. Thus, water is “thin”, having a lower viscosity, while oil is “thick”, having a higher viscosity. More generally, the less viscous a fluid is, the greater its ease of fluidity.

The term “salinity” as used herein, refers to concentration of salt dissolved in a aqueous phases. Examples for such salts are without limitation, sodium chloride, magnesium and calcium sulfates, and bicarbonates. In more particular, the term salinity as it pertains to the present invention refers to the concentration of salts in brine and surfactant solutions.

The term “aqueous solution or aqueous formulation” refers to a solution in which the solvent is water. The term “emulsion, emulsion solution or emulsion formulation” refers to a mixture of two or more liquids which are normally immiscible. A non-limiting example for an emulsion is a mixture of oil and water.

An “alkali agent” is used according to its conventional meaning and includes basic, ionic salts of alkali metals or alkaline earth metals. Alkali agents as provided herein are typically capable of reacting with an unrefined petroleum acid (e.g. the acid or its precursor in crude oil (reactive oil)) to form soap (a surfactant which is a salt of a fatty acid) in situ. These in situ generated soaps serve as a source of surfactants causing a reduction of the interfacial tension of the oil in water emulsion, thereby reducing the viscosity of the emulsion. Examples of alkali agents useful for the provided invention include, but are not limited to, sodium hydroxide, sodium carbonate, sodium silicate, sodium metaborate, and EDTA tetrasodium salt.

A “co-solvent” refers to a compound having the ability to increase the solubility of a solute (e.g. a compound as disclosed herein) in the presence of an unrefined petroleum acid. In embodiments, the co-solvents provided herein have a hydrophobic portion (alkyl or aryl chain), a hydrophilic portion (e.g. an alcohol) and optionally an alkoxy portion. Co-solvents as provided herein include alcohols (e.g. C₁-C₆ alcohols, C₁-C₆ diols), alkoxy alcohols (e.g. C₁-C₆ alkoxy alcohols, C₁-C₆ alkoxy diols, and phenyl alkoxy alcohols), glycol ether, glycol and glycerol. The term “alcohol” is used according to its ordinary meaning and refers to an organic compound containing an —OH groups attached to a carbon atom. The term “diol” is used according to its ordinary meaning and refers to an organic compound containing two —OH groups attached to two different carbon atoms. The term “alkoxy alcohol” is used according to its ordinary meaning and refers to an organic compound containing an alkoxy linker attached to a —OH group

A “microemulsion” as referred to herein is a thermodynamically stable mixture of oil, water and surfactants that may also include additional components such as co-solvents, electrolytes, alkali and polymers. In contrast, a “macroemulsion” as referred to herein is a thermodynamically unstable mixture of oil and water that may also include additional components. The emulsion composition provided herein may be an oil-in-water emulsion, wherein the surfactant forms aggregates (e.g. micelles) where the hydrophilic part of the surfactant molecule contacts the aqueous phase of the emulsion and the lipophilic part contacts the oil phase of the emulsion. Thus, in embodiments, the surfactant forms part of the aqueous part of the emulsion. And in embodiments, the surfactant forms part of the oil phase of the emulsion. In yet another embodiment, the surfactant forms part of an interface between the aqueous phase and the oil phase of the emulsion.

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not limit the scope of the invention.

Compositions

Provided herein, inter alia, are large hydrophobe compounds and methods of using the same for a variety of applications including enhanced oil recovery. The compounds provided herein may be used with broad oil concentrations, at a wide range of salinities, at high reservoir temperatures and over a broad pH range. The large hydrophobe compounds of the present invention represent a cost effective alternative to commonly used EOR surfactants. The compounds provided herein including embodiments thereof have a critical micelle concentration (CMC) that is surprisingly lower (e.g., two orders of magnitude lower) than the CMC of conventional low molecular weight EOR surfactant compounds. The compounds described herein may also significantly improve the effectiveness of co-surfactant compounds (e.g., alkoxy carboxylate compounds) to a surprising degree. Where co-surfactant compounds are combined with the compounds provided herein (e.g. a compound of formula (I), (II), (III), (IV)), the combination may be more stable and effective when compared to the stability and effectiveness of the co-surfactant compounds in the absence of the compounds provided herein. Further, the compounds provided herein including embodiments thereof are highly effective for oil recovery from high salinity reservoirs.

In a first aspect, a compound having the formula:

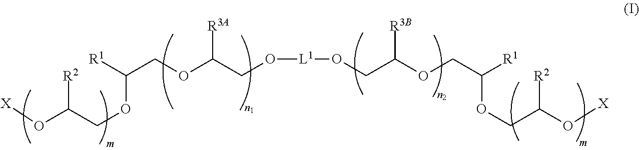

is provided. In formula (I) R¹ is substituted or unsubstituted alkyl, substituted or unsubstituted heteroalkyl, substituted or unsubstituted cycloalkyl, substituted or unsubstituted heterocycloalkyl, substituted or unsubstituted aryl or substituted or unsubstituted heteroaryl. R² is hydrogen or substituted or unsubstituted alkyl. R^{3A} and R^{3B} are independently hydrogen or substituted or unsubstituted alkyl. L¹ is substituted or unsubstituted alkylene, substituted or unsubstituted cycloalkylene or substituted or unsubstituted arylene. m is an integer of 1 to 200. n₁ and n₂ are independently integers from 0 to 20. X is —SO₃⁻M⁺, —CH₂C(O)O⁻M⁺, —SO₃H or —CH₂C(O)OH and M⁺ is a monovalent, divalent or trivalent cation. In embodiments, M⁺ is Na⁺, K⁺, NH₄⁺, Ca⁺², Mg⁺² or Ba⁺².

In embodiments, the symbol m is an integer from 1 to 200. In embodiments, the symbol m is an integer from 5 to 200. In embodiments, the symbol m is an integer from 10 to 200. In embodiments, the symbol m is an integer from 15 to 200. In embodiments, the symbol m is an integer from 20 to 200. In embodiments, the symbol m is an integer from 25 to 200. In embodiments, the symbol m is an integer from 30 to 200. In embodiments, the symbol m is an integer from 35 to 200. In embodiments, the symbol m is an integer from 40 to 200. In embodiments, the symbol m is an integer from 45 to 200. In embodiments, the symbol m is an integer from 50 to 200. In embodiments, the symbol m is an integer from 55 to 200. In embodiments, the symbol m is an integer from 60 to 200. In embodiments, the symbol m is an integer from 65 to 200. In embodiments, the symbol m is an integer from 70 to 200. In embodiments, the symbol m is an integer from 75 to 200. In embodiments, the symbol m is an integer from 80 to 200. In embodiments, the symbol m is an integer from 85 to 200. In embodiments, the symbol m is an integer from 90 to 200. In embodiments, the symbol m is an integer from 95 to 200. In embodiments, the symbol m is an integer from 100 to 200. In embodiments, the symbol m is an integer from 110 to 200. In embodiments, the symbol m is an integer from 120 to 200. In embodiments, the symbol m is an integer from 130 to 200. In embodiments, the symbol m is an integer from 140 to 200. In embodiments, the symbol m is an integer from 150 to 200. In embodiments, the symbol m is an integer from 160 to 200. In embodiments, the symbol m is an integer from 170 to 200. In embodiments, the symbol m is an integer from 180 to 200. In embodiments, the symbol m is an integer from 190 to 200.

In embodiments, the symbol m is an integer from 1 to 175. In embodiments, the symbol m is an integer from 5 to 175. In embodiments, the symbol m is an integer from 10 to 175. In embodiments, the symbol m is an integer from 15 to 175. In embodiments, the symbol m is an integer from 20 to 175. In embodiments, the symbol m is an integer from 25 to 175. In embodiments, the symbol m is an integer from 30 to 175. In embodiments, the symbol m is an integer from 35 to 175. In embodiments, the symbol m is an integer from 40 to 175. In embodiments, the symbol m is an integer from 45 to 175. In embodiments, the symbol m is an integer from 50 to 175. In embodiments, the symbol m is an integer from 55 to 175. In embodiments, the symbol m is an integer from 60 to 175. In embodiments, the symbol m is an integer from 65 to 175. In embodiments, the symbol m is an integer from 70 to 175. In embodiments, the symbol m is an integer from 75 to 175. In embodiments, the symbol m is an integer from 80 to 175. In embodiments, the symbol m is an integer from 85 to 175. In embodiments, the symbol m is an integer from 90 to 175. In embodiments, the symbol m is an integer from 95 to 175. In embodiments, the symbol m is an integer from 100 to 175. In embodiments, the symbol m is an integer from 110 to 175. In embodiments, the symbol m is an integer from 120 to 175. In embodiments, the symbol m is an integer from 130 to 175. In embodiments, the symbol m is an integer from 140 to 175. In embodiments, the symbol m is an integer from 150 to 175. In embodiments, the symbol m is an integer from 160 to 175. In embodiments, the symbol m is an integer from 170 to 175.

In embodiments, the symbol m is an integer from 1 to 150. In embodiments, the symbol m is an integer from 5 to 150. In embodiments, the symbol m is an integer from 10 to 150. In embodiments, the symbol m is an integer from 15 to 150. In embodiments, the symbol m is an integer from 20 to 150. In embodiments, the symbol m is an integer from 25 to 150. In embodiments, the symbol m is an integer from 30 to 150. In embodiments, the symbol m is an integer from 35 to 150. In embodiments, the symbol m is an integer from 40 to 150. In embodiments, the symbol m is an integer from 45 to 150. In embodiments, the symbol m is an integer from 50 to 150. In embodiments, the symbol m is an integer from 55 to 150. In embodiments, the symbol m is an integer from 60 to 150. In embodiments, the symbol m is an integer from 65 to 150. In embodiments, the symbol m is an integer from 70 to 150. In embodiments, the symbol m is an integer from 75 to 150. In embodiments, the symbol m is an integer from 80 to 150. In embodiments, the symbol m is an integer from 85 to 150. In embodiments, the symbol m is an integer from 90 to 150. In embodiments, the symbol m is an integer from 95 to 150. In embodiments, the symbol m is an integer from 100 to 150. In embodiments, the symbol m is an integer from 110 to 150. In embodiments, the symbol m is an integer from 120 to 150. In embodiments, the symbol m is an integer from 130 to 150. In embodiments, the symbol m is an integer from 140 to 150.

In embodiments, the symbol m is an integer from 1 to 125. In embodiments, the symbol m is an integer from 5 to 125. In embodiments, the symbol m is an integer from 10 to 125. In embodiments, the symbol m is an integer from 15 to 125. In embodiments, the symbol m is an integer from 20 to 125. In embodiments, the symbol m is an integer from 25 to 125. In embodiments, the symbol m is an integer from 30 to 125. In embodiments, the symbol m is an integer from 35 to 125. In embodiments, the symbol m is an integer from 40 to 125. In embodiments, the symbol m is an integer from 45 to 125. In embodiments, the symbol m is an integer from 50 to 125. In embodiments, the symbol m is an integer from 55 to 125. In embodiments, the symbol m is an integer from 60 to 125. In embodiments, the symbol m is an integer from 65 to 125. In embodiments, the symbol m is an integer from 70 to 125. In embodiments, the symbol m is an integer from 75 to 125. In embodiments, the symbol m is an integer from 80 to 125. In embodiments, the symbol m is an integer from 85 to 125. In embodiments, the symbol m is an integer from 90 to 125. In embodiments, the symbol m is an integer from 95 to 125. In embodiments, the symbol m is an integer from 100 to 125. In embodiments, the symbol m is an integer from 110 to 125. In embodiments, the symbol m is an integer from 120 to 125.

In embodiments, the symbol m is an integer from 1 to 100. In embodiments, the symbol m is an integer from 5 to 100. In embodiments, the symbol m is an integer from 10 to 100. In embodiments, the symbol m is an integer from 15 to 100. In embodiments, the symbol m is an integer from 20 to 100. In embodiments, the symbol m is an integer from 25 to 100. In embodiments, the symbol m is an integer from 30 to 100. In embodiments, the symbol m is an integer from 35 to 100. In embodiments, the symbol m is an integer from 40 to 100. In embodiments, the symbol m is an integer from 45 to 100. In embodiments, the symbol m is an integer from 50 to 100. In embodiments, the symbol m is an integer from 55 to 100. In embodiments, the symbol m is an integer from 60 to 100. In embodiments, the symbol m is an integer from 65 to 100. In embodiments, the symbol m is an integer from 70 to 100. In embodiments, the symbol m is an integer from 75 to 100. In embodiments, the symbol m is an integer from 80 to 100. In embodiments, the symbol m is an integer from 85 to 100. In embodiments, the symbol m is an integer from 90 to 100. In embodiments, the symbol m is an integer from 95 to 100.

In embodiments, the symbol m is an integer from 1 to 80. In embodiments, the symbol m is an integer from 5 to 80. In embodiments, the symbol m is an integer from 10 to 80. In embodiments, the symbol m is an integer from 15 to 80. In embodiments, the symbol m is an integer from 20 to 80. In embodiments, the symbol m is an integer from 25 to 80. In embodiments, the symbol m is an integer from 30 to 80. In embodiments, the symbol m is an integer from 35 to 80. In embodiments, the symbol m is an integer from 40 to 80. In embodiments, the symbol m is an integer from 45 to 80. In embodiments, the symbol m is an integer from 50 to 80. In embodiments, the symbol m is an integer from 55 to 80. In embodiments, the symbol m is an integer from 60 to 80. In embodiments, the symbol m is an integer from 65 to 80. In embodiments, the symbol m is an integer from 70 to 80. In embodiments, the symbol m is an integer from 75 to 80.

In embodiments, the symbol m is an integer from 1 to 60. In embodiments, the symbol m is an integer from 5 to 60. In embodiments, the symbol m is an integer from 10 to 60. In embodiments, the symbol m is an integer from 15 to 60. In embodiments, the symbol m is an integer from 20 to 60. In embodiments, the symbol m is an integer from 25 to 60. In embodiments, the symbol m is an integer from 30 to 60. In embodiments, the symbol m is an integer from 35 to 60. In embodiments, the symbol m is an integer from 40 to 60. In embodiments, the symbol m is an integer from 45 to 60. In embodiments, the symbol m is an integer from 50 to 60. In embodiments, the symbol m is an integer from 55 to 60.

In embodiments, the symbol m is an integer from 1 to 50. In embodiments, the symbol m is an integer from 5 to 50. In embodiments, the symbol m is an integer from 10 to 50. In embodiments, the symbol m is an integer from 15 to 50. In embodiments, the symbol m is an integer from 20 to 50. In embodiments, the symbol m is an integer from 25 to 50. In embodiments, the symbol m is an integer from 30 to 50. In embodiments, the symbol m is an integer from 35 to 50. In embodiments, the symbol m is an integer from 40 to 50. In embodiments, the symbol m is an integer from 45 to 50.

In embodiments, the symbol m is an integer from 1 to 40. In embodiments, the symbol m is an integer from 5 to 40. In embodiments, the symbol m is an integer from 10 to 40. In embodiments, the symbol m is an integer from 15 to 40. In embodiments, the symbol m is an integer from 20 to 40. In embodiments, the symbol m is an integer from 25 to 40. In embodiments, the symbol m is an integer from 30 to 40. In embodiments, the symbol m is an integer from 35 to 40.

In embodiments, the symbol m is an integer from 1 to 30. In embodiments, the symbol m is an integer from 5 to 30. In embodiments, the symbol m is an integer from 10 to 30. In embodiments, the symbol m is an integer from 15 to 30. In embodiments, the symbol m is an integer from 20 to 30. In embodiments, the symbol m is an integer from 25 to 30. In embodiments, m is 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, or 200. In embodiments, m is 10.

In embodiments, n₁ and n₂ are independently integers from 0 to 20. In embodiments, n₁ and n₂ are independently integers from 0 to 19. In embodiments, n₁ and n₂ are independently integers from 0 to 18. In embodiments, n₁ and n₂ are independently integers from 0 to 17. In embodiments, n₁ and n₂ are independently integers from 0 to 16. In embodiments, n₁ and n₂ are independently integers from 0 to 15. In embodiments, n₁ and n₂ are independently integers from 0 to 14. In embodiments, n₁ and n₂ are independently integers from 0 to 13. In embodiments, n₁ and n₂ are independently integers from 0 to 12. In embodiments, n₁ and n₂ are independently integers from 0 to 11. In embodiments, n₁ and n₂ are independently integers from 0 to 10. In embodiments, n₁ and n₂ are independently integers from 0 to 9. In embodiments, n₁ and n₂ are independently integers from 0 to 8. In embodiments, n₁ and n₂ are independently integers from 0 to 7. In embodiments, n₁ and n₂ are independently integers from 0 to 6. In embodiments, n₁ and n₂ are independently integers from 0 to 5. In embodiments, n₁ and n₂ are independently integers from 0 to 4. In embodiments, n₁ and n₂ are independently integers from 0 to 3. In embodiments, n₁ and n₂ are independently integers from 0 to 2. In embodiments, n₁ and n₂ are independently 1, 2, 3, 4, 5, 6, 7, 8, 9, 10, 11, 12, 13, 14, 15, 16, 17, 18, 19, or 20. In embodiments, n₁ and n₂ are independently 0 or 1.

In formula (I) R¹ may be substituted or unsubstituted alkyl, substituted or unsubstituted heteroalkyl, substituted or unsubstituted cycloalkyl, substituted or unsubstituted heterocycloalkyl, substituted or unsubstituted aryl or substituted or unsubstituted heteroaryl. In embodiments, R¹ is substituted or unsubstituted C₁-C₂₀ (e.g., C₁-C₆) alkyl, substituted or unsubstituted 2 to 20 membered (e.g., 2 to 6 membered) heteroalkyl, substituted or unsubstituted C₃-C₈ (e.g., C₅-C₇) cykloalkyl, substituted or unsubstituted 3 to 8 membered (e.g., 3 to 6 membered) heterocycloalkyl, substituted or unsubstituted C₅-C₁₀ (e.g., C₅-C₆) aryl, or substituted or unsubstituted 5 to 10 membered (e.g., 5 to 6 membered) heteroaryl. In embodiments, R¹ is R¹⁰-substituted or unsubstituted alkyl, R⁴-substituted or unsubstituted heteroalkyl, R⁴-substituted or unsubstituted aryl or R⁴-substituted or unsubstituted cycloalkyl. R⁴ is R⁵-substituted or unsubstituted C₁-C₅₀ alkyl, R⁵-substituted or unsubstituted heteroalkyl, R⁵-substituted or unsubstituted aryl or R⁵-substituted or unsubstituted cycloalkyl. R⁵ is R⁶-substituted or unsubstituted C₁-C₅₀ alkyl, R⁶-substituted or unsubstituted heteroalkyl, R⁶-substituted or unsubstituted aryl or R⁶-substituted or unsubstituted cycloalkyl. R⁶ is R⁷-substituted or unsubstituted C₁-C₅₀ alkyl, R⁷-substituted or unsubstituted heteroalkyl, R⁷-substituted or unsubstituted aryl or R⁷-substituted or unsubstituted cycloalkyl. R⁷ is R⁸-substituted or unsubstituted C₁-C₅₀ alkyl, R⁸-substituted or unsubstituted heteroalkyl, R⁸-substituted or unsubstituted heteroalkyl, R⁸-substituted or unsubstituted aryl or R⁸-substituted or unsubstituted cycloalkyl. R⁸ is R⁹-substituted or unsubstituted C₁-C₅₀ alkyl, R⁹-substituted or unsubstituted heteroalkyl, R⁹-substituted or unsubstituted aryl or R⁹-substituted or unsubstituted cycloalkyl. R⁹ is unsubstituted C₁-C₅₀ alkyl, unsubstituted heteroalkyl, unsubstituted aryl or unsubstituted cycloalkyl. R¹⁰ is unsubstituted heteroalkyl, unsubstituted aryl or unsubstituted cycloalkyl.

In embodiments, R¹ is substituted or unsubstituted C₈-C₅₀ alkyl. In embodiments, R¹ is branched or linear substituted C₈-C₅₀ alkyl. In embodiments, R¹ is branched or linear unsubstituted C₈-C₅₀ alkyl. In embodiments, R¹ is branched substituted C₈-C₅₀ alkyl. In embodiments, R¹ is branched unsubstituted C₈-C₅₀ alkyl. In embodiments, R¹ is linear substituted C₈-C₅₀ alkyl. In embodiments, R¹ is linear unsubstituted C₈-C₅₀ alkyl.

In embodiments, R¹ is substituted or unsubstituted C₁₀-C₅₀ alkyl. In embodiments, R¹ is branched or linear substituted C₁₀-C₅₀ alkyl. In embodiments, R¹ is branched or linear unsubstituted C₁₀-C₅₀ alkyl. In embodiments, R¹ is branched substituted C₁₀-C₅₀ alkyl. In embodiments, R¹ is branched unsubstituted C₁₀-C₅₀ alkyl. In embodiments, R¹ is linear substituted C₁₀-C₅₀ alkyl. In embodiments, R¹ is linear unsubstituted C₁₀-C₅₀ alkyl.

In embodiments, R¹ is substituted or unsubstituted C₁₂-C₅₀ alkyl. In embodiments, R¹ is branched or linear substituted C₁₂-C₅₀ alkyl. In embodiments, R¹ is branched or linear unsubstituted C₁₂-C₅₀ alkyl. In embodiments, R¹ is branched substituted C₁₂-C₅₀ alkyl. In embodiments, R¹ is branched unsubstituted C₁₂-C₅₀ alkyl. In embodiments, R¹ is linear substituted C₁₂-C₅₀ alkyl. In embodiments, R¹ is linear unsubstituted C₁₂-C₅₀ alkyl.

In embodiments, R¹ is substituted or unsubstituted C₁₄-C₅₀ alkyl. In embodiments, R¹ is branched or linear substituted C₁₄-C₅₀ alkyl. In embodiments, R¹ is branched or linear unsubstituted C₁₄-C₅₀ alkyl. In embodiments, R¹ is branched substituted C₁₄-C₅₀ alkyl. In embodiments, R¹ is branched unsubstituted C₁₄-C₅₀ alkyl. In embodiments, R¹ is linear substituted C₁₄-C₅₀ alkyl. In embodiments, R¹ is linear unsubstituted C₁₄-C₅₀ alkyl.

In embodiments, R¹ is substituted or unsubstituted C₁₆-C₅₀ alkyl. In embodiments, R¹ is branched or linear substituted C₁₆-C₅₀ alkyl. In embodiments, R¹ is branched or linear unsubstituted C₁₆-C₅₀ alkyl. In embodiments, R¹ is branched substituted C₁₆-C₅₀ alkyl. In embodiments, R¹ is branched unsubstituted C₁₆-C₅₀ alkyl. In embodiments, R¹ is linear substituted C₁₆-C₅₀ alkyl. In embodiments, R¹ is linear unsubstituted C₁₆-C₅₀ alkyl.

R¹ may be R¹⁰-substituted or unsubstituted alkyl. In embodiments, R¹ is R¹⁰-substituted or unsubstituted C₈-C₅₀ alkyl. In embodiments, R¹ is R¹⁰-substituted or unsubstituted C₁₀-C₅₀ alkyl. In embodiments, R¹ is R¹⁰-substituted or unsubstituted C₁₂-C₅₀ alkyl. In embodiments, R¹ is R¹⁰-substituted or unsubstituted C₁₄-C₅₀ alkyl. In embodiments, R¹ is R¹⁰-substituted or unsubstituted C₁₆-C₅₀ alkyl. In embodiments, R¹ is R¹⁰-substituted or unsubstituted C₁₈-C₅₀ alkyl. In embodiments, R¹ is R¹⁰-substituted or unsubstituted C₂₀-C₅₀ alkyl. In embodiments, R¹ is R¹⁰-substituted or unsubstituted C₂₂-C₅₀ alkyl. In embodiments, R¹ R¹⁰-substituted or unsubstituted C₂₄-C₅₀ alkyl. In embodiments, R¹ is R¹⁰-substituted or unsubstituted C₂₆-C₅₀ alkyl. In embodiments, R¹ is R¹⁰-substituted or unsubstituted C₂₈-C₅₀ alkyl. In embodiments, R¹ is R¹⁰-substituted or unsubstituted C₃₀-C₅₀ alkyl. In other related embodiments, m is as defined in an embodiment above (e.g. m is at least 5, e.g. 10, 15, 20, 25).

In embodiments, R¹ is R¹⁰-substituted or unsubstituted C₈-C₄₅ alkyl. In embodiments, R¹ is R¹⁰-substituted or unsubstituted C₁₀-C₄₅ alkyl. In embodiments, R¹ is R¹⁰-substituted or unsubstituted C₁₂-C₄₅ alkyl. In embodiments, R¹ is R¹⁰-substituted or unsubstituted C₁₄-C₄₅ alkyl. In embodiments, R¹ is R¹⁰-substituted or unsubstituted C₁₆-C₄₅ alkyl. In embodiments, R¹ is R¹⁰-substituted or unsubstituted C₁₈-C₄₅ alkyl. In embodiments, R¹ is R¹⁰-substituted or unsubstituted C₂₀-C₄₅ alkyl. In embodiments, R¹ is R¹⁰-substituted or unsubstituted C₂₂-C₄₅ alkyl. In embodiments, R¹ is R¹⁰-substituted or unsubstituted C₂₄-C₄₅ alkyl. In embodiments, R¹ is R¹⁰-substituted or unsubstituted C₂₆-C₄₅ alkyl. In embodiments, R¹ is R¹⁰-substituted or unsubstituted C₂₈-C₄₅ alkyl. In embodiments, R¹ is R¹⁰-substituted or unsubstituted C₃₀-C₄₅ alkyl. In other related embodiments, m is as defined in an embodiment above (e.g. m is at least 5, e.g. 10, 15, 20, 25).

In embodiments, R¹ is R¹⁰-substituted or unsubstituted C₈-C₄₀ alkyl. In embodiments, R¹ is R¹⁰-substituted or unsubstituted C₁₀-C₄₀ alkyl. In embodiments, R¹ is R¹⁰-substituted or unsubstituted C₁₂-C₄₀ alkyl. In embodiments, R¹ is R¹⁰-substituted or unsubstituted C₁₄-C₄₀ alkyl. In embodiments, R¹ is R¹⁰-substituted or unsubstituted C₁₆-C₄₀ alkyl. In embodiments, R¹ is R¹⁰-substituted or unsubstituted C₁₈-C₄₀ alkyl. In embodiments, R¹ is R¹⁰-substituted or unsubstituted C₂₀-C₄₀ alkyl. In embodiments, R¹ is R¹⁰-substituted or unsubstituted C₂₂-C₄₀ alkyl. In embodiments, R¹ is R¹⁰-substituted or unsubstituted C₂₄-C₄₀ alkyl. In embodiments, R¹ is R¹⁰-substituted or unsubstituted C₂₆-C₄₀ alkyl. In embodiments, R¹ is R¹⁰-substituted or unsubstituted C₂₈-C₄₀ alkyl. In embodiments, R¹ is R¹⁰-substituted or unsubstituted C₃₀-C₄₀ alkyl. In other related embodiments, m is as defined in an embodiment above (e.g. m is at least 5, e.g. 10, 15, 20, 25).

In embodiments, R¹ is R¹⁰-substituted or unsubstituted C₈-C₃₅ alkyl. In embodiments, R¹ is R¹⁰-substituted or unsubstituted C₁₀-C₃₅ alkyl. In embodiments, R¹ is R¹⁰-substituted or unsubstituted C₁₂-C₃₅ alkyl. In embodiments, R¹ is R¹⁰-substituted or unsubstituted C₁₄-C₃₅ alkyl. In embodiments, R¹ is R¹⁰-substituted or unsubstituted C₁₆-C₃₅ alkyl. In embodiments, R¹ is R¹⁰-substituted or unsubstituted C₁₈-C₃₅ alkyl. In embodiments, R¹ is R¹⁰-substituted or unsubstituted C₂₀-C₃₅ alkyl. In embodiments, R¹ is R¹⁰-substituted or unsubstituted C₂₂-C₃₅ alkyl. In embodiments, R¹ is R¹⁰-substituted or unsubstituted C₂₄-C₃₅ alkyl. In embodiments, R¹ is R¹⁰-substituted or unsubstituted C₂₆-C₃₅ alkyl. In embodiments, R¹ is R¹⁰-substituted or unsubstituted C₂₈-C₃₅ alkyl. In embodiments, R¹ is R¹⁰-substituted or unsubstituted C₃₀-C₃₅ alkyl. In some related embodiments, the alkyl is a saturated alkyl. In other related embodiments, m is as defined in an embodiment above (e.g. m is at least 5, e.g. 10, 15, 20, 25).

In embodiments, R¹ is R¹⁰-substituted or unsubstituted C₁₀-C₃₀ alkyl. In embodiments, R¹ is R¹⁰-substituted or unsubstituted C₁₂-C₃₀ alkyl. In embodiments, R¹ is R¹⁰-substituted or unsubstituted C₁₄-C₃₀ alkyl. In embodiments, R¹ is R¹⁰-substituted or unsubstituted C₁₆-C₃₀ alkyl. In embodiments, the alkyl is a branched alkyl. In embodiments, the alkyl is a saturated alkyl. In other related embodiments, m is as defined in an embodiment above (e.g. m is at least 5, e.g. 10, 15, 20, 25).

In embodiments, R¹ is R¹⁰-substituted or unsubstituted C₁₀-C₂₀ alkyl. In embodiments, R¹ is R¹⁰-substituted or unsubstituted C₁₂-C₂₀ alkyl. In embodiments, R¹ is R¹⁰-substituted or unsubstituted C₁₄-C₂₀ alkyl. In embodiments, R¹ is R¹⁰-substituted or unsubstituted C₁₆-C₂₀ alkyl. In embodiments, the alkyl is a branched alkyl. In embodiments, the alkyl is a saturated alkyl. In other related embodiments, m is as defined in an embodiment above (e.g. m is at least 5, e.g. 10, 15, 20, 25).

In embodiments, R¹ is branched unsubstituted C₈-C₅₀ alkyl. In embodiments, R¹ is linear unsubstituted C₈-C₅₀ alkyl. In embodiments, R¹ is branched unsubstituted C₁₀-C₅₀ alkyl. In embodiments, R¹ is linear unsubstituted C₁₀-C₅₀ alkyl. In embodiments, R¹ is branched unsubstituted C₁₂-C₅₀ alkyl. In embodiments, R¹ is linear unsubstituted C₁₂-C₅₀ alkyl. In embodiments, R¹ is branched unsubstituted C₁₄-C₅₀ alkyl. In embodiments, R¹ is linear unsubstituted C₁₄-C₅₀ alkyl. In embodiments, R¹ is branched unsubstituted C₁₆-C₅₀ alkyl. In embodiments, R¹ is linear unsubstituted C₁₆-C₅₀ alkyl. In embodiments, R¹ is branched unsubstituted C₁₈-C₅₀ alkyl. In embodiments, R¹ is linear unsubstituted C₁₈-C₅₀ alkyl. In embodiments, R¹ is branched unsubstituted C₂₀-C₅₀ alkyl. In embodiments, R¹ is linear unsubstituted C₂₀-C₅₀ alkyl. In embodiments, R¹ is branched unsubstituted C₂₂-C₅₀ alkyl. In embodiments, R¹ is linear unsubstituted C₂₂-C₅₀ alkyl. In embodiments, R¹ is branched unsubstituted C₂₄-C₅₀ alkyl. In embodiments, R¹ is linear unsubstituted C₂₄-C₅₀ alkyl. In embodiments, R¹ is branched unsubstituted C₂₆-C₅₀ alkyl. In embodiments, R¹ is linear unsubstituted C₂₆-C₅₀ alkyl. In embodiments, R¹ is branched unsubstituted C₂₈-C₅₀ alkyl. In embodiments, R¹ is linear unsubstituted C₂₈-C₅₀ alkyl. In embodiments, R¹ is branched 5 unsubstituted C₃₀-C₅₀ alkyl. In embodiments, R¹ is linear unsubstituted C₃₀-C₅₀ alkyl. In embodiments, R¹ is branched unsubstituted C₃₂-C₅₀ alkyl. In embodiments, R¹ is linear unsubstituted C₃₂-C₅₀ alkyl. In embodiments, R¹ is branched unsubstituted C₃₄-C₅₀ alkyl. In embodiments, R¹ is linear unsubstituted C₃₄-C₅₀ alkyl. In other related embodiments, m is as defined in an embodiment above (e.g. m is at least 5, e.g. 10, 15, 20, 25).

In embodiments, R¹ is branched unsubstituted C₈-C₄₀ alkyl. In embodiments, R¹ is linear unsubstituted C₈-C₄₀ alkyl. In embodiments, R¹ is branched unsubstituted C₁₀-C₄₀ alkyl. In embodiments, R¹ is linear unsubstituted C₁₀-C₄₀ alkyl. In embodiments, R¹ is branched unsubstituted C₁₂-C₄₀ alkyl. In embodiments, R¹ is linear unsubstituted C₁₂-C₄₀ alkyl. In embodiments, R¹ is branched unsubstituted C₁₄-C₄₀ alkyl. In embodiments, R¹ is linear unsubstituted C₁₄-C₄₀ alkyl. In embodiments, R¹ is branched unsubstituted C₁₆-C₄₀ alkyl. In embodiments, R¹ is linear unsubstituted C₁₆-C₄₀ alkyl. In embodiments, R¹ is branched unsubstituted C₁₈-C₄₀ alkyl. In embodiments, R¹ is linear unsubstituted C₁₈-C₄₀ alkyl. In embodiments, R¹ is branched unsubstituted C₂₀-C₄₀ alkyl. In embodiments, R¹ is linear unsubstituted C₂₀-C₄₀ alkyl. In embodiments, R¹ is branched unsubstituted C₂₂-C₄₀ alkyl. In embodiments, R¹ is linear unsubstituted C₂₂-C₄₀ alkyl. In embodiments, R¹ is branched unsubstituted C₂₄-C₄₀ alkyl. In embodiments, R¹ is linear unsubstituted C₂₄-C₄₀ alkyl. In embodiments, R¹ is branched unsubstituted C₂₆-C₄₀ alkyl. In embodiments, R¹ is linear unsubstituted C₂₆-C₄₀ alkyl. In embodiments, R¹ is branched unsubstituted C₂₈-C₄₀ alkyl. In embodiments, R¹ is linear unsubstituted C₂₈-C₄₀ alkyl. In embodiments, R¹ is branched unsubstituted C₃₀-C₄₀ alkyl. In embodiments, R¹ is linear unsubstituted C₃₀-C₄₀ alkyl. In embodiments, R¹ is branched unsubstituted C₃₂-C₄₀ alkyl. In embodiments, R¹ is linear unsubstituted C₃₂-C₄₀ alkyl. In embodiments, R¹ is branched unsubstituted C₃₄-C₄₀ alkyl. In embodiments, R¹ is linear unsubstituted C₃₄-C₄₀ alkyl. In other related embodiments, m is as defined in an embodiment above (e.g. m is at least 5, e.g. 10, 15, 20, 25).

In embodiments, R¹ is branched unsubstituted C₈-C₃₀ alkyl. In embodiments, R¹ is linear unsubstituted C₈-C₃₀ alkyl. In embodiments, R¹ is branched unsubstituted C₁₀-C₃₀ alkyl. In embodiments, R¹ is linear unsubstituted C₁₀-C₃₀ alkyl. In embodiments, R¹ is branched unsubstituted C₁₂-C₃₀ alkyl. In embodiments, R¹ is linear unsubstituted C₁₂-C₃₀ alkyl. In embodiments, R¹ is branched unsubstituted C₁₄-C₃₀ alkyl. In embodiments, R¹ is linear unsubstituted C₁₄-C₃₀ alkyl. In embodiments, R¹ is branched unsubstituted C₁₆-C₃₀ alkyl. In embodiments, R¹ is linear unsubstituted C₁₆-C₃₀ alkyl. In embodiments, R¹ is branched unsubstituted C₁₈-C₃₀ alkyl. In embodiments, R¹ is linear unsubstituted C₁₈-C₃₀ alkyl. In embodiments, R¹ is branched unsubstituted C₂₀-C₃₀ alkyl. In embodiments, R¹ is linear unsubstituted C₂₀-C₃₀ alkyl. In embodiments, R¹ is branched unsubstituted C₂₂-C₃₀ alkyl. In embodiments, R¹ is linear unsubstituted C₂₂-C₃₀ alkyl. In embodiments, R¹ is branched unsubstituted C₂₄-C₃₀ alkyl. In embodiments, R¹ is linear unsubstituted C₂₄-C₃₀ alkyl. In embodiments, R¹ is branched unsubstituted C₂₆-C₃₀ alkyl. In embodiments, R¹ is linear unsubstituted C₂₆-C₃₀ alkyl. In embodiments, R¹ is branched unsubstituted C₂₈-C₃₀ alkyl. In embodiments, R¹ is linear unsubstituted C₂₈-C₃₀ alkyl. In other related embodiments, m is as defined in an embodiment above (e.g. m is at least 5, e.g. 10, 15, 20, 25).

In embodiments, where R¹ is a linear or branched unsubstituted alkyl (e.g. branched unsubstituted C₁₀-C₅₀ alkyl), the alkyl is a saturated alkyl (e.g. a linear or branched unsubstituted saturated alkyl or branched unsubstituted C₁₀-C₅₀ saturated alkyl). A “saturated alkyl,” as used herein, refers to an alkyl consisting only of hydrogen and carbon atoms and are bonded exclusively by single bonds. Thus, in embodiments, R¹ may be linear or branched unsubstituted saturated alkyl. In embodiments, R¹ is branched unsubstituted C₁₀-C₅₀ saturated alkyl. In embodiments, R¹ is linear unsubstituted C₁₀-C₅₀ saturated alkyl. In embodiments, R¹ is branched unsubstituted C₁₂-C₃₀ saturated alkyl. In embodiments, R¹ is linear unsubstituted C₁₂-C₃₀ saturated alkyl. In embodiments, R¹ is branched unsubstituted C₁₂-C₂₀ saturated alkyl. In embodiments, R¹ is linear unsubstituted C₁₂-C₂₀ saturated alkyl. In embodiments, R¹ is linear unsubstituted C₁₂-C₁₆ saturated alkyl. In embodiments, R¹ is branched unsubstituted C₁₂-C₁₆ saturated alkyl. In embodiments, R¹ is linear unsubstituted C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₂₆, C₂₇, C₂₈, C₂₉, C₃₀, C₃₁, C₃₂, C₃₃, C₃₄, C₃₅, C₃₆, C₃₇, C₃₈, C₃₉, or C₄₀ saturated alkyl.

In formula (I), R² is hydrogen or substituted or unsubstituted alkyl. In embodiments, R² is hydrogen or substituted or unsubstituted C₁-C₂₀ (e.g., C₁-C₆) alkyl. In embodiments, R² is hydrogen or unsubstituted C₁-C₆ alkyl. In embodiments, R² is hydrogen or unsubstituted C₁-C₅ alkyl. In embodiments, R² is branched unsubstituted C₁-C₅ saturated alkyl. In embodiments, R² is linear unsubstituted C₁-C₅ saturated alkyl. In embodiments, R² is hydrogen or unsubstituted C₁-C₂ alkyl. In embodiments, R² is hydrogen or methyl. In embodiments, R² is hydrogen or unsubstituted ethyl. In embodiments, R² is hydrogen or branched unsubstituted C₁ or C₂ saturated alkyl. In embodiments, R² is hydrogen or linear unsubstituted C₁ or C₂ saturated alkyl. In embodiments, R² is branched unsubstituted C₁-C₆ saturated alkyl. In embodiments, R² is linear unsubstituted C₁-C₆ saturated alkyl. In embodiments, R² is hydrogen.

In formula (I), R^{3A} and R^{3B} are independently hydrogen or substituted or unsubstituted alkyl. In embodiments, R^{3A} and R^{3B} are independently hydrogen or substituted or unsubstituted C₁-C₂₀ (e.g., C₁-C₆) alkyl. In embodiments, R^{3A} and R^{3B} are independently hydrogen or substituted C₁-C₆ alkyl. In embodiments, R^{3A} and R^{3B} are independently hydrogen or substituted C₁-C₅ alkyl. In embodiments, R^{3A} and R^{3B} are independently hydrogen or substituted C₁-C₄ alkyl. In embodiments, R^{3A} and R^{3B} are independently hydrogen or substituted C₁-C₃ alkyl. In embodiments, R^{3A} and R^{3B} are independently hydrogen or substituted C₁-C₂ alkyl.

In embodiments, R^{3A} and R^{3B} are independently hydrogen or unsubstituted C₁-C₆ alkyl. In embodiments, R^{3A} and R^{3B} are independently hydrogen or unsubstituted C₁-C₅ alkyl. In embodiments, R^{3A} and R^{3B} are independently hydrogen or unsubstituted C₁-C₄ alkyl. In embodiments, R^{3A} and R^{3B} are independently hydrogen or unsubstituted C₁-C₃ alkyl. In embodiments, R^{3A} and R^{3B} are independently hydrogen or unsubstituted C₁-C₂ alkyl.

In embodiments, R^{3A} and R^{3B} are independently branched unsubstituted C₁-C₆ saturated alkyl. In embodiments, R^{3A} and R^{3B} are independently linear unsubstituted C₁-C₆ saturated alkyl. In embodiments, R^{3A} and R^{3B} are independently branched unsubstituted C₁-C₅ saturated alkyl. In embodiments, R^{3A} and R^{3B} are independently linear unsubstituted C₁-C₅ saturated alkyl. In embodiments, R^{3A} and R^{3B} are independently branched unsubstituted C₁-C₄ saturated alkyl. In embodiments, R^{3A} and R^{3B} are independently linear unsubstituted C₁-C₄ saturated alkyl. In embodiments, R^{3A} and R^{3B} are independently branched unsubstituted C₁-C₃ saturated alkyl. In embodiments, R^{3A} and R^{3B} are independently linear unsubstituted C₁-C₃ saturated alkyl. In embodiments, R^{3A} and R^{3B} are independently hydrogen or unsubstituted C₁-C₂ alkyl. In embodiments, R^{3A} and R^{3B} are independently hydrogen or methyl. In embodiments, R^{3A} and R^{3B} are independently hydrogen or unsubstituted ethyl. In embodiments, R^{3A} and R^{3B} are independently hydrogen or unsubstituted C₁ or C₂ saturated alkyl. In embodiments, R^{3A} and R^{3B} are independently hydrogen or linear unsubstituted C₁ or C₂ saturated alkyl. In embodiments, R^{3A} and R^{3B} are independently hydrogen, methyl or ethyl. In embodiments, R^{3A} and R^{3B} are independently hydrogen or methyl. In embodiments, R^{3A} and R^{3B} are independently hydrogen or ethyl. In embodiments, R^{3A} and R^{3B} are independently methyl or ethyl.

In formula (I), L¹ may be substituted or unsubstituted alkylene. In embodiments, L¹ is substituted or unsubstituted C₁-C₂₀ (e.g., C₁-C₆) alkylene. In embodiments, L¹ is substituted or unsubstituted C₂-C₂₀ (e.g., C₂-C₆) alkylene. In embodiments, L¹ is substituted or unsubstituted C₂-C₁₉ alkylene. In embodiments, L¹ is substituted or unsubstituted C₂-C₁₈ alkylene. In embodiments, L¹ is substituted or unsubstituted C₂-C₁₇ alkylene. In embodiments, L¹ is substituted or unsubstituted C₂-C₁₆ alkylene. In embodiments, L¹ is substituted or unsubstituted C₂-C₁₅ alkylene. In embodiments, L¹ is substituted or unsubstituted C₂-C₁₄ alkylene. In embodiments, L¹ is substituted or unsubstituted C₂-C₁₃ alkylene. In embodiments, L¹ is substituted or unsubstituted C₂-C₁₂ alkylene. In embodiments, L¹ is substituted or unsubstituted C₂-C₁₁ alkylene. In embodiments, L¹ is substituted or unsubstituted C₂-C₁₀ alkylene. In embodiments, L¹ is substituted or unsubstituted C₂-C₉ alkylene. In embodiments, L¹ is substituted or unsubstituted C₂-C₈ alkylene. In embodiments, L¹ is substituted or unsubstituted C₂-C₇ alkylene. In embodiments, L¹ is substituted or unsubstituted C₂-C₆ alkylene. In embodiments, L¹ is substituted or unsubstituted C₂-C₅ alkylene. In embodiments, L¹ is substituted or unsubstituted C₂-C₄ alkylene. In embodiments, L¹ is substituted or unsubstituted C₂-C₃ alkylene. In embodiments, L¹ is substituted or unsubstituted C₁-C₂ alkylene.

In embodiments, L¹ is unsubstituted C₂-C₆ alkylene. In embodiments, L¹ is unsubstituted C₂-C₅ alkylene. In embodiments, L¹ is unsubstituted C₂-C₄ alkylene. In embodiments, L¹ is unsubstituted C₂-C₃ alkylene. In embodiments, L¹ is unsubstituted C₁-C₂ alkylene. In embodiments, L¹ is unsubstituted ethylene. In embodiments, L¹ is substituted C₂-C₆ alkylene. In embodiments, L¹ is substituted C₂-C₅ alkylene. In embodiments, L¹ is substituted C₂-C₄ alkylene. In embodiments, L¹ is substituted C₂-C₃ alkylene. In embodiments, L¹ is substituted C₁-C₂ alkylene. In embodiments, L¹ is

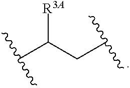

In embodiments, L¹ is

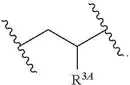

In embodiments, L¹ is

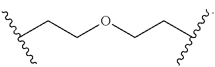 [SMILES: *CCOCC*]

In embodiments, L¹ is substituted or unsubstituted cycloalkylene or substituted or unsubstituted arylene. In embodiments, L¹ is substituted or unsubstituted C₆-C₁₅ cycloalkylene. In embodiments, L¹ is substituted or unsubstituted C₆-C₁₅ arylene. In embodiments, L¹ is cyclohexylene-diol, biscyclohexylene-diol, dihydroxy benzylene, bisphenylene, or dihydroxy naphthylene.

M⁺ may be a monovalent, divalent or trivalent cation. In embodiments, M⁺ is a monovalent, divalent or trivalent metal cation. In embodiments, M⁺ is a monovalent or divalent cation (e.g. metal cation). In embodiments, M⁺ is a monovalent cation (e.g. metal cation). In embodiments, M⁺ is a divalent cation (e.g. metal cation). In embodiments, M⁺ is Na⁺, K⁺, NH₄⁺, Ca⁺², Mg⁺² or Ba⁺². A person having ordinary skill in the art will immediately recognize that M⁺ may be a divalent cation where it is coordinated with a monovalent anion (e.g. where M⁺ is coordinated with more than one compound provided herein or with an additional anion in the surrounding liquid environment).

In embodiments the compound of formula (I), or embodiments thereof disclosed herein (e.g. formula (II), (III), (IV), (VIII) or (IX)) the compound has a molecular weight of at least about 1500 g/mol. In embodiments of the compound of formula (I), or embodiments thereof disclosed herein, the compound has a molecular weight of at least 1 about 600 g/mol. In embodiments of the compound of formula (I), or embodiments thereof disclosed herein, the compound has a molecular weight of at least 200 about 600 g/mol. In embodiments of the compound of formula (I), or embodiments thereof disclosed herein, the compound has a molecular weight of at least about 1700 g/mol. In embodiments of the compound of formula (I), or embodiments thereof disclosed herein, the compound has a molecular weight of at least about 1800 g/mol. In embodiments of the compound of formula (I), or embodiments thereof disclosed herein, the compound has a molecular weight of at least about 1900 g/mol. In embodiments of the compound of formula (I), or embodiments thereof disclosed herein, the compound has a molecular weight of at least about 2000 g/mol. In embodiments of the compound of formula (I), or embodiments thereof disclosed herein, the compound has a molecular weight of at least about 2100 g/mol. In embodiments of the compound of formula (I), or embodiments thereof disclosed herein, the compound has a molecular weight of at least about 2200 g/mol. In embodiments of the compound of formula (I), or embodiments thereof disclosed herein, the compound has a molecular weight of at least about 2300 g/mol. In embodiments of the compound of formula (I), or embodiments thereof disclosed herein, the compound has a molecular weight of at least about 2400 g/mol. In embodiments of the compound of formula (I), or embodiments thereof disclosed herein, the compound has a molecular weight of at least about 2500 g/mol. In embodiments of the compound of formula (I), or embodiments thereof disclosed herein, the compound has a molecular weight of at least about 2600 g/mol. In embodiments of the compound of formula (I), or embodiments thereof disclosed herein, the compound has a molecular weight of at least about 2700 g/mol. In embodiments of the compound of formula (I), or embodiments thereof disclosed herein, the compound has a molecular weight of at least about 2800 g/mol. In embodiments of the compound of formula (I), or embodiments thereof disclosed herein, the compound has a molecular weight of at least about 2900 g/mol. In embodiments of the compound of formula (I), or embodiments thereof disclosed herein, the compound has a molecular weight of at least about 3000 g/mol.

In embodiments, the compound has the formula:

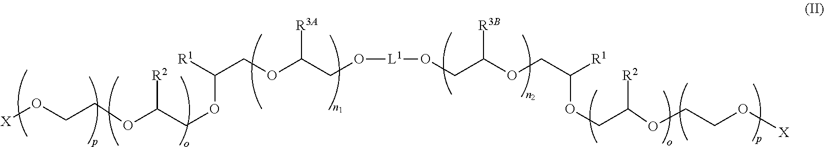

where o is an integer from 1 to 100 and p is an integer from 0 to 100. In formula (II) R¹, R², R^{3A}, R^{3B}, L¹, n₁, n₂ and X are defined as above (e.g., in formula (I)).

In embodiments, p is 0 to 100. In embodiments, p is 5 to 100. In embodiments, p is 10 to 100. In embodiments, p is 15 to 100. In embodiments, p is 20 to 100. In embodiments, p is 25 to 100. In embodiments, p is 30 to 100. In embodiments, p is 35 to 100. In embodiments, p is 40 to 100. In embodiments, p is 45 to 100. In embodiments, p is 50 to 100. In embodiments, p is 55 to 100. In embodiments, p is 60 to 100. In embodiments, p is 65 to 100. In embodiments, p is 70 to 100. In embodiments, p is 75 to 100. In embodiments, p is 80 to 100. In embodiments, p is 85 to 100. In embodiments, p is 90 to 100. In embodiments, p is 95 to 100. In embodiments, p is more than 5. In embodiments, p is 0, 1, 5, 10, 15, 20, 25, 30, 35, 40, 45, 50, 55, 60, 65, 70, 75, 80, 85, 90, 95 or 100. In some further related embodiments, p is 0. In some related embodiments, o is 1 to 100. In some further related embodiments, o is 5 to 100. In some further related embodiments, o is 10 to 100. In some further related embodiments, o is 20 to 100. In some further related embodiments, o is 30 to 100. In some further related embodiments, o is 40 to 100. In some further related embodiments, o is 50 to 100. In some further related embodiments, o is 60 to 100. In some further related embodiments, o is 70 to 100. In some further related embodiments, o is 80 to 100. In some further related embodiments, o is 90 to 100. In some further related embodiments, o is more than 5. In embodiments, o is 1, 5, 10, 15, 20, 25, 30, 35, 40, 45, 50, 55, 60, 65, 70, 75, 80, 85, 90, 95 or 100. R¹, R², R^{3A}, R^{3B}, n₁, n₂ and X may be any of the embodiments described above (e.g. R¹ may be branched unsubstituted C₁₀-C₅₀ alkyl; R² may be hydrogen or methyl; R^{3A} and R^{3B} may be independently hydrogen or methyl; L¹ may be unsubstituted ethylene; n₁ and n₂ may be independently 0 or 1; X may be —SO₃⁻M⁺ and M⁺ may be Na⁺).

In embodiments, the compound has the formula:

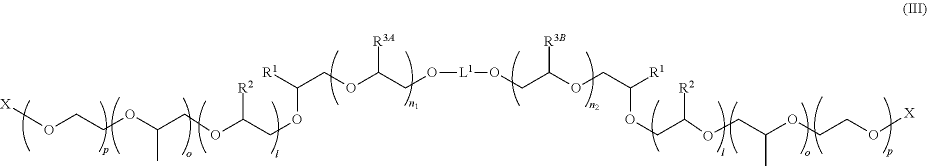

where o is an integer from 1 to 50, p is an integer from 0 to 50, and l is an integer from 0 to 50. In formula (III) R¹, R², R^{3A}, R^{3B}, L¹, n₁, n₂ and X are defined as above (e.g., in formula (I)).

In embodiments, p is 0 to 50. In embodiments, p is 5 to 50. In embodiments, p is 10 to 50. In embodiments, p is 15 to 50. In embodiments, p is 20 to 50. In embodiments, p is 25 to 50. In embodiments, p is 30 to 50. In embodiments, p is 35 to 50. In embodiments, p is 40 to 50. In embodiments, p is 45 to 50. In embodiments, p is more than 5. In embodiments, p is 0, 1, 5, 10, 15, 20, 25, 30, 35, 40, 45, or 50. In some further related embodiments, p is 0. In some related embodiments, o is 1 to 50. In some further related embodiments, o is 5 to 50. In some further related embodiments, o is 10 to 50. In some further related embodiments, o is 20 to 50. In some further related embodiments, o is 30 to 50. In some further related embodiments, o is 40 to 50. In some further related embodiments, o is more than 5. In some further embodiments, o is 1, 5, 10, 15, 20, 25, 30, 35, 40, 45, or 50. Moreover, in still further related embodiments, 1 is 0 to 50. In still further related embodiments, 1 is 5 to 50. In still further related embodiments, 1 is 10 to 50. In still further related embodiments, 1 is 15 to 50. In still further related embodiments, 1 is 20 to 50. In still further related embodiments, 1 is 25 to 50. In still further related embodiments, 1 is 30 to 50. In still further related embodiments, 1 is 35 to 50. In still further related embodiments, 1 is 40 to 50. In still further related embodiments, 1 is 45 to 50. In still further related embodiments, 1 is more than 5. In still further related embodiments, 1 is 0. In still further related embodiments, 1 is 0, 1, 5, 10, 15, 20, 25, 30, 35, 40, 45, or 50. R¹, R², R^{3A}, R^{3B}, L¹, n₁, n₂ and X may be any of the embodiments described above (e.g. R¹ may be branched unsubstituted C₁₀-C₅₀ alkyl; R² may be hydrogen or methyl; R^{3A} and R^{3B} may be independently hydrogen or methyl; L¹ may be unsubstituted ethylene; n₁ and n₂ may be independently 0 or 1; X may be —SO₃⁻M⁺ and M⁺ may be Na⁺).

In embodiments, the compound has the formula:

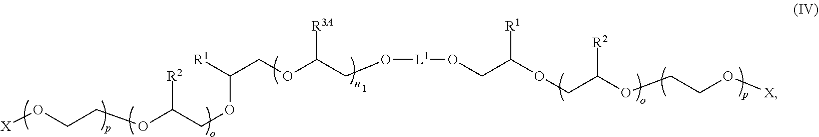

where o is an integer from 1 to 100 and p is an integer from 0 to 100.

In embodiments, p is 0 to 100. In embodiments, p is 5 to 100. In embodiments, p is 10 to 100. In embodiments, p is 15 to 100. In embodiments, p is 20 to 100. In embodiments, p is 25 to 100. In embodiments, p is 30 to 100. In embodiments, p is 35 to 100. In embodiments, p is 40 to 100. In embodiments, p is 45 to 100. In embodiments, p is 50 to 100. In embodiments, p is 55 to 100. In embodiments, p is 60 to 100. In embodiments, p is 65 to 100. In embodiments, p is 70 to 100. In embodiments, p is 75 to 100. In embodiments, p is 80 to 100. In embodiments, p is 85 to 100. In embodiments, p is 90 to 100. In embodiments, p is 95 to 100. In embodiments, p is more than 5. In embodiments, p is 0, 1, 5, 10, 15, 20, 25, 30, 35, 40, 45, 50, 55, 60, 65, 70, 75, 80, 85, 90, 95 or 100. In some further related embodiments, p is 0. In some related embodiments, o is 1 to 100. In some further related embodiments, o is 5 to 100. In some further related embodiments, o is 10 to 100. In some further related embodiments, o is 20 to 100. In some further related embodiments, o is 30 to 100. In some further related embodiments, o is 40 to 100. In some further related embodiments, o is 50 to 100. In some further related embodiments, o is 60 to 100. In some further related embodiments, o is 70 to 100. In some further related embodiments, o is 80 to 100. In some further related embodiments, o is 90 to 100. In some further related embodiments, o is more than 5. In embodiments, o is 1, 5, 10, 15, 20, 25, 30, 35, 40, 45, 50, 55, 60, 65, 70, 75, 80, 85, 90, 95 or 100. R¹, R², R^{3A}, L¹, n₁, and X may be any of the embodiments described above (e.g. R¹ may be branched unsubstituted C₁₀-C₅₀ alkyl; R² may be hydrogen or methyl; R^{3A} may be hydrogen or methyl; L¹ may be unsubstituted ethylene; n₁ may be 0 or 1; X may be —SO₃⁻M⁺ and M⁺ may be Na⁺). Thus, in further embodiments, R^{3A} is hydrogen. In other further embodiments, L¹ is unsubstituted ethylene. In other further embodiments, n₁ is 1. In other further embodiments, o is an integer from 1-30. In other further embodiments, p is 0.

In embodiments, the compound has formula:

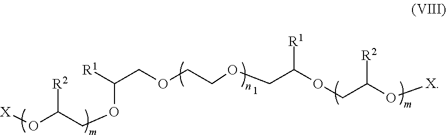

In formula (VIII) R¹, R², m, n₁, and X may be any of the embodiments described above (e.g. R¹ may be branched unsubstituted C₁₀-C₅₀ alkyl; R² may be hydrogen or methyl; m may be 5 to 150; n₁ may be 1; X may be —SO₃⁻M⁺ and M⁺ may be Na⁺). Thus, in further embodiments, R¹ is unsubstituted C₁₆-C₂₀ alkyl. In other further embodiments, R² is unsubstituted ethylene. In other further embodiments, m is an integer from 1-30. In other further embodiments, n₁ is 1.

In embodiments, the compound has formula:

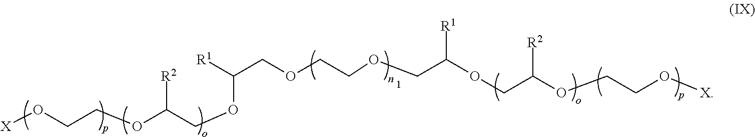

In formula (IX) R¹, R², o, p, n₁, and X may be any of the embodiments described above (e.g. R¹ may be branched unsubstituted C₁₀-C₅₀ alkyl; R² may be hydrogen or methyl; o may be 1 to 100; p may be 0 to 100; n₁ may be 1; X may be —SO₃⁻M and M⁺ may be Na⁺). Thus, in further embodiments, R¹ is unsubstituted C₁₆-C₂₀ alkyl. In other further embodiments, R² is unsubstituted ethylene. In other further embodiments, o is an integer from 1-30. In other further embodiments, p is an integer from 0-50. In other further embodiments, n₁ is 1.

In one embodiment, the compound has the structure of formula (I), wherein R¹ is unsubstituted saturated Cis alkyl; R² is methyl; m is 10; L¹ is unsubstituted ethylene; n₁ is 1 and n₂ is 0; R^{3A} hydrogen; X is —SO₃⁻M⁺ and M⁺ is Na⁺.

In embodiments, where multiple R² substituents are present and at least two R² substituents are different, the R² substituents with the fewest number of carbons are present on the side of the compound of formula (I), (II), (III) or (IV) bound to the X substituent. In this embodiment, the compound of formula (I), (II), (III) or (IV) will be increasingly hydrophilic in progressing from the R¹ substituent to the side of the compound of formula (I), (II), (III) or (IV) bound to the X substituent. The term “side of the compound of formula ((I), (II), (III) or (IV) bound to the X substituent” refers to the side of the compound indicated by asterisks in the below structures and is alternatively referred to as the ends of the compound:

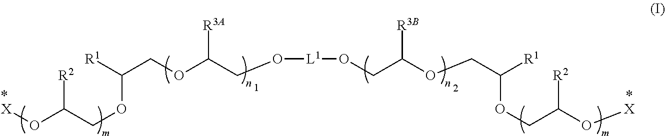

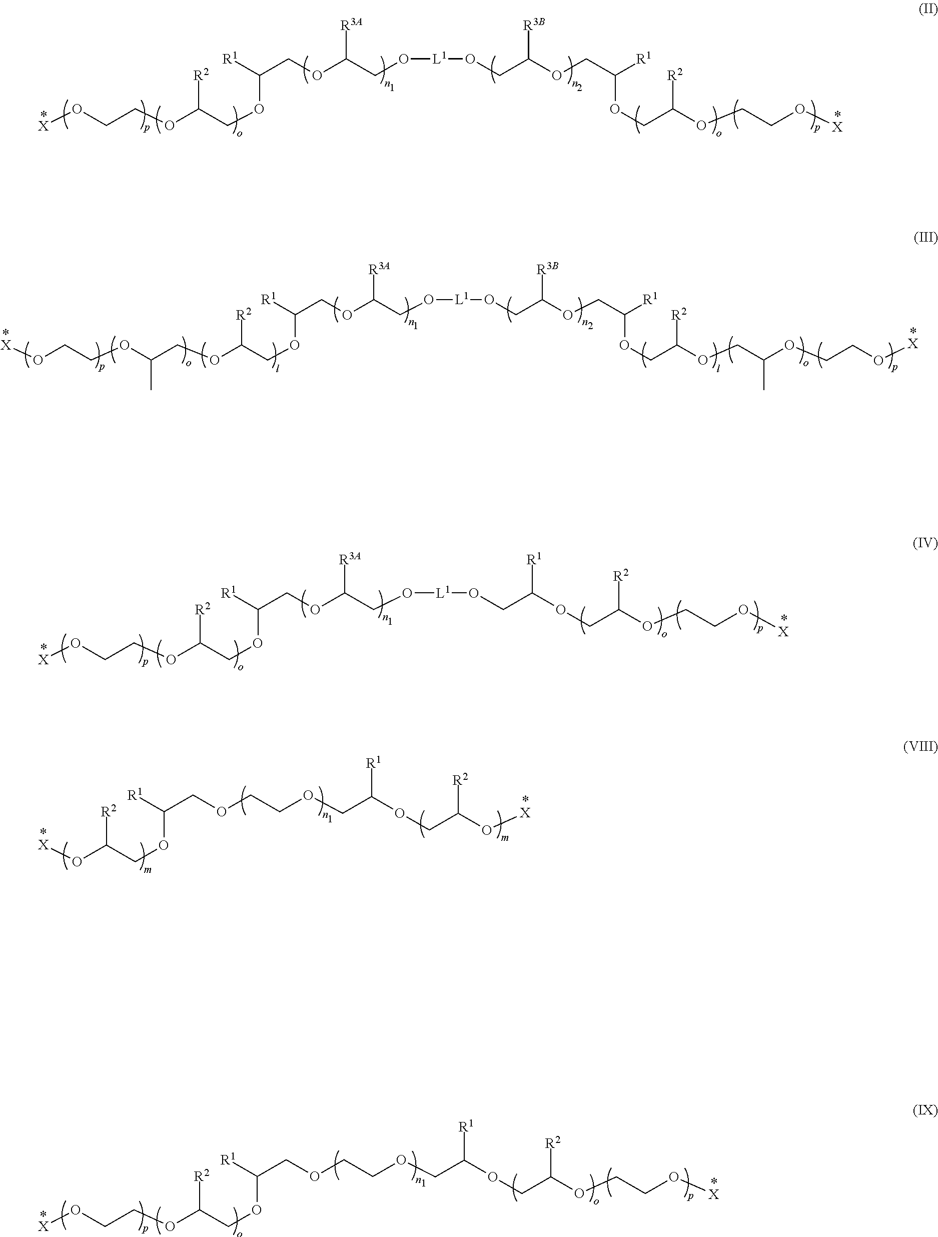

In another aspect, an aqueous composition including a co-surfactant and a compound as provided herein (e.g., a compound of formula (I), (II), (III), (IV), (VIII) or (IX)) including embodiments thereof is provided. A co-surfactant, as used herein, is a compound within the aqueous composition that functions as a surface active agent when the aqueous composition is in contact with a crude oil (e.g. an unrefined petroleum). The co-surfactant, along with the compound of formula (I), (II), (III), (IV), (VIII) or (IX), may act to lower the interfacial tension and/or surface tension of the unrefined petroleum. In embodiments, the co-surfactant and the compound of formula (I), (II), (III), (IV), (VIII) or (IX) are present in synergistic surface active amounts. A “synergistic surface active amount,” as used herein, means that a compound of formula (I), (II), (III), (IV), (VIII) or (IX) and the co-surfactant are present in amounts in which the oil surface activity (interfacial tension lowering effect and/or surface tension lowering effect on crude oil when the aqueous composition is added to the crude oil) of the compound and co-surfactant combined is greater than the additive oil surface activity of the co-surfactant individually and the compound individually. In some cases, the oil surface activity of the compound and co-surfactant combination is 10%, 20%, 30%, 40%, 50%, 60%, 70%, 80%, 90% or 100% more than the additive oil surface activity of the co-surfactant individually and the compound individually. In embodiments, the oil surface activity of the compound and co-surfactant combination is 2, 3, 4, 5, 6, 7, 8, 9 or 10 times more than the additive oil surface activity of the co-surfactant individually and the compound individually.

In another embodiment, the compound and co-surfactant are present in a surfactant stabilizing amount. A “surfactant stabilizing amount” means that the compound and the co-surfactant are present in an amount in which the co-surfactant degrades at a slower rate in the presence of the compound than in the absence of the compound, and/or the compound degrades at a slower rate in the presence of the co-surfactant than in the absence of the co-surfactant. The rate of degradation may be 10%, 20%, 30%, 40%, 50%, 60%, 70%, 80%, 90% or 100% slower. In embodiments, the rate of degradation is 2, 3, 4, 5, 6, 7, 8, 9 or 10 times slower.

In embodiments, the co-surfactant is present at an amount sufficient to increase the stability (e.g., thermal stability) of the compound in the aqueous composition relative to the absence of the co-surfactant. Where the co-surfactant is present at an amount sufficient to increase the stability (e.g., thermal stability) of the compound in the aqueous composition relative to the absence of the co-surfactant, the compound is more stable in the presence of the co-surfactant than in the absence of the co-surfactant. In further embodiments, the pH of the aqueous composition is at least 8. In further embodiments, the pH of the aqueous composition is at least 9. In further embodiments, the pH of the aqueous composition is at least 10. In further embodiments, the pH of the aqueous composition is at least 11.

In embodiments, the compound (e.g., a compound of formula (I), (II), (III), (IV), (VIII) or (IX)) is present at an amount sufficient to increase the stability (e.g., thermal stability) of the co-surfactant in the aqueous composition relative to the absence of the compound. Where the compound (e.g., a compound of formula (I), (II), (III), (IV), (VIII) or (IX)) is present at an amount sufficient to increase the stability (e.g., thermal stability) of the co-surfactant in the aqueous composition relative to the absence of the compound, the co-surfactant is more stable in the presence of the compound than in the absence of the compound. In further embodiments, the pH of the aqueous composition is at least 8. In further embodiments, the pH of the aqueous composition is at least 9. In further embodiments, the pH of the aqueous composition is at least 10. In further embodiments, the pH of the aqueous composition is at least 11.

In another embodiment, the compound and co-surfactant are present in a synergistic solubilizing amount. A “synergistic solubilizing amount” means that the compound and the co-surfactant are present in an amount in which the compound is more soluble in the presence of the co-surfactant than in the absence of the surfactant, and/or the co-surfactant is more soluble in the presence of the compound than in the absence of the compound. The solubilization may be 10%, 20%, 30%, 40%, 50%, 60%, 70%, 80%, 90% or 100% higher. In some embodiment, the solubilization is 2, 3, 4, 5, 6, 7, 8, 9 or 10 times higher. In embodiments, the compound is present in an amount sufficient to increase the solubility of the co-surfactant in the aqueous composition relative to the absence of the compound. In other words, in the presence of a sufficient amount of the compound, the solubility of the co-surfactant in the aqueous composition is higher than in the absence of the compound. In embodiments, the co-surfactant is present in an amount sufficient to increase the solubility of the compound in the aqueous composition relative to the absence of the co-surfactant. Thus, in the presence of a sufficient amount of the co-surfactant the solubility of the compound in the aqueous solution is higher than in the absence of the co-surfactant.

In embodiments, a single type of co-surfactant is present in the aqueous composition. In embodiments, a plurality of co-surfactant types is present in the aqueous composition. Where the emulsion further includes a co-surfactant, the emulsion may include a co-surfactant or a co-surfactant blend (e.g. a plurality of co-surfactant types). The co-surfactant provided herein may be any appropriate co-surfactant useful in the field of enhanced oil recovery. In embodiments, the co-surfactant is a single co-surfactant type in the aqueous composition or emulsion composition. In embodiments, the co-surfactant is a co-surfactant blend. A “co-surfactant blend” as provided herein is a mixture of a plurality of co-surfactant types. In embodiments, the co-surfactant blend includes a first co-surfactant type, a second co-surfactant type or a third co-surfactant type. The first, second and third co-surfactant type may be independently different (e.g. anionic or cationic co-surfactants; or two anionic co-surfactants having a different hydrocarbon chain length but are otherwise the same). Therefore, a person having ordinary skill in the art will immediately recognize that the terms “co-surfactant” and “co-surfactant type(s)” have the same meaning and can be used interchangeably.

In embodiments, the co-surfactant is an anionic surfactant, a non-ionic surfactant, a zwitterionic surfactant or a cationic surfactant. In embodiments, the co-surfactant is an anionic surfactant, a non-ionic surfactant or a cationic surfactant. In embodiments, the co-surfactant is a zwitterionic co-surfactant. “Zwitterionic” or “zwitterion” as used herein refers to a neutral molecule with a positive (or cationic) and a negative (or anionic) electrical charge at different locations within the same molecule. Examples for zwitterionics are without limitation betains and sultains.

The co-surfactant as provided herein may be a combination of one or more anionic, non-ionic, cationic or zwitterionic co-surfactants. In embodiments, the co-surfactant is an internal olefin sulfonate (IOS), an alfa olefin sulfonate (AOS), an alkyl aryl sulfonate (ARS), an alkane sulfonate, a petroleum sulfonate, an alkyl diphenyl oxide (di)sulfonate, an alcohol sulfate, an alkoxy sulfate, an alkoxy sulfonate, an alkoxy carboxylate, an alcohol phosphate, an alkoxy phosphate, a sulfosuccinate ester, an alcohol ethoxylate, an alkyl phenol ethoxylate, a quaternary ammonium salt, a betaine or sultaine. The co-surfactant as provided herein, may also be a soap.

The co-surfactant provided herein may be any appropriate anionic surfactant. In embodiments, the co-surfactant is an anionic surfactant. In embodiments, the anionic co-surfactant is an anionic surfactant blend. Where the anionic surfactant is an anionic surfactant blend, the aqueous composition includes a plurality (i.e. more than one) of anionic surfactant types. In embodiments, the anionic surfactant is an alkoxy carboxylate surfactant, an alkoxy sulfate surfactant, an alkoxy sulfonate surfactant, an alkyl sulfonate surfactant, an aryl sulfonate surfactant or an olefin sulfonate surfactant. An “alkoxy carboxylate surfactant” or “alkoxy carboxylate” as provided herein is a compound having an alkyl or aryl attached to one or more alkoxylene groups (typically —CH₂—CH(ethyl)-O—, —CH₂—CH(methyl)-O—, or —CH₂—CH₂—O—) which, in turn is attached to —COO⁻ or acid or salt thereof including metal cations such as sodium. In embodiments, the alkoxy carboxylate surfactant has the formula:

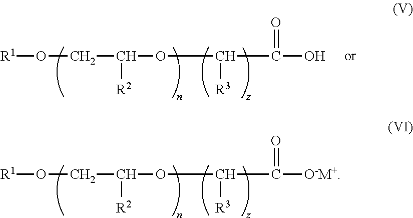

In formula (V) or (VI) R¹ is substituted or unsubstituted C₈-C₁₅₀ alkyl or substituted or unsubstituted aryl, R² is independently hydrogen or unsubstituted C₁-C₆ alkyl, R³ is independently hydrogen or unsubstituted C₁-C₆ alkyl, n is an integer from 2 to 210, z is an integer from 1 to 6 and M⁺ is a monovalent, divalent or trivalent cation. In embodiments, R¹ is unsubstituted linear or branched C₈-C₃₆ alkyl. In embodiments, R¹ is (C₆H₅—CH₂CH₂)₃C₆H₂—(TSP), (C₆H₅—CH₂CH₂)₂C₆H₃— (DSP), (C₆H₅—CH₂CH₂)₁C₆H₄— (MSP), or substituted or unsubstituted naphthyl. In embodiments, the alkoxy carboxylate is C₂₈-25PO-25EO-carboxylate (i.e. unsubstituted C₂₈ alkyl attached to 25 —CH₂—CH(methyl)-O-linkers, attached in turn to 25 —CH₂—CH₂—O— linkers, attached in turn to —COO⁻ or acid or salt thereof including metal cations such as sodium).

In embodiments, the co-surfactant is an alkoxy sulfate surfactant. An alkoxy sulfate surfactant as provided herein is a surfactant having an alkyl or aryl attached to one or more alkoxylene groups (typically —CH₂—CH(ethyl)-O—, —CH₂—CH(methyl)-O—, or —CH₂—CH₂—O—) which, in turn is attached to —SO₃⁻ or acid or salt thereof including metal cations such as sodium. In some embodiment, the alkoxy sulfate surfactant has the formula R^{A}—(BO)ₑ—(PO)_{f}-(EO)_{g}—SO₃⁻ or acid or salt (including metal cations such as sodium) thereof, wherein R^{A} is C₈-C₃₀ alkyl, BO is —CH₂—CH(ethyl)-O—, PO is —CH₂—CH(methyl)-O—, and EO is —CH₂—CH₂—O—. The symbols e, f and g are integers from 0 to 25 wherein at least one is not zero. In some embodiment, the alkoxy sulfate surfactant is C₁₈-13PO-sulfate (i.e. an unsubstituted C₁₅ alkyl attached to 13 —CH₂—CH(methyl)-O— linkers, in turn attached to —SO₃⁻ or acid or salt thereof including metal cations such as sodium). In embodiments, the surfactant is an unsubstituted alkyl sulfate.

The alkoxy sulfate surfactant provided herein may be an aryl alkoxy sulfate surfactant. An aryl alkoxy surfactant as provided herein is an alkoxy surfactant having an aryl attached to one or more alkoxylene groups (typically —CH₂—CH(ethyl)-O—, —CH₂—CH(methyl)-O—, or —CH₂—CH₂—O—) which, in turn is attached to —SO₃⁻ or acid or salt thereof including metal cations such as sodium. In embodiments, the aryl alkoxy sulfate surfactant is (C₆H₅—CH₂CH₂)₃C₆H₂—7PO-10EO-sulfate (i.e. tri-styrylphenol attached to 7 —CH₂—CH(methyl)-O— linkers, in turn attached to 10 —CH₂—CH₂—O— linkers, in turn attached to —SO₃⁻ or acid or salt thereof including metal cations such as sodium).

In embodiments, the alkoxy sulfate surfactant has the formula

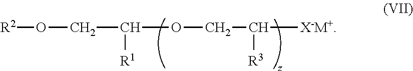

In formula (VII) R¹ and R² are independently substituted or unsubstituted C₈-C₁₅₀ alkyl or substituted or unsubstituted aryl. R³ is independently hydrogen or unsubstituted C₁-C₆ alkyl. z is an integer from 2 to 210. X⁻ is

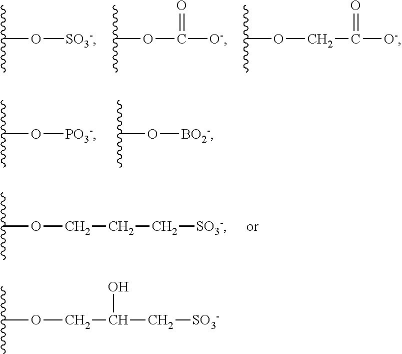

and M⁺ is a monovalent, divalent or trivalent cation. In embodiments, R¹ is branched unsubstituted C₈-C₁₅₀. In embodiments, R¹ is branched or linear unsubstituted C₁₂-C₁₀₀ alkyl, (C₆H₅—CH₂CH₂)₃C₆H₂— (TSP), (C₆H₅—CH₂CH₂)₂C₆H₃— (DSP), (C₆H₅—CH₂CH₂)₁C₆H₄— (MSP), or substituted or unsubstituted naphthyl. In embodiments, the alkoxy sulfate is C₁₆-C₁₆-epoxide-15PO-10EO-sulfate (i.e. a linear unsubstituted C₁₆ alkyl attached to an oxygen, which in turn is attached to a branched unsubstituted C₁₆ alkyl, which in turn is attached to 15 —CH₂—CH(methyl)-O— linkers, in turn attached to 10 —CH₂—CH₂—O— linkers, in turn attached to —SO₃⁻ or acid or salt thereof including metal cations such as sodium.

In embodiments, the co-surfactant is an unsubstituted alkyl sulfate or an unsubstituted alkyl sulfonate surfactant. An alkyl sulfate surfactant as provided herein is a surfactant having an alkyl group attached to —O—SO₃⁻ or acid or salt thereof including metal cations such as sodium.

An alkyl sulfonate surfactant as provided herein is a surfactant having an alkyl group attached to —SO₃⁻ or acid or salt thereof including metal cations such as sodium. In embodiments, the surfactant is an unsubstituted aryl sulfate surfactant or an unsubstituted aryl sulfonate surfactant. An aryl sulfate surfactant as provided herein is a surfactant having an aryl group attached to —O—SO₃⁻ or acid or salt thereof including metal cations such as sodium. An aryl sulfonate surfactant as provided herein is a surfactant having an aryl group attached to —SO₃⁻ or acid or salt thereof including metal cations such as sodium. In embodiments, the surfactant is an alkyl aryl sulfonate. Non-limiting examples of alkyl sulfate surfactants, aryl sulfate surfactants, alkyl sulfonate surfactants, aryl sulfonate surfactants and alkyl aryl sulfonate surfactants useful in the embodiments provided herein are alkyl aryl sulfonates (ARS) (e.g. alkyl benzene sulfonate (ABS)), alkane sulfonates, petroleum sulfonates, and alkyl diphenyl oxide (di)sulfonates. In embodiments, the co-surfactant is a C₁₀-C₃₀ internal olefin sulfate (IOS) or a C₈-C₃₀ alkyl benzene sulfonate (ABS).

The co-surfactant as provided herein may be an olefin sulfonate surfactant. In embodiments, the olefin sulfonate surfactant is an internal olefin sulfonate (IOS) or an alfa olefin sulfonate (AOS). In embodiments, the olefin sulfonate surfactant is a C₁₀-C₃₀ (IOS). In some further embodiments, the olefin sulfonate surfactant is C₁₅-C₁₈ IOS. In embodiments, the olefin sulfonate surfactant is C₁₉-C₂₈ IOS. Where the olefin sulfonate surfactant is C₁₅-C₁₈ IOS, the olefin sulfonate surfactant is a mixture (combination) of C₁₅, C₁₆, C₁₇ and Cis alkene, wherein each alkene is attached to a —SO₃⁻ or acid or salt thereof including metal cations such as sodium. Likewise, where the olefin sulfonate surfactant is C₁₉-C₂₈ IOS, the olefin sulfonate surfactant is a mixture (combination) of C₁₉, C₂₀, C₂₁ C₂₂, C₂₃, C₂₄, C₂₅, C₂₆, C₂₇ and C₂₈ alkene, wherein each alkene is attached to a —SO₃⁻ or acid or salt thereof including metal cations such as sodium. As mentioned above, the aqueous composition provided herein may include a plurality of co-surfactants (i.e. a surfactant blend). In embodiments, the surfactant blend includes a first olefin sulfonate surfactant and a second olefin sulfonate surfactant. In some further embodiments, the first olefin sulfonate surfactant is C₁₅-C₁₈ IOS and the second olefin sulfonate surfactant is C₁₉-C₂₈ IOS.

Useful surfactants are disclosed, for example, in U.S. Pat. Nos. 3,811,504, 3,811,505, 3,811,507, 3,890,239, 4,463,806, 6,022,843, 6,225,267, 7,629,299; WIPO Patent Application WO/2008/079855, WO/2012/027757 and WO/2011/094442; as well as U.S. Patent Application Nos. 2005/0199395, 2006/0185845, 2006/018486, 2009/0270281, 2011/0046024, 2011/0100402, 2011/0190175, 2007/0191633, 2010/004843. 2011/0201531, 2011/0190174, 2011/0071057, 2011/0059873, 2011/0059872, 2011/0048721, 2010/0319920, and 2010/0292110. Additional useful surfactants are surfactants known to be used in enhanced oil recovery methods, including those discussed in D. B. Levitt, A. C. Jackson, L. Britton and G. A. Pope, “Identification and Evaluation of High-Performance EOR Surfactants,” SPE 100089, conference contribution for the SPE Symposium on Improved Oil Recovery Annual Meeting, Tulsa, Okla., Apr. 24-26, 2006.

A person having ordinary skill in the art will immediately recognize that many co-surfactants are commercially available as blends of related molecules (e.g. IOS and ABS surfactants). Thus, where a co-surfactant is present within a composition provided herein, a person of ordinary skill would understand that the surfactant may be a blend of a plurality of related co-surfactant molecules (as described herein and as generally known in the art).

In some embodiment, the total surfactant concentration (i.e. the compound of formula (I), (II), (III), (IV), (VIII) or (IX)) and one or more co-surfactants within the aqueous compositions and emulsion compositions provided herein) is from about 0.05% w/w to about 10% w/w. In embodiments, the total surfactant concentration in the aqueous composition is from about 0.25% w/w to about 10% w/w. In embodiments, the total surfactant concentration in the aqueous composition is about 0.5% w/w. In embodiments, the total surfactant concentration in the aqueous composition is about 1.0% w/w. In embodiments, the total surfactant concentration in the aqueous composition is about 1.25% w/w. In embodiments, the total surfactant concentration in the aqueous composition is about 1.5% w/w. In embodiments, the total surfactant concentration in the aqueous composition is about 1.75% w/w. In embodiments, the total surfactant concentration in the aqueous composition is about 2.0% w/w. In embodiments, the total surfactant concentration in the aqueous composition is about 2.5% w/w. In embodiments, the total surfactant concentration in the aqueous composition is about 3.0% w/w. In embodiments, the total surfactant concentration in the aqueous composition is about 3.5% w/w. In embodiments, the total surfactant concentration in the aqueous composition is about 4.0% w/w. In embodiments, the total surfactant concentration in the aqueous composition is about 4.5% w/w. In embodiments, the total surfactant concentration in the aqueous composition is about 5.0% w/w. In embodiments, the total surfactant concentration in the aqueous composition is about 5.5% w/w. In embodiments, the total surfactant concentration in the aqueous composition is about 6.0% w/w. In embodiments, the total surfactant concentration in the aqueous composition is about 6.5% w/w. In embodiments, the total surfactant concentration in the aqueous composition is about 7.0% w/w. In embodiments, the total surfactant concentration in the aqueous composition is about 7.5% w/w. In embodiments, the total surfactant concentration in the aqueous composition is about 8.0% w/w. In embodiments, the total surfactant concentration in the aqueous composition is about 9.0% w/w. In embodiments, the total surfactant concentration in the aqueous composition is about 10% w/w.

In embodiments, the concentration of the compound of formula (I), (II), (III), (IV), (VIII), or (IX) is about 0.05% (all percentages of the compounds of formula (I), (II), (III), (IV), (VIII), or (IX), co-solvents and co-surfactants within the aqueous compositions and emulsion compositions herein are w/w percentages). In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 0.1%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 0.15%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 0.20%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 0.25%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 0.30%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 0.35%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 0.40%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 0.45%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 0.50%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 0.55%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 0.60%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 0.65%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 0.70%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 0.75%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 0.80%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 0.85%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 0.90%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 0.95%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 1.0%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 1.25%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 1.50%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 1.75%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 2%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 3%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 4%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In embodiments, the concentration of the compound of formula (I), (II), (III), (IV), (VIII), or (IX) is about 5%. In some further embodiments, the concentration of the co-surfactant is about 0.05%. In some further embodiments, the concentration of the co-surfactant is about 0.10%. In some further embodiments, the concentration of the co-surfactant is about 0.15%. In some further embodiments, the concentration of the co-surfactant is about 0.20%. In some further embodiments, the concentration of the co-surfactant is about 0.25%. In some further embodiments, the concentration of the co-surfactant is about 0.30%. In some further embodiments, the concentration of the co-surfactant is about 0.35%. In some further embodiments, the concentration of the co-surfactant is about 0.40%. In some further embodiments, the concentration of the co-surfactant is about 0.45%. In some further embodiments, the concentration of the co-surfactant is about 0.50%. In some further embodiments, the concentration of the co-surfactant is about 0.55%. In some further embodiments, the concentration of the co-surfactant is about 0.60%. In some further embodiments, the concentration of the co-surfactant is about 0.65%. In some further embodiments, the concentration of the co-surfactant is about 0.70%. In some further embodiments, the concentration of the co-surfactant is about 0.75%. In some further embodiments, the concentration of the co-surfactant is about 0.80%. In some further embodiments, the concentration of the co-surfactant is about 0.85%. In some further embodiments, the concentration of the co-surfactant is about 0.90%. In some further embodiments, the concentration of the co-surfactant is about 0.95%. In some further embodiments, the concentration of the co-surfactant is about 1.0%. In some further embodiments, the concentration of the co-surfactant is about 1.25%. In some further embodiments, the concentration of the co-surfactant is about 1.5%. In some further embodiments, the concentration of the co-surfactant is about 1.75%. In some further embodiments, the concentration of the co-surfactant is about 2%. In some further embodiments, the concentration of the co-surfactant is about 3%. In some further embodiments, the concentration of the co-surfactant is about 4%. In some further embodiments, the concentration of the co-surfactant is about 5%.

In certain embodiments, the composition is substantially free of sulfonate surfactants (e.g., the composition comprises less than 0.1% by weight sulfonate surfactants, or the composition comprises less than 0.05% by weight sulfonate surfactants, or the composition comprises less than 0.01% by weight sulfonate surfactants). In certain embodiments, the one or more co-surfactants consist of one or more carboxylate surfactants, one or more sulfate surfactants, or a combination thereof.

The aqueous composition provided herein includes a compound of formula (I), (II), (III), (IV), (VIII) or (IX) and a co-surfactant. In embodiments, the aqueous composition includes a co-solvent. In embodiments, the aqueous composition includes an additional co-solvent. Where the aqueous composition includes an additional co-solvent the co-solvent and the additional co-solvent form a co-solvent blend (e.g. a plurality of co-solvent types). A “co-solvent” and “additional co-solvent” as provided herein is any co-solvent useful in enhanced oil recovery and transport of heavy oil. In embodiments, the co-solvent is a co-solvent blend. A “co-solvent blend” as provided herein is a mixture of a plurality of co-solvent types. Thus, in one embodiment, the aqueous composition includes a plurality of different co-solvents. Where the aqueous composition includes a plurality of different co-solvents, the different co-solvents can be distinguished by their chemical (structural) properties. For example, the aqueous composition may include a co-solvent having the structure of formula (X) and an additional co-solvent, wherein the co-solvent and the additional co-solvent are chemically different. The aqueous composition may include a co-solvent having the structure of formula (X) and a first additional co-solvent, a second additional co-solvent and a third additional co-solvent, wherein the first additional co-solvent is chemically different from the second and the third additional co-solvent, and the second additional co-solvent is chemically different from the third additional co-solvent.

In embodiments, the co-solvent is an alcohol, alcohol ethoxylate, glycol ether, glycols, or glycerol. In embodiments, the co-solvent is iso-butyl alcohol (IBA). In embodiments, the co-solvent is TEGBE (triethylene glycol mono butyl ether). In embodiments, TEGBE is present at a concentration from about 0.01% to about 2%. In embodiments, TEGBE is present at a concentration from about 0.05% to about 1.5%. In embodiments, TEGBE is present at a concentration from about 0.2% to about 1.25%. In embodiments, TEGBE is present at a concentration from about 0.25% to about 1%. In embodiments, TEGBE is present at a concentration from about 0.5% to about 0.75%. In embodiments, TEGBE is present at a concentration of about 0.25%. In embodiments, TEGBE is present at a concentration of about 1%.

In embodiments, the co-solvent has the formula

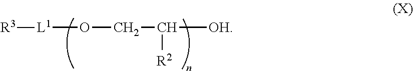

In formula (X), L¹ is unsubstituted C₁-C₆ alkylene, unsubstituted phenylene, unsubstituted cyclohexylene, unsubstituted cyclopentylene or methyl-substituted cyclopentylene. R² is independently hydrogen, methyl or ethyl. R³ is independently hydrogen or

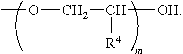

R⁴ is independently hydrogen, methyl or ethyl, n is an integer from 0 to 30, and m is an integer from 0 to 30. In one embodiment, n is an integer from 0 to 25. In one embodiment, n is an integer from 0 to 20. In one embodiment, n is an integer from 0 to 15. In one embodiment, n is an integer from 0 to 10. In one embodiment, n is an integer from 0 to 5. In one embodiment, n is 1. In embodiments, n is 3. In one embodiment, n is 5. In one embodiment, m is an integer from 0 to 25. In one embodiment, m is an integer from 0 to 20. In one embodiment, m is an integer from 0 to 15. In one embodiment, m is an integer from 0 to 10. In one embodiment, m is an integer from 0 to 5. In one embodiment, m is 1. In embodiments, m is 3. In one embodiment, m is 5. In formula (X) each of R² and R⁴ can appear more than once and can be optionally different. For example, in one embodiment where n is 2, R² appears twice and can be optionally different. In embodiments, where m is 3, R⁴ appears three times and can be optionally different.

L¹ may be linear or branched unsubstituted alkylene. In one embodiment, L¹ of formula (X) is linear unsubstituted C₁-C₆ alkylene. In one embodiment, L¹ of formula (X) is branched unsubstituted C₁-C₆ alkylene. In embodiments, L¹ of formula (X) is linear unsubstituted C₂-C₆ alkylene. In embodiments, L¹ of formula (X) is branched unsubstituted C₂-C₆ alkylene. In embodiments, L¹ of formula (X) is linear unsubstituted C₃-C₆ alkylene. In embodiments, L¹ of formula (X) is branched unsubstituted C₃-C₆ alkylene. In embodiments, L¹ of formula (X) is linear unsubstituted C₄-C₆ alkylene. In embodiments, L¹ of formula (X) is branched unsubstituted C₄-C₆ alkylene. In embodiments, L¹ of formula (X) is linear unsubstituted C₄-alkylene. In embodiments, L¹ of formula (X) is branched unsubstituted C₄-alkylene.

In one embodiment, where L¹ is linear or branched unsubstituted alkylene (e.g. branched unsubstituted C₁-C₆ alkylene), the alkylene is a saturated alkylene (e.g. a linear or branched unsubstituted saturated alkylene or branched unsubstituted C₁-C₆ saturated alkylene). A “saturated alkylene,” as used herein, refers to an alkylene consisting only of hydrogen and carbon atoms that are bonded exclusively by single bonds. Thus, in one embodiment, L¹ is linear or branched unsubstituted saturated alkylene. In one embodiment, L¹ of formula (X) is linear unsubstituted saturated C₁-C₆ alkylene. In one embodiment, L¹ of formula (X) is branched unsubstituted saturated C₁-C₆ alkylene. In embodiments, L¹ of formula (X) is linear unsubstituted saturated C₂-C₆ alkylene. In embodiments, L¹ of formula (X) is branched unsubstituted saturated C₂-C₆ alkylene. In embodiments, L¹ of formula (X) is linear unsubstituted saturated C₃-C₆ alkylene. In embodiments, L¹ of formula (X) is branched unsubstituted saturated C₃-C₆ alkylene. In embodiments, L¹ of formula (X) is linear unsubstituted saturated C₄-C₆ alkylene. In embodiments, L¹ of formula (X) is branched unsubstituted saturated C₄-C₆ alkylene. In embodiments, L¹ of formula (X) is linear unsubstituted saturated C₄-alkylene. In embodiments, L¹ of formula (X) is branched unsubstituted saturated C₄-alkylene.

In one embodiment, L¹ of formula (X) is substituted or unsubstituted cycloalkylene or unsubstituted arylene. In one embodiment, L¹ of formula (X) is R⁷-substituted or unsubstituted cyclopropylene, wherein R⁷ is C₁-C₃ alkyl. In embodiments, L¹ of formula (X) is R⁸-substituted or unsubstituted cyclobutylene, wherein R⁸ is C₁-C₂ alkyl. In embodiments, L¹ of formula (X) is R⁹-substituted or unsubstituted cyclopentylene, wherein R⁹ is C₁-alkyl. In embodiments, L¹ of formula (X) is R¹⁰-substituted or unsubstituted cyclopentylene, wherein R¹⁰ is unsubstituted cyclohexyl. In one embodiment, L¹ of formula (X) is unsubstituted phenylene, unsubstituted cyclohexylene, unsubstituted cyclopentylene or methyl-substituted cyclopentylene.

In one embodiment, -L¹-R³ of formula (X) is C₁-C₆ alkyl, unsubstituted phenyl, unsubstituted cyclohexyl, unsubstituted cyclopentyl or a methyl-substituted cycloalkyl.

In one embodiment, the co-solvent has the structure of formula

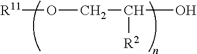

(XA). In formula (XA), R¹¹ is C₁-C₆ alkyl, unsubstituted phenyl, unsubstituted cyclohexyl, unsubstituted cyclopentyl or a methyl-substituted cycloalkyl.

In one embodiment, n and m are independently 1 to 20. In embodiments, n and m are independently 1 to 15. In embodiments, n and m are independently 1 to 10. In one embodiment, n and m are independently 1 to 6. In one embodiment, n and m are independently 1.

The co-solvent included in the aqueous composition provided herein may be a monohydric or a dihydric alkoxy alcohol (e.g. C₁-C₆ alkoxy alcohol or C₁-C₆ alkoxy diol). Where the co-solvent is a monohydric alcohol, the co-solvent has the formula (X) and R³ is hydrogen. Where the co-solvent is a diol, the co-solvent has the formula (X) and R³ is

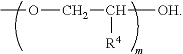

In one embodiment, L¹ is linear unsubstituted C₄ alkylene and n is 3. In one embodiment, the co-solvent is triethylene glycol butyl ether. In embodiments, the co-solvent is tetraethylene glycol. In further embodiments, m is 3. In one embodiment, L¹ is linear unsubstituted C₄ alkylene and n is 5. In one embodiment, the co-solvent is pentaethylene glycol n-butyl ether. In further embodiments, m is 5. In one embodiment, L¹ is branched unsubstituted C₄ alkylene and n is 1. In one embodiment, the co-solvent is ethylene glycol iso-butyl ether. In further embodiments, m is 1. In one embodiment, L¹ is branched unsubstituted C₄ alkylene and n is 3. In one embodiment, the co-solvent is triethylene glycol iso-butyl ether. In further embodiments, m is 3. In one embodiment, the co-solvent is ethylene glycol or propylene glycol. In embodiments, the co-solvent is ethylene glycol alkoxylate or propylene glycol alkoxylate. In one embodiment, the co-solvent is propylene glycol diethoxylate or propylene glycoltriethoxylate. In one embodiment, the co-solvent is propylene glycol tetraethoxylate. In embodiments, the co-solvent is an alcohol, alkoxy alcohol, glycol ether, glycol or glycerol. In embodiments, the co-solvent is an alcohol, alkoxy alcohol or glycol ether.

In the structure of formula (X), R³ may be hydrogen

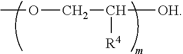

Thus in one embodiment, R³ is

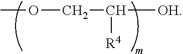

In one embodiment, the co-solvent provided herein may be an alcohol or diol (C₁-C₆ alcohol or C₁-C₆ diol). Where the co-solvent is an alcohol, the co-solvent has a structure of formula (X), where R³ is hydrogen and n is 0. Where the co-solvent is a diol, the co-solvent has a structure of formula (X), where R³ is

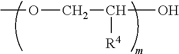

and n and m are 0. Thus, in one embodiment, n and m are independently 0. In one embodiment, L¹ is linear or branched unsubstituted C₁-C₆ alkylene. In embodiments, L¹ is linear or branched unsubstituted C₂-C₆ alkylene. In one embodiment, L¹ is linear or branched unsubstituted C₂-C₆ alkylene. In one embodiment L¹ is linear or branched unsubstituted C₃-C₆ alkylene. In embodiments, L¹ is linear or branched unsubstituted C₄-C₆ alkylene. In one embodiment, L¹ is linear or branched unsubstituted C₄-alkylene. In one embodiment, L¹ is branched unsubstituted butylene. In one embodiment, the co-solvent has the structure of formula

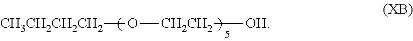

In embodiments, the co-solvent has the structure of formula

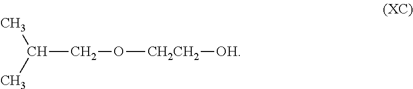

In one embodiment, the co-solvent has the structure of formula

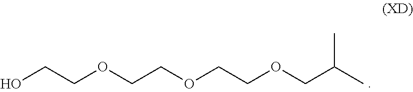

In embodiments, the co-solvent has the formula

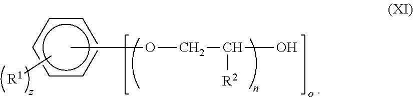

In formula (XI) R¹ is independently hydrogen, unsubstituted C₁-C₆ alkyl or R⁵—OH, R² is independently hydrogen or unsubstituted C₁-C₂ alkyl, R⁵ is independently a bond or unsubstituted C₁-C₆ alkyl, n is an integer from 1 to 30, o is an integer from 1 to 5 and z is an integer from 1 to 5. In embodiments, R¹ is unsubstituted C₂-C₆ alkyl. In embodiments, R¹ is unsubstituted C₄-C₆ alkyl. In embodiments, R¹ is unsubstituted C₁-C₅ alkyl. In embodiments, R¹ is unsubstituted C₁-C₄ alkyl. In embodiments, R¹ is unsubstituted C₁-C₃ alkyl. In embodiments, R¹ is unsubstituted C₁-C₂ alkyl. In embodiments, R¹ is unsubstituted C₂ alkyl. In embodiments, R¹ is ethyl. In embodiments, R¹ is methyl. In some embodiment, R¹ is hydrogen.

In some embodiment, R¹ is independently a bond or R⁵—OH. In some embodiment, R¹ is R⁵—OH. In embodiments, R⁵ is unsubstituted C₂-C₆ alkyl. In embodiments, R⁵ is unsubstituted C₄-C₆ alkyl. In embodiments, R⁵ is unsubstituted C₁-C₅ alkyl. In embodiments, R⁵ is unsubstituted C₁-C₄ alkyl. In embodiments, R⁵ is unsubstituted C₁-C₃ alkyl. In embodiments, R⁵ is unsubstituted C₁-C₂ alkyl. In embodiments, R⁵ is unsubstituted C₂ alkyl. In embodiments, R⁵ is ethyl. In embodiments, R⁵ is methyl. In embodiments, R⁵ is a bond.

In formula (XI) the symbol n is an integer from 1 to 30. In one embodiment, n is an integer from 1 to 25. In one embodiment, n is an integer from 1 to 20. In one embodiment, n is an integer from 1 to 15. In one embodiment, n is an integer from 1 to 10. In one embodiment, n is an integer from 1 to 5. In some embodiment, n is 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30. In one embodiment, n is 3. In embodiments, n is 5. In one embodiment, n is 6. In one embodiment, n is 16.

In formula (XI) the symbol o is an integer from 1 to 5 and the symbol z is an integer from 1 to 5. In embodiments, o is 1, 2, 3, 4, or 5. In embodiments, z is 1, 2, 3, 4, or 5. In embodiments, o is 1 and z is 5. In further embodiments, R¹ is independently hydrogen or R⁵—OH and R⁵ is a bond. In other further embodiments, R¹ is hydrogen. In other further embodiments, R¹ is R⁵—OH and R⁵ is a bond.

In embodiments, the co-solvent has the formula

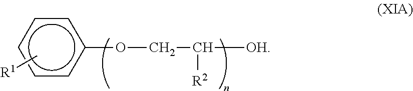

In formula (XIA) R¹ is independently hydrogen or unsubstituted C₁-C₆ alkyl, R² is independently hydrogen or unsubstituted C₁-C₂ alkyl and n is an integer from 1 to 30. In embodiments, R¹ is unsubstituted C₂-C₆ alkyl. In embodiments, R¹ is unsubstituted C₄-C₆ alkyl. In embodiments, R¹ is unsubstituted C₁-C₅ alkyl. In embodiments, R¹ is unsubstituted C₁-C₄ alkyl. In embodiments, R¹ is unsubstituted C₁-C₃ alkyl. In embodiments, R¹ is unsubstituted C₁-C₂ alkyl. In embodiments, R¹ is unsubstituted C₂ alkyl. In embodiments, R¹ is ethyl. In embodiments, R¹ is methyl. In some embodiment, R¹ is hydrogen.

R¹ may be linear or branched unsubstituted alkyl. In one embodiment, R¹ of formula (XIA) is linear unsubstituted C₁-C₆ alkyl. In one embodiment, R¹ of formula (XIA) is branched unsubstituted C₁-C₆ alkyl. In embodiments, R¹ of formula (XIA) is linear unsubstituted C₁-C₅ alkyl. In embodiments, R¹ of formula (XIA) is branched unsubstituted C₁-C₅ alkyl. In embodiments, R¹ of formula (XIA) is linear unsubstituted C₁-C₄ alkyl. In embodiments, R¹ of formula (XIA) is branched unsubstituted C₁-C₄ alkyl. In embodiments, R¹ of formula (XIA) is linear unsubstituted C₁-C₃ alkyl. In embodiments, R¹ of formula (XIA) is branched unsubstituted C₁-C₃ alkyl. In embodiments, R¹ of formula (XIA) is linear unsubstituted ethyl. In embodiments, R¹ of formula (XIA) is branched unsubstituted ethyl.

In one embodiment, where R¹ is linear or branched unsubstituted alkyl (e.g. branched unsubstituted C₁-C₆ alkyl), the alkyl is a saturated alkyl (e.g. a linear or branched unsubstituted saturated alkyl or branched unsubstituted C₁-C₆ saturated alkyl). A “saturated alkyl,” as used herein, refers to an alkyl consisting only of hydrogen and carbon atoms that are bonded exclusively by single bonds. Thus, in one embodiment, R¹ is linear or branched unsubstituted saturated alkyl. In one embodiment, R¹ of formula (XIA) is linear unsubstituted saturated C₁-C₆ alkyl. In one embodiment, R¹ of formula (XIA) is branched unsubstituted saturated C₁-C₆ alkyl. In embodiments, R¹ of formula (XIA) is linear unsubstituted saturated C₁-C₅ alkyl. In embodiments, R¹ of formula (XIA) is branched unsubstituted saturated C₁-C₅ alkyl. In embodiments, R¹ of formula (XIA) is linear unsubstituted saturated C₁-C₄ alkyl. In embodiments, R¹ of formula (XIA) is branched unsubstituted saturated C₁-C₄ alkyl. In embodiments, R¹ of formula (XIA) is linear unsubstituted saturated C₁-C₃ alkyl. In embodiments, R¹ of formula (XIA) is branched unsubstituted saturated C₁-C₃ alkyl. In embodiments, R¹ of formula (XIA) is linear unsubstituted saturated ethyl. In embodiments, R¹ of formula (XIA) is branched unsubstituted saturated ethyl.

In formula (XIA) the symbol n is an integer from 1 to 30. In one embodiment, n is an integer from 1 to 25. In one embodiment, n is an integer from 1 to 20. In one embodiment, n is an integer from 1 to 15. In one embodiment, n is an integer from 1 to 10. In one embodiment, n is an integer from 1 to 5. In some embodiment, n is 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30. In one embodiment, n is 3. In embodiments, n is 5. In one embodiment, n is 6. In one embodiment, n is 16.

In embodiments, R¹ is hydrogen. In other related embodiments, n is as defined in an embodiment above (e.g. n is at least 1, or at least 15, e.g. 5 to 20). Thus, in embodiments, R¹ is hydrogen and n is 16.

In embodiments, R¹ is methyl. In other related embodiments, n is as defined in an embodiment above (e.g. n is at least 1, or at least 10, e.g. 5 to 20). Thus, In embodiments, R¹ is methyl and n is 16.

In some embodiment, the co-solvent has the formula:

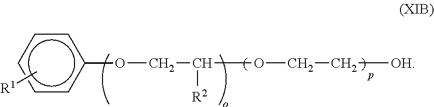

In formula (XIB) R¹ is defined as above (e.g. unsubstituted C₁-C₆ alkyl), R² is methyl or ethyl, o is an integer from 0 to 10 and p is an integer from 1 to 20. In embodiments, R² is methyl. In embodiments, R² is ethyl. In formula (XIB) R² can appear more than once and can be optionally different. For example, In embodiments where o is 3, R² appears three times and can be optionally different. In embodiments, where o is 6, R² appears six times and can be optionally different.

In embodiments, o is 0 to 10. In some related embodiments, o is 0 to 8. In some related embodiments, o is 0 to 6. In some related embodiments, o is 0 to 4. In some related embodiments, o is 0 to 2. In still further related embodiments, o is 0. In some further related embodiment, p is 1 to 20. In some further related embodiment, p is 1 to 18. In some further related embodiment, p is 1 to 16. In some further related embodiment, p is 1 to 14. In some further related embodiment, p is 1 to 12. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1. In some further embodiment, p is 6. In some further embodiment, p is 16. R¹ and R² may be any of the embodiments described above (e.g. R¹ maybe linear unsubstituted C₁-C₆ alkyl, R² maybe linear unsubstituted C₁-C₂ alkyl). Thus, in some embodiment, R¹ is hydrogen, o is 0 and p is 16.

In embodiments, o is 1 to 10. In some related embodiments, o is 1 to 8. In some related embodiments, o is 1 to 6. In some related embodiments, o is 1 to 4. In some related embodiments, o is 1 to 2. In some further related embodiment, p is 1 to 20. In some further related embodiment, p is 1 to 18. In some further related embodiment, p is 1 to 16. In some further related embodiment, p is 1 to 14. In some further related embodiment, p is 1 to 12. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1. R¹ and R² may be any of the embodiments described above (e.g. R¹ maybe linear unsubstituted C₁-C₆ alkyl, R² maybe linear unsubstituted C₁-C₂ alkyl).

In embodiments, o is 2 to 10. In some related embodiments, o is 2 to 8. In some related embodiments, o is 2 to 6. In some related embodiments, o is 2 to 4. In some further related embodiment, p is 1 to 20. In some further related embodiment, p is 1 to 18. In some further related embodiment, p is 1 to 16. In some further related embodiment, p is 1 to 14. In some further related embodiment, p is 1 to 12. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1. R¹ and R² may be any of the embodiments described above (e.g. R¹ maybe linear unsubstituted C₁-C₆ alkyl, R² maybe linear unsubstituted C₁-C₂ alkyl).

In embodiments, o is 4 to 10. In some related embodiments, o is 4 to 8. In some related embodiments, o is 4 to 6. In some further related embodiment, p is 1 to 20. In some further related embodiment, p is 1 to 18. In some further related embodiment, p is 1 to 16. In some further related embodiment, p is 1 to 14. In some further related embodiment, p is 1 to 12. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1. R¹ and R² may be any of the embodiments described above (e.g. R¹ maybe linear unsubstituted C₁-C₆ alkyl, R² maybe linear unsubstituted C₁-C₂ alkyl).

In embodiments, o is 6 to 10. In some related embodiments, o is 6 to 8. In some further related embodiment, p is 1 to 20. In some further related embodiment, p is 1 to 18. In some further related embodiment, p is 1 to 16. In some further related embodiment, p is 1 to 14. In some further related embodiment, p is 1 to 12. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1. R¹ and R² may be any of the embodiments described above (e.g. R¹ maybe linear unsubstituted C₁-C₆ alkyl, R² maybe linear unsubstituted C₁-C₂ alkyl).

In embodiments, o is 8 to 10. In some further related embodiment, p is 1 to 20. In some further related embodiment, p is 1 to 18. In some further related embodiment, p is 1 to 16. In some further related embodiment, p is 1 to 14. In some further related embodiment, p is 1 to 12. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1. R¹ and R² may be any of the embodiments described above (e.g. R¹ maybe linear unsubstituted C₁-C₆ alkyl, R² maybe linear unsubstituted C₁-C₂ alkyl).

In formula (XI), (XIA) or (XIB) R² may be independently hydrogen or unsubstituted C₁-C₂ alkyl. In embodiments, R² is hydrogen or unsubstituted C₁ or C₂ alkyl. In some related embodiments, R² is hydrogen or branched unsubstituted C₁ or C₂ saturated alkyl. In embodiments, R² is hydrogen or a branched unsubstituted C₁ saturated alkyl. In embodiments, R² is independently hydrogen or methyl. In embodiments, R² is independently hydrogen or ethyl. In embodiments, R² is independently hydrogen, methyl or ethyl. In embodiments, R² is hydrogen. In embodiments, R² is methyl. In embodiments, R² is ethyl. In formula (V) R² can appear more than once and can be optionally different. For example, In embodiments where n is 3, R² appears three times and can be optionally different. In embodiments, where n is 6, R² appears six times and can be optionally different.

In embodiments, where multiple R² substituents are present and at least two R² substituents are different, R² substituents with the fewest number of carbons are present to the side of the compound of formula (XI), (XIA) or (XIB) bound to the —OH group. In this embodiment, the compound of formula (XI), (XIA) or (XIB) will be increasingly hydrophilic in progressing from the R¹ substituent to the side of the compound of formula (XI), (XIA) or (XIB) bound to the —OH group. The term “side of the compound of formula (XI), (XIA) or (XIB) bound to the —OH group” refers to the side of the compound indicated by asterisks in the below structures:

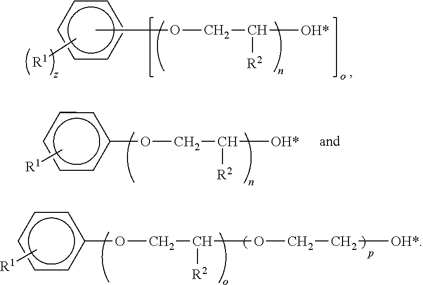

In embodiments, R² is hydrogen. In other related embodiments, n is as defined in an embodiment above (e.g. n is at least 1, or at least 20, e.g. 5 to 15). Thus, in embodiments, R² is hydrogen and n is 16.

In embodiments, R² is methyl. In other related embodiments, n is as defined in an embodiment above (e.g. n is at least 1, or at least 20, e.g. 5 to 15). Thus, in embodiments, R² is methyl and n is 16.

In embodiments, the aqueous composition further includes an alkali agent. An alkali agent as provided herein is a basic, ionic salt of an alkali metal (e.g. lithium, sodium, potassium) or alkaline earth metal element (e.g. magnesium, calcium, barium, radium). In embodiments, the alkali agent is NaOH, KOH, LiOH, Na₂CO₃, NaHCO₃, Na-metaborate, Na silicate, Na orthosilicate, or NH₄OH. In embodiments, the alkali agent is NH₄OH/NH₄OAc, NH₄OH/NH₄Cl, or NH₄OH/NaOAc. The aqueous composition may include seawater, or fresh water from an aquifer, river or lake. In embodiments, the aqueous composition includes hard brine or soft brine. In some further embodiments, the water is soft brine. In some further embodiments, the water is hard brine. Where the aqueous composition includes soft brine, the aqueous composition may include an alkaline agent. In soft brine the alkaline agent provides for enhanced soap generation from the active oils, lower surfactant adsorption to the solid material (e.g. rock) in the reservoir and increased solubility of viscosity enhancing water soluble polymers. The alkali agent is present in the aqueous composition at a concentration from about 0.1% w/w to about 10% w/w.

In embodiments, the aqueous composition further includes a viscosity enhancing water-soluble polymer. In embodiments, the viscosity enhancing water-soluble polymer may be a biopolymer such as xanthan gum or scleroglucan, a synthetic polymer such as polyacryamide, hydrolyzed polyarcrylamide or co-polymers of acrylamide and acrylic acid, 2-acrylamido 2-methyl propane sulfonate or N-vinyl pyrrolidone, a synthetic polymer such as polyethylene oxide, or any other high molecular weight polymer soluble in water or brine. In embodiments, the viscosity enhancing water-soluble polymer is polyacrylamide or a co-polymer of polyacrylamide. In embodiments, the viscosity enhancing water-soluble polymer is a partially (e.g. 20%, 25%, 30%, 35%, 40%, 45%) hydrolyzed anionic polyacrylamide. In some further embodiment, the viscosity enhancing water-soluble polymer has a molecular weight of approximately about 8×10⁶. In some other further embodiment, the viscosity enhancing water-soluble polymer has a molecular weight of approximately about 18×10⁶. Non-limiting examples of commercially available polymers useful for the invention including embodiments provided herein are Florpaam 3330S and Florpaam 3360S.

The aqueous composition provided herein may further include a gas. Thus, in some embodiment, the aqueous composition further includes a gas. For instance, the gas may be combined with the aqueous composition to reduce its mobility by decreasing the liquid flow in the pores of the solid material (e.g. rock). In embodiments, the gas may be supercritical carbon dioxide, nitrogen, natural gas or mixtures of these and other gases. In embodiments, the gas is CO₂, N₂, CH₄, C₂H₆, or NH₃. As mentioned above, the apparent viscosity of the aqueous composition may be increased with a gas (e.g. a foam forming gas) as an alternative to the water-soluble polymer. Thus, in embodiments, the aqueous composition includes a foam.

In embodiments, the aqueous composition has a salinity of at least 5,000 ppm. In embodiments, the aqueous composition has a salinity of at least 10,000 ppm. In embodiments, the aqueous composition has a salinity of at least 100,000 ppm. In embodiments, the aqueous composition has a salinity of about 200,000 ppm. The total range of salinity (total dissolved solids in the brine) is 100 ppm to saturated brine (about 260,000 ppm). The aqueous composition may include seawater, brine or fresh water from an aquifer, river or lake. The aqueous combination may further include salt to increase the salinity. In embodiments, the salt is NaCl, KCl, CaCl₂, or MgCl₂.

In embodiments, the temperature of the aqueous composition is at least 40 C. In embodiments, the temperature of the aqueous composition is at least 70 C. In embodiments, the temperature of the aqueous composition is about 100 C. In embodiments, the aqueous composition has a viscosity of between 20 mPa·s and 100 mPa·s. The viscosity of the aqueous solution may be increased from 0.3 mPa·s to 1, 2, 10, 20, 100 or even 1000 mPa·s by including a water-soluble polymer. As mentioned above, the apparent viscosity of the aqueous composition may be increased with a gas (e.g. a foam forming gas) as an alternative to the water-soluble polymer.

In another aspect, an emulsion composition including an unrefined petroleum phase and a compound as provided herein (e.g., a compound of formula (I), (II), (III), (IV), (VIII) or (IX)) including embodiments thereof is provided. In embodiments, the emulsion composition includes the components set forth in the aqueous composition provided above. For example, in embodiments, the emulsion composition further includes a co-surfactant (e.g. wherein the compound and the co-surfactant are present in synergistic surface active amount, a surfactant stabilizing amount, and/or a synergistic solubilizing amount). In embodiments, the emulsion composition includes a co-surfactant and a co-solvent. The emulsion composition may include a combination of one or more co-surfactants and one or more co-solvents. In embodiments, the emulsion composition includes a co-surfactant and an alkali agent.

In embodiments, the emulsion composition is a microemulsion. A “microemulsion” as referred to herein is a thermodynamically stable mixture of oil, water and surfactants that may also include additional components such as co-solvents, electrolytes, alkali and polymers. In contrast, a “macroemulsion” as referred to herein is a thermodynamically unstable mixture of oil and water that may also include additional components. The emulsion composition provided herein may be an oil-in-water emulsion, wherein the compound provided herein (e.g., a compound of formula (I), (II), (III), (IV), (VIII) or (IX)) including embodiments thereof and the co-surfactant as provided herein form aggregates (e.g. micelles) where the hydrophilic part of the surfactant molecule contacts the aqueous phase of the emulsion and the lipophilic part contacts the oil phase of the emulsion. Thus, in embodiments, the compound provided herein (e.g., a compound of formula (I), (II), (III), (IV), (VIII) or (IX)) including embodiments thereof and the co-surfactant as provided herein form part of the aqueous part of the emulsion. And in embodiments, the compound provided herein (e.g., a compound of formula (I), (II), (III), (IV), (VIII) or (IX)) including embodiments thereof and the co-surfactant as provided herein form part of the oil phase of the emulsion. In yet another embodiment, the compound provided herein (e.g., a compound of formula (I), (II), (III), (IV), (VIII) or (IX)) including embodiments thereof and the co-surfactant as provided herein form part of an interface between the aqueous phase and the oil phase of the emulsion.

In embodiments, the oil and water solubilization ratios are insensitive to the combined concentration of divalent metal cations (e.g. Ca⁺² and Mg⁺²) within the emulsion composition. In embodiments, the oil and water solubilization ratios are insensitive to the salinity of the water or to all of the specific electrolytes contained in the water. The term “insensitive” used in the context of this paragraph means that the solubilization ratio tends not to change (e.g. tends to remain constant) as the concentration of divalent metal cations and/or salinity of water changes. In embodiments, the change in the solubilization ratios are less than 5%, 10%, 20%, 30%, 40%, or 50% over a divalent metal cation concentration range of 10 ppm, 100 ppm, 1000 ppm or 10,000 ppm. In another embodiment, the change in the solubilization ratios are less than 5%, 10%, 20%, 30%, 40%, or 50% over a salinity concentration range of 10 ppm, 100 ppm, 1000 ppm or 10,000 ppm.

As described above the aqueous composition may include the compound of formula (I), (II), (III), (IV), (VIII) or (IX) and a co-surfactant. In embodiments, the aqueous composition or emulsion composition includes a compound of formula (I), wherein R¹ is unsubstituted saturated C₁₈ alkyl; R² is methyl; m is 10; L¹ is unsubstituted ethylene; n₁ is 1 and n₂ is 0; R^{3A} hydrogen; X is —SO₃⁻M⁺ and M⁺ is Na⁺. In a further embodiment, the aqueous composition or emulsion composition includes a co-surfactant of formula (VI), wherein the co-surfactant is an C₂₈-45PO-30EO-carboxylate (i.e. R¹ is unsubstituted C₂₈ alkyl attached to 45 —CH₂—CH(methyl)-O-linkers, attached in turn to 30 —CH₂—CH₂—O— linkers, attached in turn to —COO⁻ or acid or salt thereof including metal cations such as sodium). In another further embodiment, the aqueous composition or emulsion composition includes a co-surfactant of formula (VII), wherein the co-surfactant is a C₁₆-C₁₆-epoxide-35PO-20EO-sulfate (i.e. R² is a linear unsubstituted C₁₆ alkyl attached to an oxygen, which in turn is attached to a branched unsubstituted C₁₆ alkyl (R¹), which in turn is attached to 35 —CH₂—CH(methyl)-O— linkers, in turn attached to 20 —CH₂—CH₂—O— linkers, in turn attached to —SO₃⁻ or acid or salt thereof including metal cations such as sodium). In some further embodiment, the aqueous composition or emulsion composition includes a co-solvent. In some further embodiment, the co-solvent is IBA. In yet another further embodiment, the compound of formula (I), (II), (III), (IV), (VIII) or (IX) is present at about 0.8% w/w. In some further embodiment, the co-surfactant is present at about 0.2% w/w. In yet some further embodiment, the co-solvent is present at about 0.5% w/w.

Methods

In another aspect, a method of displacing an unrefined petroleum material in contact with a solid material is provided. The method includes contacting an unrefined petroleum material with an aqueous composition including water, a co-surfactant and a compound as provided herein including embodiments thereof (e.g., a compound of formula (I), (II), (III), (IV), (VIII) or (IX)), wherein the unrefined petroleum material is in contact with a natural solid material. The unrefined petroleum material is allowed to separate from the solid material thereby displacing the unrefined petroleum material in contact with the solid material. In embodiments, the solid material is contacted with the aqueous composition. In embodiments, the compound is present in an amount sufficient to increase the solubility of the co-surfactant relative to the absence of the compound. In embodiments, the co-surfactant is present in an amount sufficient to increase the solubility of the compound relative to the absence of the co-surfactant.

The natural solid material may be found in a petroleum reservoir. Thus, in embodiments, the reactive petroleum material is in a petroleum reservoir. In embodiments, the method is an enhanced oil recovery method. Enhanced oil recovery methods are well known in the art. A general treatise on enhanced oil recovery methods is Basic Concepts in Enhanced Oil Recovery Processes edited by M. Baviere (published for SCI by Elsevier Applied Science, London and New York, 1991). For example, in an enhanced oil recovery method, the displacing of the unrefined petroleum in contact with the solid material is accomplished by contacting the unrefined with a compound provided herein (e.g. a compound of formula (I), (II), (III), (IV), (VIII) or (IX)), wherein the unrefined petroleum is in contact with the solid material. The unrefined petroleum may be in an oil reservoir. The compound provided herein (e.g. a compound of formula (I), (II), (III), (IV), (VIII) or (IX)) is pumped into the reservoir in accordance with known enhanced oil recovery parameters. The compound may be pumped into the reservoir as part of the aqueous compositions provided herein and, upon contacting the unrefined petroleum, form an emulsion composition provided herein. Thus, in embodiments, an emulsion forms after the contacting. The emulsion thus formed may be the emulsion composition as described above. In embodiments, the method includes allowing an unrefined petroleum acid within the unrefined petroleum material to enter into the emulsion (e.g. emulsion composition), thereby converting the unrefined petroleum acid into a surfactant. In other words, where the unrefined petroleum acid converts into a surfactant it is mobilized and therefore separates from the solid material

In embodiments, the natural solid material is rock or regolith. In embodiments, the regolith is soil. The natural solid material may be a geological formation such as clastics or carbonates. The natural solid material may be either consolidated or unconsolidated material or mixtures thereof. The hydrocarbon material may be trapped or confined by “bedrock” above or below the natural solid material. The hydrocarbon material may be found in fractured bedrock or porous natural solid material. In embodiments, the regolith is soil. In embodiments, the compound forms part of an aqueous composition comprising a co-surfactant and the hydrocarbon material is an unrefined petroleum material. In embodiments, the co-surfactant is an internal olefin sulfonate (IOS), an alfa olefin sulfonate (AOS), an alkyl aryl sulfonate (ARS), an alkane sulfonate, a petroleum sulfonate, an alkyl diphenyl ether (di)sulfonate, an alcohol sulfate, an alkoxy sulfate, an alkoxy carboxylate, an alcohol phosphate, an alkoxy phosphate, a sulfosuccinate ester, an alcohol ethoxylate, an alkyl phenol ethoxylate or a quaternary ammonium salt. In embodiments, the co-surfactant is a C₁₀-C₃₀ internal olefin sulfate or a C₈-C₃₀ alkyl benzene sulfonate. In embodiments, the aqueous composition further includes a co-solvent.

In another aspect, a method of converting an unrefined petroleum acid into a surfactant is provided. The method includes contacting a petroleum material with an aqueous composition thereby forming an emulsion in contact with the petroleum material, wherein the aqueous composition includes a compound as provided herein (e.g. a compound of formula (I), (II), (III), (IV), (VIII) or (IX)) including embodiments thereof and a co-surfactant. Thus, in embodiments, the aqueous composition is the aqueous composition described above. And in embodiments, the emulsion is the emulsion composition described above. An unrefined petroleum acid within the unrefined petroleum material is allowed to enter into the emulsion, thereby converting the unrefined petroleum acid into a surfactant. In embodiments, the petroleum material is in a petroleum reservoir. In embodiments, as described above and as is generally known in the art, the unrefined petroleum acid is a naphthenic acid. In embodiments, as described above and as is generally known in the art, the unrefined petroleum acid is a mixture of naphthenic acid. In embodiments, the aqueous composition further includes a co-solvent.

In another aspect, a method of making a compound as provided herein including embodiments thereof is provided. The method includes contacting an epoxide compound with a diol thereby forming an epoxide-diol mixture. The temperature of the epoxide-diol mixture is increased thereby an epoxide-diol adduct is formed. The epoxide-diol adduct is contacted with a C₁-C₄ alkoxide thereby forming an alkoxylated hydrophobe and the alkoxylated hydrophobe is contacted with one or more anionic functional groups thereby forming the compound. In the method provided herein the epoxide compound has the formula

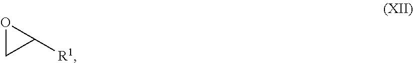

wherein R¹ is as described herein (e.g., a linear unsubstituted C₁₂-C₃₀ alkyl). The diol has the formula HO-L¹-OH (XIIA), wherein L¹ is as described herein (e.g. substituted or unsubstituted C₂-C₄ alkylene or has the structure

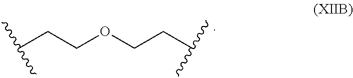 [SMILES: *CCOCC*]

The epoxide-diol adduct is a compound having the formula

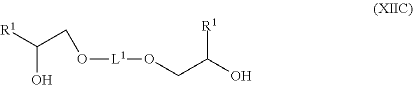

wherein R¹ and L¹ are as described above (e.g. R¹ is linear unsubstituted C₁₂-C₃₀ alkyl; L¹ is substituted or unsubstituted C₂-C₄ alkylene or has the structure of formula (XIIB)). The C₁-C₄ alkoxide has the formula

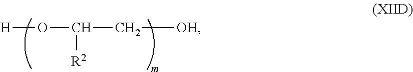

wherein R² and m are as described above. For example, R² is unsubstituted C₁-C₄ alkyl and m is an integer from 1 to 200. The alkoxylated hydrophobe provided herein has the formula

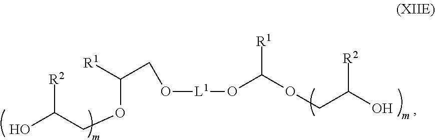

wherein R¹, R², L¹ and m are as described above (e.g., R¹ is linear unsubstituted C₁₂-C₃₀ alkyl; L¹ is substituted or unsubstituted C₂-C₄ alkylene or has the structure of formula (XIIB); and m is an integer from 1 to 200).

By way of non-limiting illustration, examples of certain embodiments of the present disclosure are given below.

### EXAMPLES

### Example 1

### General Synthesis and Characterization of Gemini Surfactant Compounds

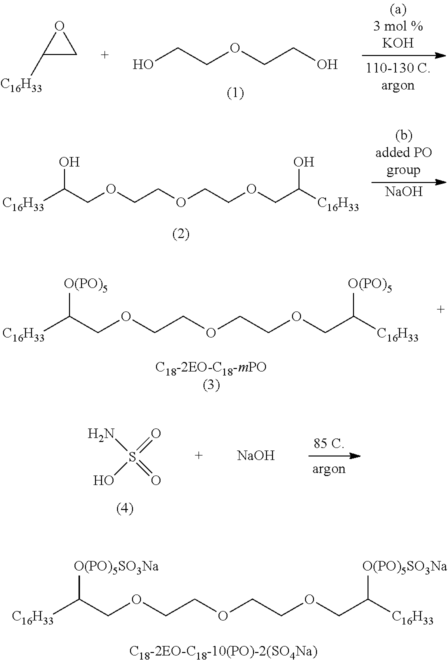

An epoxide compound, wherein R¹ is C₁₆, is contacted with a diol (1) thereby forming an epoxide-diol mixture. The temperature of the epoxide-diol mixture is increased and in the presence of a base (alkaline catalyst) (a) an epoxide-diol adduct (2) is formed. The epoxide-diol adduct (2) is contacted with a C₁-C₄ alkoxide (b), thereby forming an alkoxylated hydrophobe (3) and the alkoxylated hydrophobe is transformed with one or more anionic functional groups (4) thereby forming the Gemini compound (5).

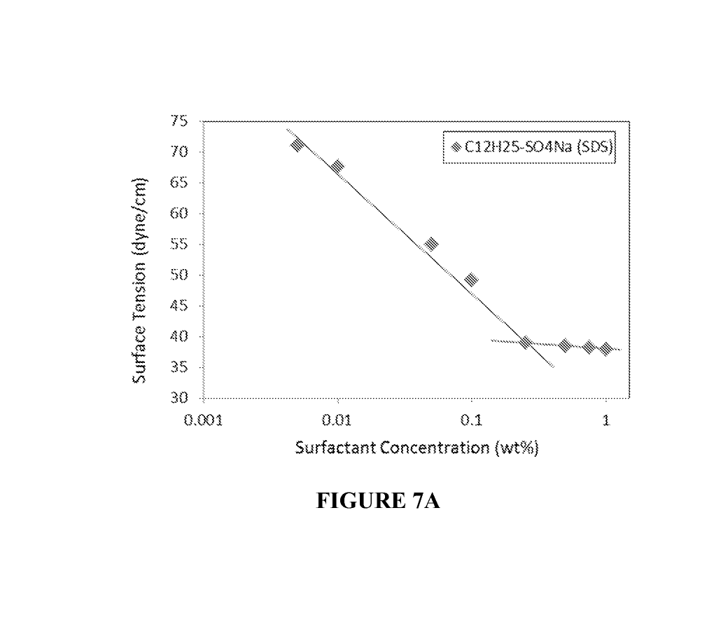

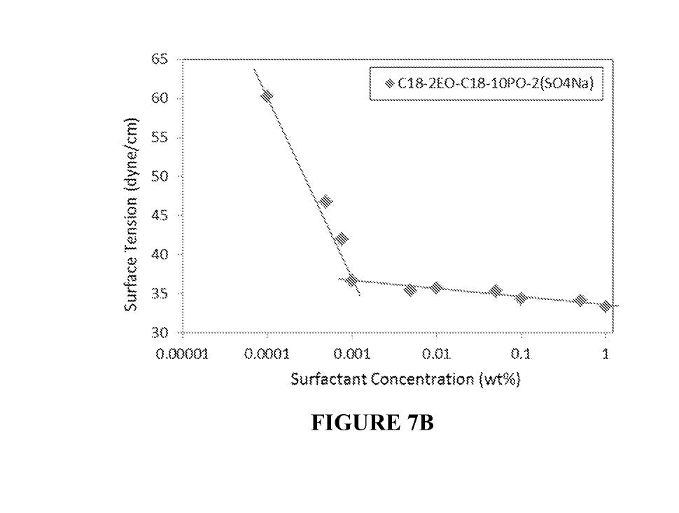

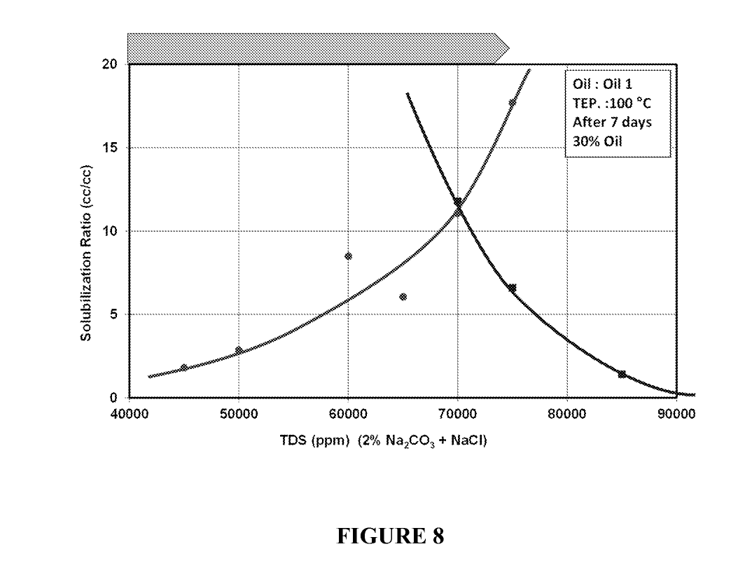

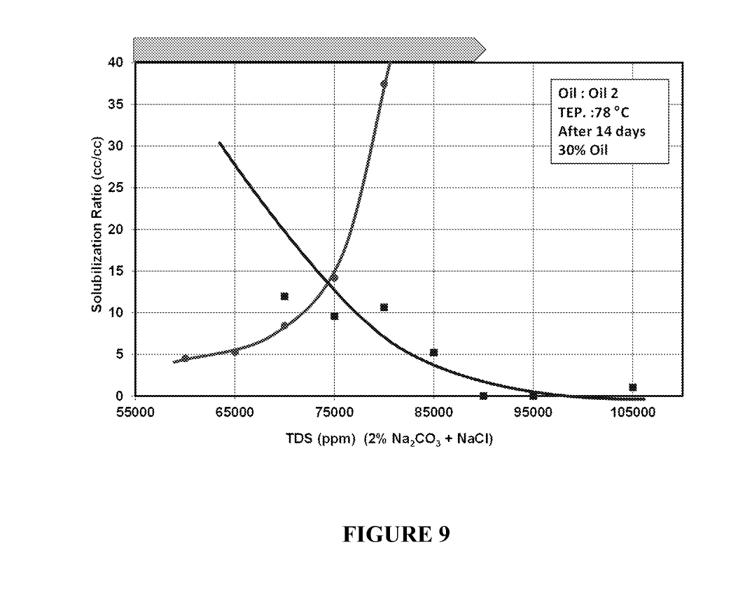

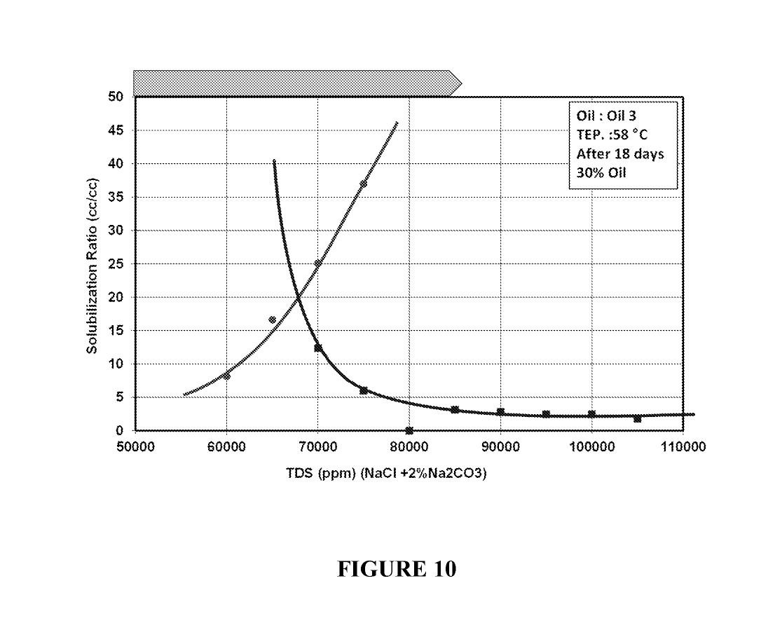

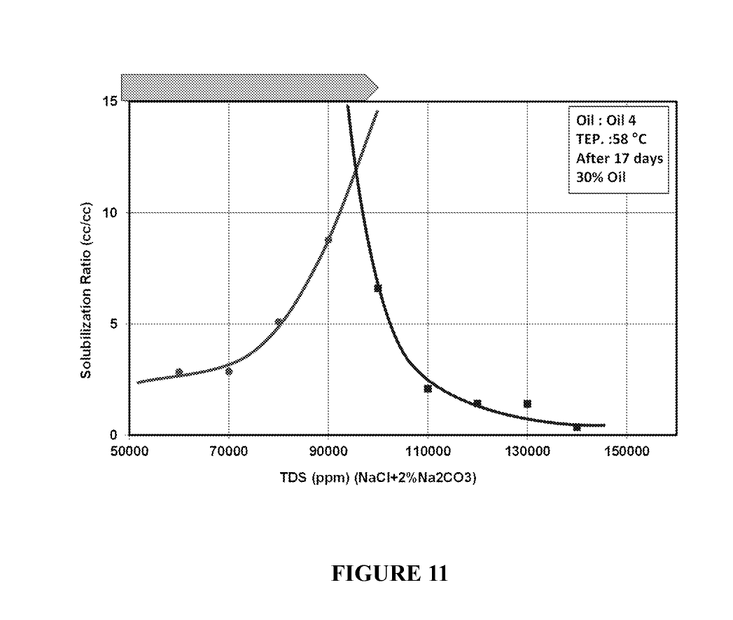

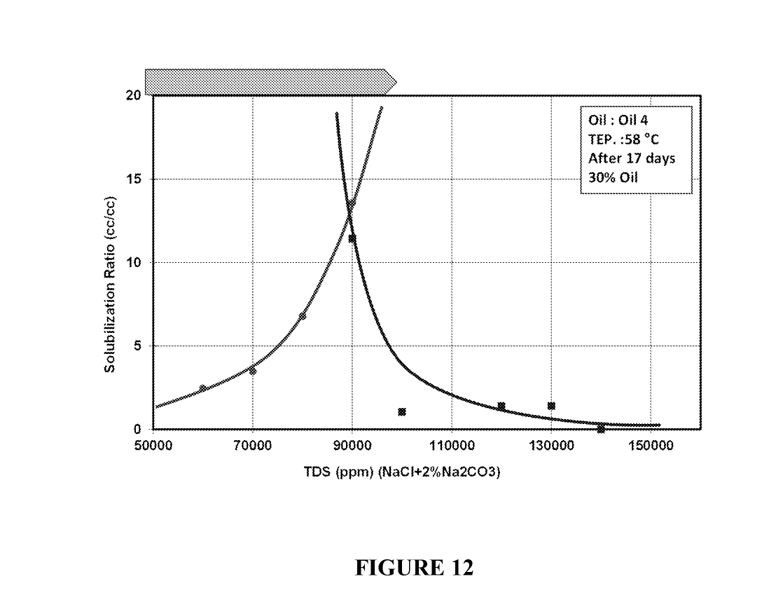

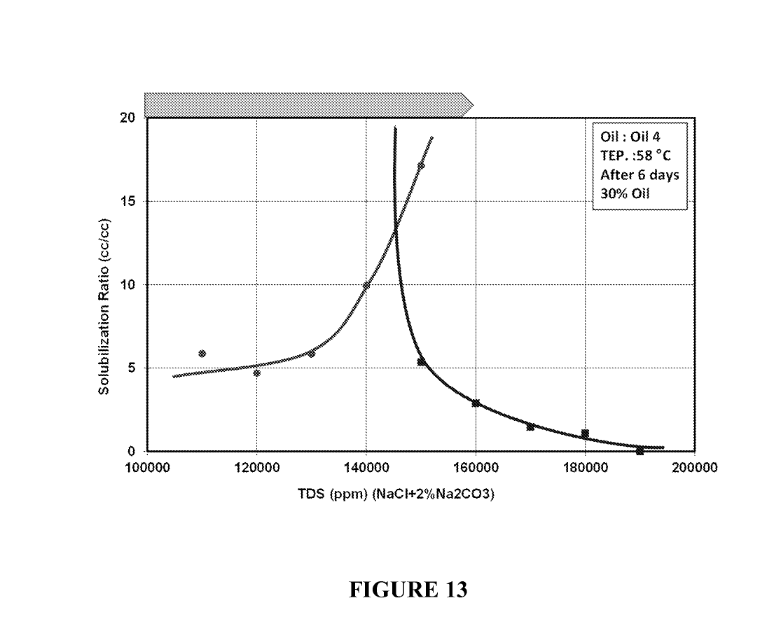

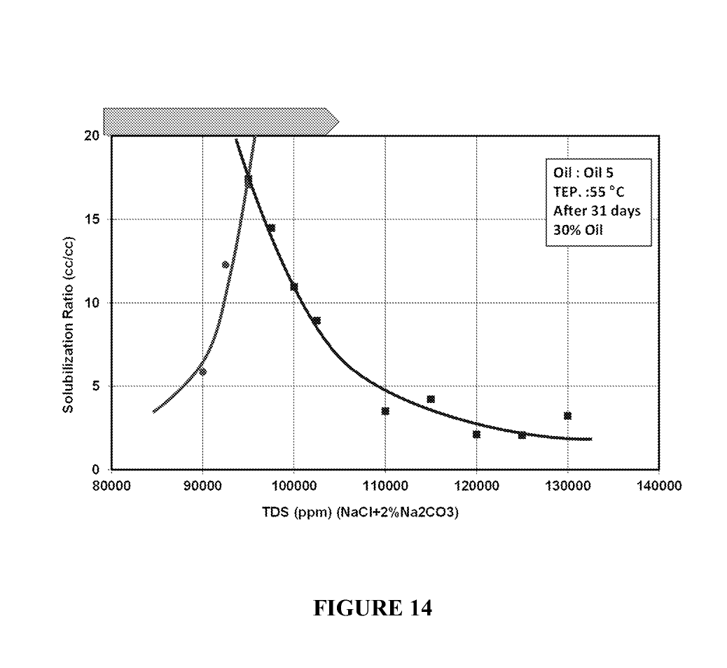

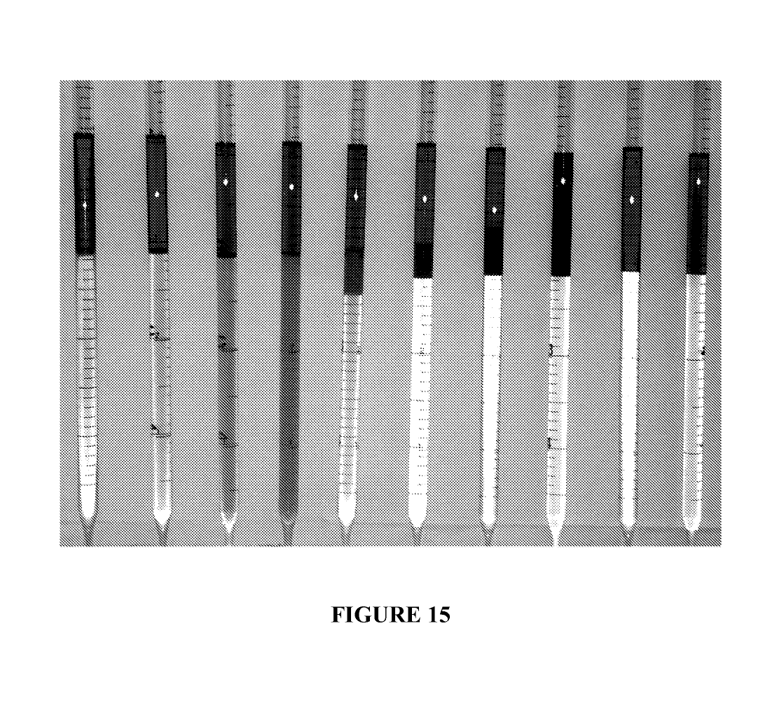

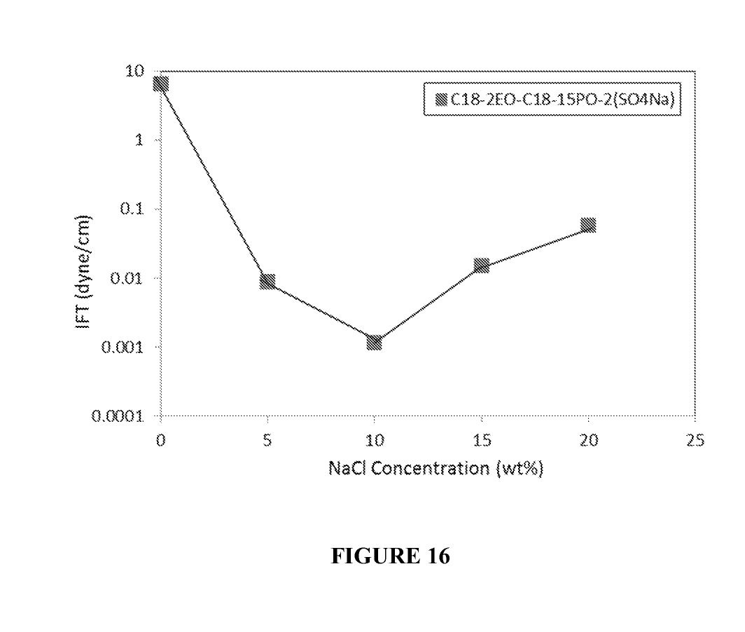

Gemini surfactants are synthesized cost effectively and can be easily scaled up to meet the needs of petroleum industry. The performance of the Gemini surfactants was evaluated using the procedures described below. The results are included in Tables 1-4 below. The CMC value for anionic Gemini surfactant (˜0.001 wt % in pure water at 25° C.) is about two orders of magnitude lower than conventional low molecular weight EOR surfactants. Ultra-low interfacial tension values (˜10-3 dyne/cm or less) were measured at the low surfactant concentration (0.1 wt % 1.0 wt %) by spinning drop tensiometer and Phase Behavior study, even at high temperature (100° C.). Anionic Gemini sulfate surfactants can generate good synergy with large hydrophobe POEO carboxylate or sulfate to promote emulsification of crude oil and good aqueous stability. Anionic Gemini surfactants show the potential application in high salinity reservoir (up to 150,000 ppm to 200,000 ppm TDS. The CMC value for anionic gemini surfactant (˜0.001 wt % in pure water at 25° C.) is about two orders of magnitude lower than conventional surfactants (SDS(C₁₂H₂₅SO₄Na) CMC: 0.23 wt % in pure water at 25° C.) (see FIG. 7A-B).

Phase Behavior Procedures

Phase Behavior Screening: Phase behavior studies have been used to characterize chemicals for EOR. There are many benefits in using phase behavior as a screening method. Phase Behavior studies are used to determine, measure or observe characteristics related to chemical performance such as the following examples but are not limited to these examples: (1) the effect of electrolytes; (2) oil solubilization and IFT reduction, (3) microemulsion densities; (4) microemulsion viscosities; (5) coalescence times; (6) optimal surfactant-co-solvent formulations; and/or (7) optimal properties for recovering oil from cores and reservoirs.

Thermodynamically stable phases can form with oil, water and surfactant mixtures. Surfactants form micellar structures at concentrations at or above the critical micelle concentration (CMC). The emulsion coalesces into a separate phase at the oil-water interface and is referred to as a microemulsion. A microemulsion is a surfactant-rich distinct phase consisting of surfactant, oil and water and possibly co-solvents and other components. This phase is thermodynamically stable in the sense that it will return to the same phase volume at a given temperature. Some workers in the past have added additional requirements, but for the purposes of this engineering study, the only requirement will be that the microemulsion is a thermodynamically stable phase.

The phase transition is examined by keeping all variables fixed except for the scanning variable. The scan variable is changed over a series of pipettes and may include, but is not limited to, salinity, temperature, chemical (surfactant, alcohol, electrolyte), oil, which is sometimes characterized by its equivalent alkane carbon number (EACN), and surfactant structure, which is sometimes characterized by its hydrophilic-lipophilic balance (HLB). The phase transition was first characterized by Winsor (1954) into three regions: Type I— excess oleic phase, Type III—aqueous, microemulsion and oleic phases, and the Type II—excess aqueous phase. The phase transition boundaries and some common terminology are described as follows: Type I to III—lower critical salinity, Type III to II—upper critical salinity, oil solubilization ratio (Vo/Vs), water solubilization ratio (Vw/Vs), the solubilization value where the oil and water solubilization ratios are equal is called the Optimum Solubilization Ratio (σ*), and the electrolyte concentration where the optimum solubilization ratio occurs is referred to as the Optimal Salinity (S*).

Determining Interfacial Tension

Efficient use of time and lab resources can lead to valuable results when conducting phase behavior scans. A correlation between oil and water solubilization ratios and interfacial tension was suggested by Healy and Reed (1976) and a theoretical relationship was later derived by Chun Huh (1979). Lowest oil-water IFT occurs at optimum solubilization as shown by the Chun Huh theory. This is equated to an interfacial tension through the Chun Huh equation, where IFT varies with the inverse square of the solubilization ratio:

$$γ = \frac{C}{{σ}^{2}} \qquad ( 1 )$$

For most crude oils and microemulsions, C=0.3 is a good approximation. Therefore, a quick and convenient way to estimate IFT is to measure phase behavior and use the Chun-Huh equation to calculate IFT. The IFT between microemulsions and water and/or oil can be very difficult and time consuming to measure and is subject to larger errors, so using the phase behavior approach to screen hundreds of combinations of surfactants, co-surfactants, co-solvents, electrolytes, oil, and so forth is not only simpler and faster, but avoids the measurement problems and errors associated with measuring IFT especially of combinations that show complex behavior (gels and so forth) and will be screened out anyway. Once a good formulation has been identified, then it is still a good idea to measure IFT.

Equipment

Phase behavior experiments are created with the following materials and equipment.

Mass Balance: Mass balances are used to measure chemicals for mixtures and determine initial saturation values of cores.

Water Deionizer: Deionized (DI) water is prepared for use with all the experimental solutions using a Nanopure™ filter system. This filter uses a recirculation pump and monitors the water resistivity to indicate when the ions have been removed. Water is passed through a 0.45 micron filter to eliminate undesired particles and microorganisms prior to use.

Borosilicate Pipettes: Standard 5 mL borosilicate pipettes with 0.1 mL markings are used to create phase behavior scans as well as run dilution experiments with aqueous solutions. Ends are sealed using a propane and oxygen flame.

Pipette Repeater: An Eppendorf Repeater Plus® instrument is used for most of the pipetting. This is a handheld dispenser calibrated to deliver between 25 microliter and 1 ml increments. Disposable tips are used to avoid contamination between stocks and allow for ease of operation and consistency.

Propane-oxygen Torch: A mixture of propane and oxygen gas is directed through a Bernz-O-Matic flame nozzle to create a hot flame about/z inch long. This torch is used to flame-seal the glass pipettes used in phase behavior experiments.

Convection Ovens: Several convection ovens are used to incubate the phase behaviors and core flood experiments at the reservoir temperatures. The phase behavior pipettes are primarily kept in Blue M and Memmert ovens that are monitored with mercury thermometers and oven temperature gauges to ensure temperature fluctuations are kept at a minimal between recordings. A large custom built flow oven was used to house most of the core flood experiments and enabled fluid injection and collection to be done at reservoir temperature.

pH Meter: An ORION research model 701/digital ion analyzer with a pH electrode is used to measure the pH of most aqueous samples to obtain more accurate readings. This is calibrated with 4.0, 7.0 and 10.0 pH solutions. For rough measurements of pH, indicator papers are used with several drops of the sampled fluid.

Phase Behavior Calculations

The oil and water solubilization ratios are calculated from interface measurements taken from phase behavior pipettes. These interfaces are recorded over time as the mixtures approached equilibrium and the volume of any macroemulsions that initially formed decreased or disappeared.

Phase Behavior Methodology

The methods for creating, measuring and recording observations are described in this section. Scans are made using a variety of electrolyte mixtures described below. Oil is added to most aqueous surfactant solutions to see if a microemulsion formed, how long it took to form and equilibrate if it formed, what type of microemulsion formed and some of its properties such as viscosity. However, the behavior of aqueous mixtures without oil added is also important and is also done in some cases to determine if the aqueous solution is clear and stable over time, becomes cloudy or separated into more than one phase.

Preparation of samples. Phase behavior samples are made by first preparing surfactant stock solutions and combining them with brine stock solutions in order to observe the behavior of the mixtures over a range of salinities. All the experiments are created at or above 0.1 wt % active surfactant concentration, which is above the typical CMC of the surfactant.

Solution Preparation. Surfactant stocks are based on active weight-percent surfactant (and co-surfactant when incorporated). The masses of surfactant, co-surfactant, co-solvent and de-ionized water (DI) are measured out on a balance and mixed in glass jars using magnetic stir bars. The order of addition is recorded on a mixing sheet along with actual masses added and the pH of the final solution. Brine solutions are created at the necessary weight percent concentrations for making the scans.

Surfactant Stock. The chemicals being tested are first mixed in a concentrated stock solution that usually consisted of a primary surfactant, co-solvent and/or co-surfactant along with de-ionized water. The quantity of chemical added is calculated based on activity and measured by weight percent of total solution. Initial experiments are at about 1-3% active surfactant so that the volume of the middle microemulsion phase would be large enough for accurate measurements assuming a solubilization ratio of at least 10 at optimum salinity.

Polymer Stock. Often these stocks were quite viscous and made pipetting difficult so they are diluted with de-ionized water accordingly to improve ease of handling. Mixtures with polymer are made only for those surfactant formulations that showed good behavior and merited additional study for possible testing in core floods. Consequently, scans including polymer are limited since they are done only as a final evaluation of compatibility with the surfactant.

Pipetting Procedure. Phase behavior components are added volumetrically into 5 ml pipettes using an Eppendorf Repeater Plus or similar pipetting instrument. Surfactant and brine stocks are mixed with DI water into labeled pipettes and brought to temperature before agitation. Almost all of the phase behavior experiments are initially created with a water oil ratio (WOR) of 1:1, which involves mixing 2 ml of the aqueous phase with 2 ml of the evaluated crude oil or hydrocarbon, and different WOR experiments are mixed accordingly. The typical phase behavior scan consisted of 10-20 pipettes, each pipette being recognized as a data point in the series.

Order of Addition. Consideration must be given to the addition of the components since the concentrations are often several folds greater than the final concentration. Therefore, an order is established to prevent any adverse effects resulting from surfactant or polymer coming into direct contact with the concentrated electrolytes. The desired sample compositions are made by combining the stocks in the following order: (1) Electrolyte stock(s); (2) De-ionized water; (3) Surfactant stock; (4) Polymer stock; and (5) Crude oil or hydrocarbon. Any air bubbles trapped in the bottom of the pipettes are tapped out (prior to the addition of surfactant to avoid bubbles from forming).

Initial Observations. Once the components are added to the pipettes, sufficient time is allotted to allow all the fluid to drain down the sides. Then aqueous fluid levels are recorded before the addition of oil. These measurements are marked on record sheets. Levels and interfaces are recorded on these documents with comments over several days and additional sheets are printed as necessary.

Sealing and Mixing. The pipettes are blanketed with argon gas to prevent the ignition of any volatile gas present by the flame sealing procedure. The tubes are then sealed with the propane-oxygen torch to prevent loss of additional volatiles when placed in the oven. Pipettes are arranged on the racks to coincide with the change in the scan variable. Once the phase behavior scan is given sufficient time to reach reservoir temperature (15-30 minutes), the pipettes are inverted several times to provide adequate mixing. Tubes are observed for low tension upon mixing by looking at droplet size and how uniform the mixture appeared. Then the solutions are allowed to equilibrate over time and interface levels are recorded to determine equilibration time and surfactant performance.

Measurements and Observations. Phase behavior experiments are allowed to equilibrate in an oven that is set to the reservoir temperature for the crude oil being tested. The fluid levels in the pipettes are recorded periodically and the trend in the phase behavior observed over time. Equilibrium behavior is assumed when fluid levels ceased to change within the margin of error for reading the samples.

Fluid Interfaces. The fluid interfaces are the most crucial element of phase behavior experiments. From them, the phase volumes are determined and the solubilization ratios are calculated. The top and bottom interfaces are recorded as the scan transitioned from an oil-in-water microemulsion to a water-in-oil microemulsion. Initial readings are taken one day after initial agitation and sometimes within hours of agitation if coalescence appeared to happen rapidly. Measurements are taken thereafter at increasing time intervals (for example, one day, four days, one week, two weeks, one month and so on) until equilibrium is reached or the experiment is deemed unessential or uninteresting for continued observation.

TABLE 1A
Phase Behavior Data Summary.

| | | | Optimal | Aqueous | |
|---|---|---|---|---|---|
| Surfactant | | | Salinity¹ | Stability¹ | |
| Formulation | Oil | Temp. | (ppm TDS) | (ppm TDS) | Activity² |
| 0.8% C₁₈—2EO—C₁₈—10PO—2(SO₄Na) + | Oil 1 | 100° C. | 70,000 | 75,000 | 12 |
| 0.2% C₂₈45PO30EO-carboxylate | | | | | |
| 0.8% C₁₈—2EO—C18—10PO—2(SO₄Na) + | Oil 2 | 78° C. | 74,500 | 90,000 | 14 |
| 0.2% C₂₈45PO30EO-carboxylate | | | | | |
| 1.0% C₁₈—2EO—C₁₈—10PO—2(SO₄Na) | Oil 3 | 58° C. | 68,000 | 85,000 | 20 |

¹wt % NaCl + 2(wt % Na₂CO₃)
²Solubilization Ratio

TABLE 1B
Phase Behavior Data Summary.

| | | | Optimal | Aqueous | |
|---|---|---|---|---|---|
| Surfactant | | | Salinity¹ | Stability¹ | |
| formulation | Oil | Temp. | (ppm TDS) | (ppm TDS) | Activity² |
| 0.8% C₁₈—2EO—C₁₈—10PO—2(SO₄Na) + | Oil 4 | 58° C. | 95,000 | 100,000 | 12 |
| 0.2% C₂₈45PO30EO-carboxylate + | | | | | |
| 0.5% IBA | | | | | |
| 0.8% C₁₈—2EO—C₁₈—10PO—2(SO₄Na) + | Oil 4 | 58° C. | 90,000 | 100,000 | 13 |
| 0.2% C_{16/16}—35PO—20EO Sulfate + | | | | | |
| 0.5% IBA | | | | | |
| 0.8% C₁₈—2EO—C₁₈—5PO—2(SO₄Na) + | Oil 4 | 58° C. | 146,000 | 160,000 | 13 |
| 0.2% C₂₈45PO30EO-carboxylate + | | | | | |
| 0.5% IBA | | | | | |
| 0.8% C₁₈—2EO—C₁₈—10PO—2(SO₄Na) + | Oil 5 | 55° C. | 95,000 | 105,000 | 17.5 |
| 0.2% C₂₈45PO30EO-carboxylate + | | | | | |
| 0.5% IBA | | | | | |

¹wt % NaCl + 2(wt % Na₂CO₃)
²Solubilization Ratio

TABLE 2A
Synergy Study between Gemini Disulfate and Large Hydrophobe
POEO Carboxylate or Sulfate.

| | | | Optimal | Aqueous | |
|---|---|---|---|---|---|
| Surfactant | | | Salinity¹ | Stability¹ | |
| Formulation | Oil | Temp. | (ppm TDS) | (ppm TDS) | Activity² |
| 0.8% C₁₈—2EO—C₁₈—10PO—2(SO₄Na) + | Oil 2 | 78° C. | 74,500 | 90,000 | 14 |
| 0.2% C₂₈45PO30EO-carboxylate | | | | | |
| 1.0% C18—2EO—C18—10PO—2(SO₄Na) | Oil 2 | 78° C. | 79,000 | 60,000 | 5.2 |

¹wt % NaCl + 2(wt % Na₂CO₃)
²Solubilization Ratio

TABLE 2B
Synergy Study between Gemini Disulfate and Large Hydrophobe POEO Carboxylate or Sulfate.

| | | | Optimal | Aqueous | |
|---|---|---|---|---|---|
| Surfactant | | | Salinity¹ | Stability¹ | |
| Formulation | Oil | Temp. | (ppm TDS) | (ppm TDS) | Activity² |
| 0.8% C₁₈—2EO—C₁₈—10PO—2(SO₄Na) + | Oil 4 | 58° C. | 95,000 | 100,000 | 12 |
| 0.2% C₂₈45PO30EO-carboxylate + | | | | | |
| 0.5% IBA | | | | | |
| 0.8% C₁₈—2EO—C₁₈—10PO—2(SO₄Na) + | Oil 4 | 58° C. | 90,000 | 100,000 | 13 |
| 0.2% C_{16/16}—35PO—20EO Sulfate + | | | | | |
| 0.5% IBA | | | | | |
| 1.0% C₁₈—2EO—C₁₈—10PO—2(SO₄Na) | Oil 4 | 58° C. | 115,000 | 85,000 | 6.1 |

¹wt % NaCl + 2(wt % Na₂CO₃)
²Solubilization Ratio

TABLE 3A

| | | | Optimal | Aqueous | |
|---|---|---|---|---|---|
| Surfactant | | | Salinity¹ | Stability¹ | |
| formulation | Oil | Temp. | (ppm TDS) | (ppm TDS) | Activity² |
| 0.8% C₁₈—2EO—C₁₈—10PO—2(SO₄Na) + | Oil 1 | 100° C. | 78,000 | 80,000 | 11 |
| 0.2% C₂₈45PO30EO-carboxylate | | | | | |
| 0.8% C₁₈—2EO—C₁₈—10PO—2(SO₄Na) + | Oil 2 | 78° C. | 75,000 | 95,000 | 14 |
| 0.2% C₂₈45PO30EO-carboxylate | | | | | |
| 1.0% C₁₈—2EO—C₁₈—10PO—2(SO₄Na) | Oil 3 | 58° C. | 67,000 | 85,000 | 18 |

¹wt % NaCl + 2(wt % Na₂CO₃)
²Solubilization Ratio

TABLE 3B

| | | | Optimal | Aqueous | |
|---|---|---|---|---|---|
| Surfactant | | | Salinity¹ | Stability¹ | |
| formulation | Oil | Temp. | (ppm TDS) | (ppm TDS) | Activity² |
| 0.8% C₁₈—2EO—C₁₈—10PO—2(SO₄Na) + | Oil 4 | 58° C. | 95,000 | 100,000 | 13 |
| 0.2% C₂₈45PO30EO-carboxylate + | | | | | |
| 0.5% IBA | | | | | |
| 0.8% C₁₈—2EO—C₁₈—10PO—2(SO₄Na) + | Oil 4 | 58° C. | 90,000 | 100,000 | 12.5 |
| 0.2% C_{16/16}—35PO—20EO Sulfate + | | | | | |
| 0.5% IBA | | | | | |
| 0.8% C₁₈—2EO—C₁₈—10PO—2(SO₄Na) + | Oil 5 | 55° C. | 96250 | 105,000 | 14 |
| 0.2% C₂₈45PO30EO-carboxylate + | | | | | |
| 0.5% IBA | | | | | |

TABLE 4
List of Synthetic Oils

| Oil 1 | Oil 2 | Oil 3 | Oil 4 | Oil 5 |
|---|---|---|---|---|
| CN-LY | SA98T + | LC2343 + | Weiler- | CHSN 372 |
| 179 | 10% Toluene | 18.7% | BrooksHopper#1 | |
| | | Cyclohexane | | |

### Example 2

### Gemini-3 ASP Coreflood Experiments

Summary

The purpose of Gemini-3 ASP coreflood experiment was to measure the retention of a Gemini surfactant in Berea sandstone (relatively higher clay content, lower permeability) and compare the results with aGemini-2 Bentheimer coreflood using the same oil.

The phase behavior experiments were done with Loudon oil (20% toluene diluted) at 60° C. The surfactant formulation is 0.5 wt. % C₁₈-2EO—C₁₈-10PO-disulfate, 0.5 wt. % branched C₁₂₋₁₃-7PO sulfate, and 1.0 wt. % DIPA 5EO. The brine used for the salinity scan included sodium chloride and 20,000 ppm sodium carbonate. The optimal salinity was around 35,000 ppm TDS with 30% oil concentration (15,000 ppm sodium chloride and 20,000 ppm sodium carbonate). The aqueous stability was 40,313 ppm TDS with 2,500 ppm FP 3330 polymer (20,313 ppm sodium chloride and 20,000 ppm sodium carbonate). The waterflood salinity was 50,000 ppm TDS. Polymer drive salinity was 24,500 ppm NaCl.

The coreflood produced 91.3% recovery of the waterflood residual oil. The Sore was 0.025. The total surfactants retention was 0.103 mg/g, which was about 34.6% of the surfactants injected.

The pH, salinity, and viscosity were propagated through the core successfully.

The pressure drops of sections 3 and 4 were not reached a steady state. As a result, the whole pressure was kept increasing during the chemical flood.

Tables 5 and 6 show the composition of the ASP solution in the Gemini-3 Berea coreflood.

TABLE 5
Composition of ASP slug.

| Parameter | Description |
|---|---|
| PV | 0.3 |
| C18—2EO—C18—10PO—2(SO₄Na) (wt. %) | 0.5 |
| Branched C12-13—7PO sulfate (Enordet J771) | 0.5 |
| DIPA 5EO (wt. %) | 1 |
| FP 3330 Polymer (ppm) | 2600 |
| Sodium chloride (ppm) | 15,000 |
| Sodium carbonate (ppm) | 20,000 |
| pH | 11.8 |
| Sodium dithionite (ppm) | 500 |
| ORP (R · mV) | −660 |
| Frontal Velocity (ft/day) | 1 |
| Viscosity (cp) at 12.5 s⁻¹, 60° C. | 13 |
| Filtration ratio | 1.07 |
| TDS (ppm) | 35,500 |

TABLE 6
Composition of Polymer drive.

| Parameter | Description |
|---|---|
| PV | ~2.5 |
| FP 3330 (ppm) | 2400 |
| Sodium chloride (ppm) | 24,000 |
| pH | 6.8 |
| Sodium dithionite (ppm) | 500 |
| ORP (R · mV) | −574 |
| Frontal Velocity (ft/day) | 1 |
| Viscosity (cp) at 12.5 s⁻¹, 60° C. | 11 |
| Filtration Ratio | 1.15 |
| TDS (ppm) | 24,500 |

Phase Behavior and Aqueous Stability Experiments

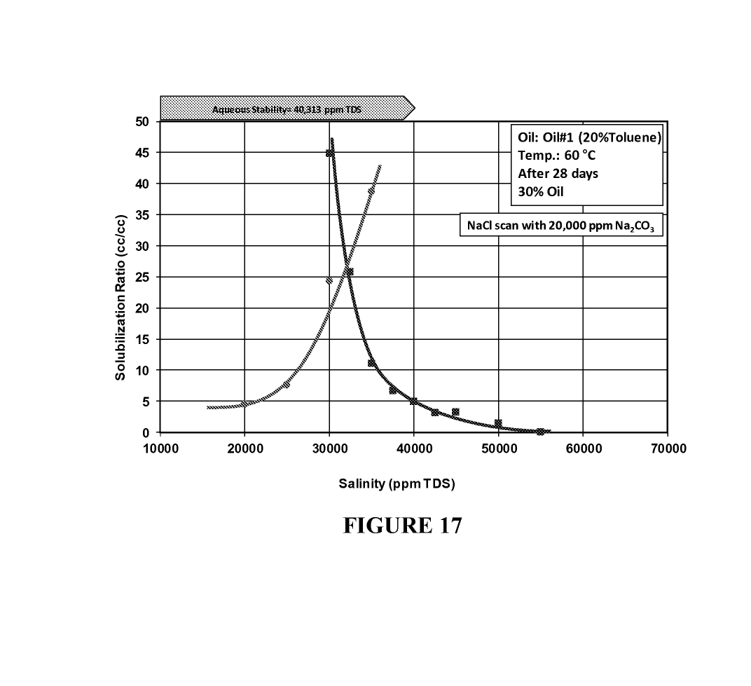

The phase behavior of the Gemini surfactant formulation composed of 0.5 wt. % C₁₈-2EO—C₁₈-10PO-disulfate, 0.5 wt. % branched C₁₂₋₁₃-7PO sulfate (Enordet J771), and 1.0 wt. % DIPA 5EO was studied using a NaCl scan with 20,000 ppm Na₂CO₃ at 60° C. The optimal salinity was determined by emulsion test and is around 35,000 ppm TDS with 30% oil concentration (15,000 ppm NaCl and 20,000 ppm Na₂CO₃). The solubilization data after 28 days are shown in FIG. 17. The aqueous solution composed of the Gemini surfactant formulation with 2,500 ppm Flopaam 3330 was cleared up to 40,313 ppm TDS.

Core Flood Procedure:

Berea sandstone of 1.47 inch diameter was used in this core flood. The length of the core was 29.5 cm.

The core was initially sealed into a stainless steel core holder. A confined pressure of 1000 psi was then applied.

The core was evacuated by vacuum pump for about 1-1½ hours and checked for leaks.

The core was saturated with 20,000 ppm NaCl brine.

The core was then flooded with 20,000 ppm NaCl brine at 5 mL/min.

A tracer test was conducted by displacing the 20,000 ppm NaCl with 60,000 ppm restoration brine (1% sodium dithionite, 1% EDTA, and 4% NaHCO₃ in DI water) at a flow rate of 4 mL/min and measuring salinity of the effluents. The pore volume and heterogeneity in the core were determined from the tracer test.

The core was restored by injection of 1% sodium dithionite, 1% EDTA, and 4% NaHCO₃ in DI water (restoration brine). The iron concentration with 1% sodium dithionite and 4% NaHCO₃ was 0.2 ppm at the end of the restoration process.

The restoration brine was displaced by about 5 pore volumes of 50,000 ppm NaCl with 1000 ppm sodium dithionite.

The core was placed in a 60° C. oven and allowed to equilibrate.

Loudon oil (diluted with 20% toluene) was injected at a constant pressure of ˜86 psi and at 60° C. and the residual water saturation was measured.

50,000 ppm NaCl solution containing 1000 ppm sodium dithionite was injected at a flow rate of 5 ft/day at 60° C. until 99% water cut was achieved.

0.3 PV of ASP slug with 500 ppm sodium dithionite was injected at 1 ft/day at 60° C.

The ASP slug was followed by polymer drive with 500 ppm sodium dithionite at 1 ft/day at 60° C.

Oil recovery and surfactant retention were analyzed. In addition, the pH of every 2^{nd} sample was tested, and the viscosities of the produced aqueous effluent samples was measured.

Salinity was also measured using the portable refractometer.

Core Data

The properties of the core are described below.

| Core | Berea | |
|---|---|---|
| Mass | 687.2 | g |
| Porosity | 0.22 | |
| Length | 29.5 | cm |
| Length to Tap 1 | 7.62 | cm |
| Length to Tap 2 | 15.24 | cm |
| Length to Tap 3 | 22.86 | cm |
| Length to Outlet | 29.4 | cm |
| Diameter | 3.73 | cm |
| Area | 10.95 | cm² |
| Temperature | 60° | C. |
| Brine permeability | 210 | mD |
| PV | 67.7 | mL |

Brineflood Before Restoration

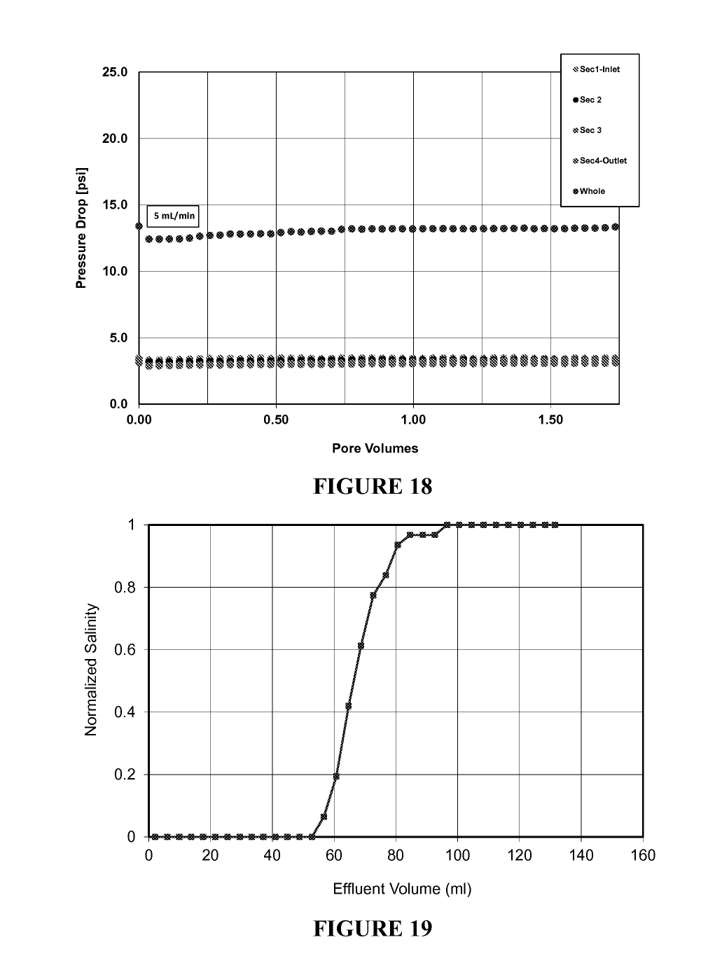

A 20,000 ppm NaCl solution was injected at 5 mL/min (99.58 ft/day) to measure the brine permeability before the core restoration. Table 7 includes the brine permeability calculated for each section of the core. The pressure drop data is illustrated in FIG. 18.

TABLE 7
Brine Permeability Before Restoration.

| Core Section | Permeability (mD) |
|---|---|
| Whole core | 250 |
| Section 1 - Inlet | 242 |
| Section 2 | 252 |
| Section 3 | 273 |
| Section 4 - Outlet | 241 |

Salinity Tracer Test

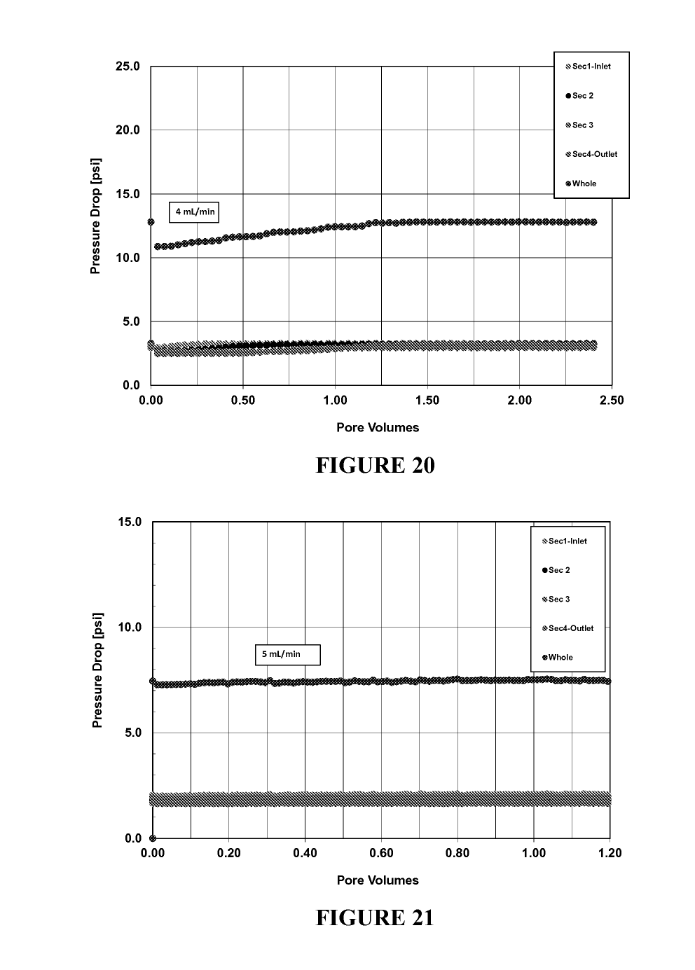

A salinity tracer test was conducted by displacing the 20,000 ppm NaCl with 60,000 ppm restoration brine (1% sodium dithionite, 1% EDTA, and 4% NaHCO₃ in DI water) at a flow rate of 4 ml/min. The effluents were collected as 4 ml/tube and the salinity in each tube was measured using a portable refractometer. The salinity profile during the tracer test is shown in FIG. 19 and pressure drop of tracer test are shown in FIG. 20. The pore volume after correcting 2 mL for dead volume was 67.7 mL.

Core Restoration

About twelve pore volumes of 1% sodium dithionite, 1% EDTA, and 4% NaHCO₃ in DI was injected at room temperature into the core at 5 ft/day and the iron concentration in the effluent was monitored. The iron concentration was 100 ppm after 12 pore volumes of 1% sodium dithionite, 1% EDTA, and 4% NaHCO₃. Then a solution of 1% sodium dithionite and 4% NaHCO₃ in DI was injected. The injection of restoration solution without EDTA was stopped when the concentration of iron was reached and stable at 0.2 ppm.

About 5 PV of a 50,000 ppm NaCl solution with 1000 ppm sodium dithionite was injected at 5 mL/min to displace the restoration brine at room temperature. Then the temperature was increased to 60° C. The brine permeability of the core was measured at 60° C. with 50,000 ppm NaCl after restoration.

A 50,000 ppm NaCl solution was injected at 5 mL/min to measure the brine permeability after restoration. Table 8 presents the brine permeability calculated for each section of the core. The pressure drop data is presented in FIG. 21.

TABLE 8
Brine permeability after restoration.

| Core Section | Permeability (mD) |
|---|---|
| Whole core | 210 |
| Section 1 - Inlet | 191 |
| Section 2 | 218 |
| Section 3 | 239 |
| Section 4 - Outlet | 194 |

Oil Flood

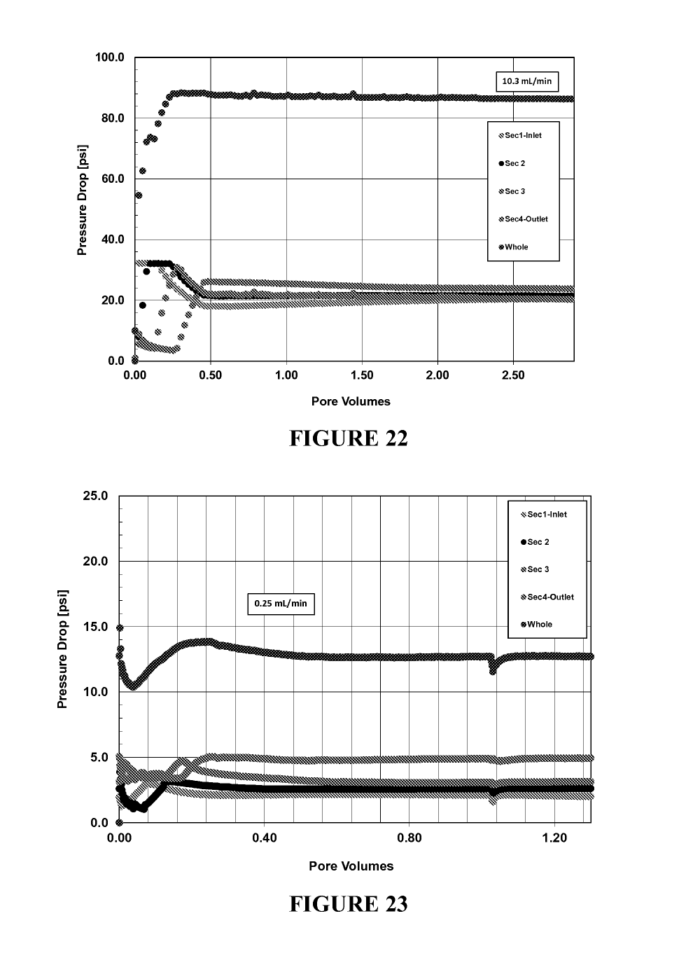

The oil flood was conducted using Loudon oil (diluted with 20% toluene) (filtered through 0.45 micron cellulose filter paper) at 86 psi, 60° C. The viscosity of the oil at 60° C. was 2 cP. Table 9 presents the oil permeability measured for each section of the core, and Table 10 summarizes of the oil flood. The pressure drop data during the oil flood is given in FIG. 22.

TABLE 9
Oil permeability measured for each section of the core.

| Core Section | Permeability (mD) |
|---|---|
| Whole core | 157 |
| Section 1 - Inlet | 167 |
| Section 2 | 160 |
| Section 3 | 170 |
| Section 4 - Outlet | 135 |

TABLE 10
Summary of the oil flood.

| Experiment | Gemini-3 |
|---|---|
| Sₒᵢ | 0.62 |
| S_{wr} | 0.38 |
| kₒ | 157 mD |
| kᵣₒ | 0.76 |

### Gemini-3 Water Flood

The core was then water flooded at 5 ft/day with 50,000 ppm NaCl with 1000 ppm sodium dithionite at 60° C. The pressure drop data during the water flood is given below in FIG. 23. Table 11 presents the water permeability for each section of the core and Table 12 presents the summary of the water flood.

TABLE 11
Water flood permeability measured for each section of the core.

| Core Section | Permeability (mD) |
|---|---|
| Whole core | 6 |
| Section 1 - Inlet | 9 |
| Section 2 | 8 |
| Section 3 | 6 |
| Section 4 - Outlet | 4 |

TABLE 12
Summary of the water flood.

| Experiment | Gemini-3 |
|---|---|
| S_{orw} | 0.29 |
| k_{w} | 6 mD |
| k_{rw} | 0.03 |

Polymer Viscosity Data

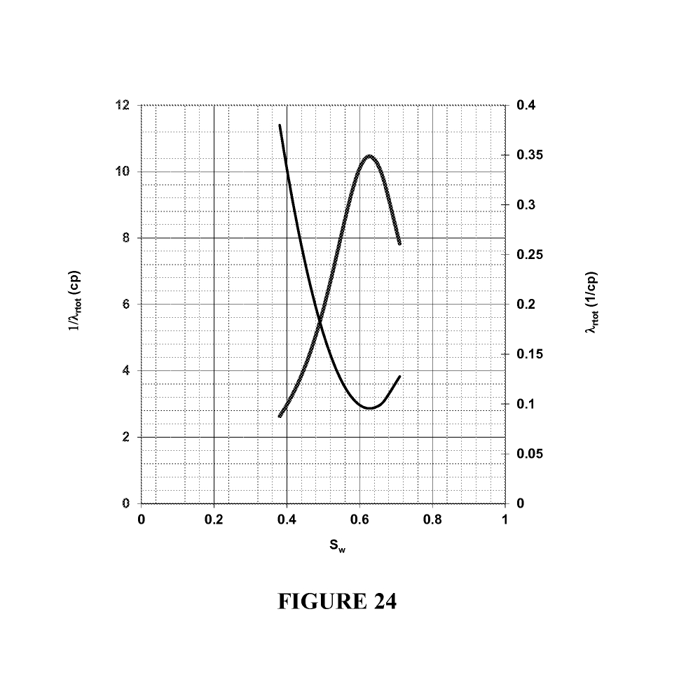

The viscosity needed in the ASP slug and polymer drives was determined by fluid mobility calculations using endpoint oil and water relative permeabilities and residual fluid saturations obtained from the oil flood and water flood results. The total relative mobility and its inverse, the apparent viscosity, were calculated at various fluid saturations to determine the viscosity required for a stable displacement of the oil bank. FIG. 24 shows a peak of approximately 10.5 cP for the inverse total mobility plot. The data used to calculate total relative mobility curve in FIG. 24 is included below.

| | |
|---|---|
| k_{rw}^{o} | 0.06 |
| kᵣₒ^{o} | 0.76 |
| n_{w} | 2 |
| nₒ | 2 |
| S_{wr} | 0.38 |
| Sₒᵣ | 0.29 |
| μ_{w} | 0.47 cP |
| μₒ | 2 cP |

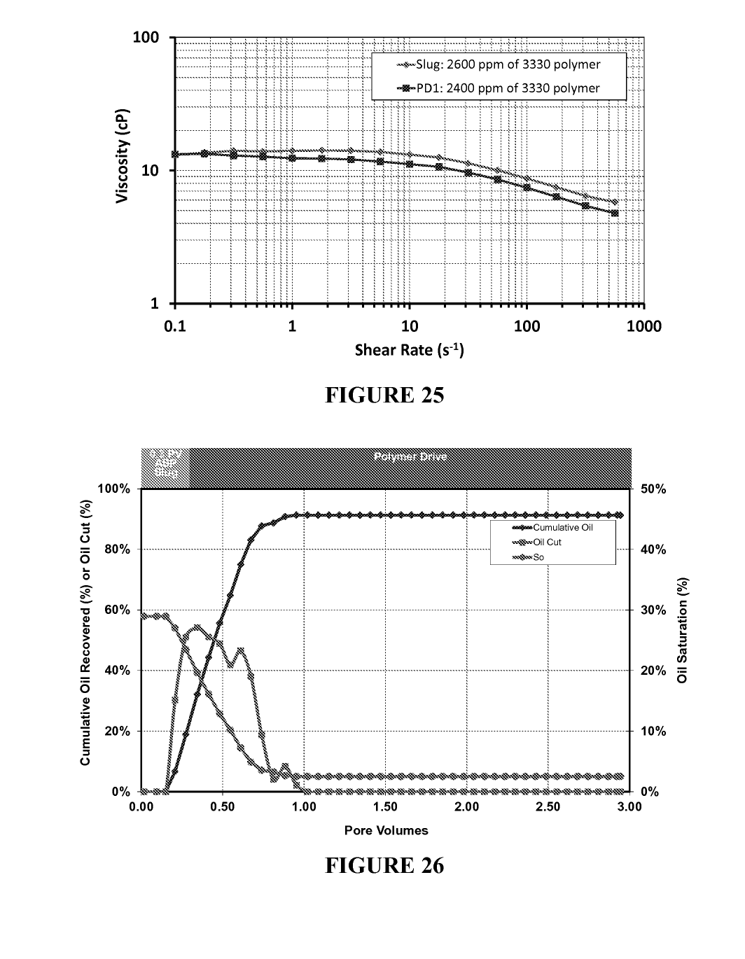

The shear rate of the core was calculated to be 12.5 s⁻¹. FIG. 25 shows the viscosity curves for slug and the polymer drive.

Chemical Flood

0.3 PV of ASP slug was injected at 0.048 mL/min (1 ft/day) followed by polymer drive at the same rate. The 4.56 mL effluent samples were collected at room temperature. The fluid levels in the samples were measured after centrifuging for 10 minutes at 2000 rpm and heating to 60° C.

Oil Recovery

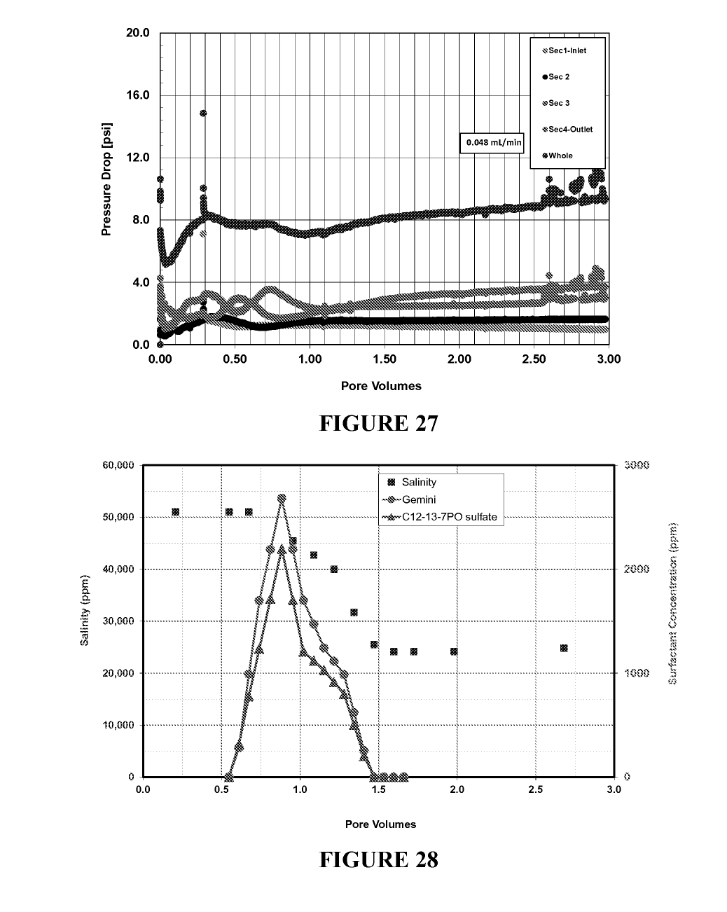

The final oil recovery was 91.3% of the waterflood residual oil and the Sore was 0.025 (FIG. 26). The pressure drop data are shown in FIG. 27.

Surfactants Retention

Surfactants of the effluent samples were extracted with 1% bleach with 10% iso-propanol solution in DI water. Extracted aqueous phases were analyzed using Dionex 3000 UHPLC attached to Agilent 1260 ELSD.

The total surfactants retention was 0.103 mg/g, which was about 34.6% of the surfactants injected. The C₁₈-2EO—C₁₈-10PO disulfate retention was 0.040 mg/g. The TDA-7PO sulfate retention was 0.063 mg/g (FIG. 28).

Salinity of Effluent

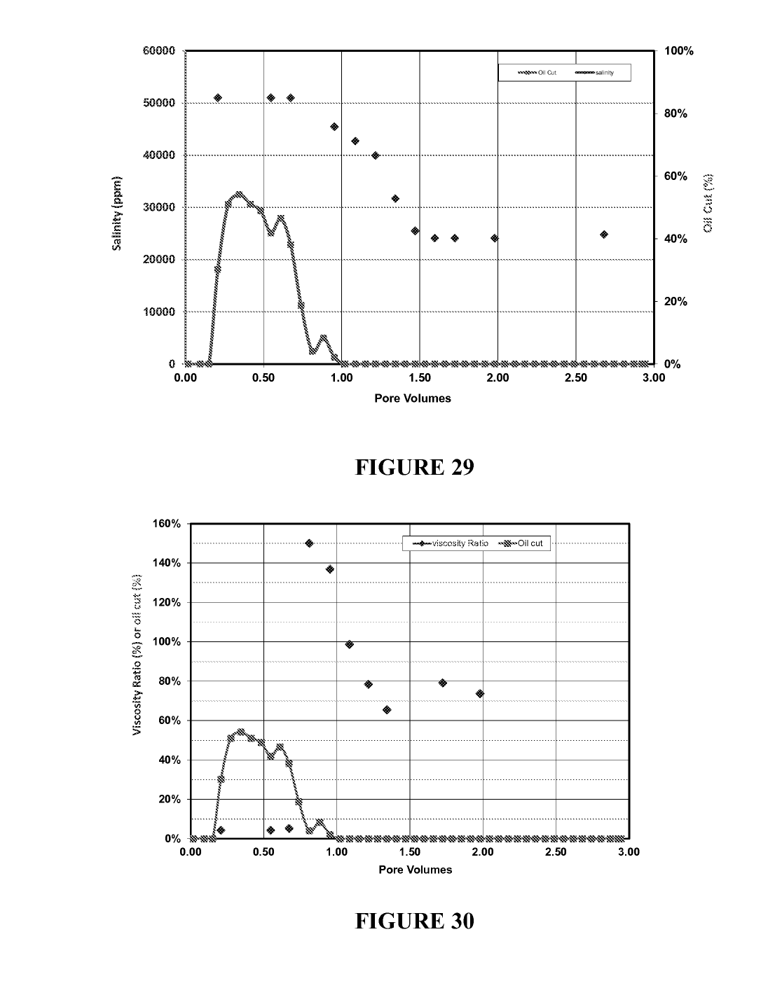

The salinity of the effluent samples is shown in the FIG. 29.

Viscosity and pH of Effluent

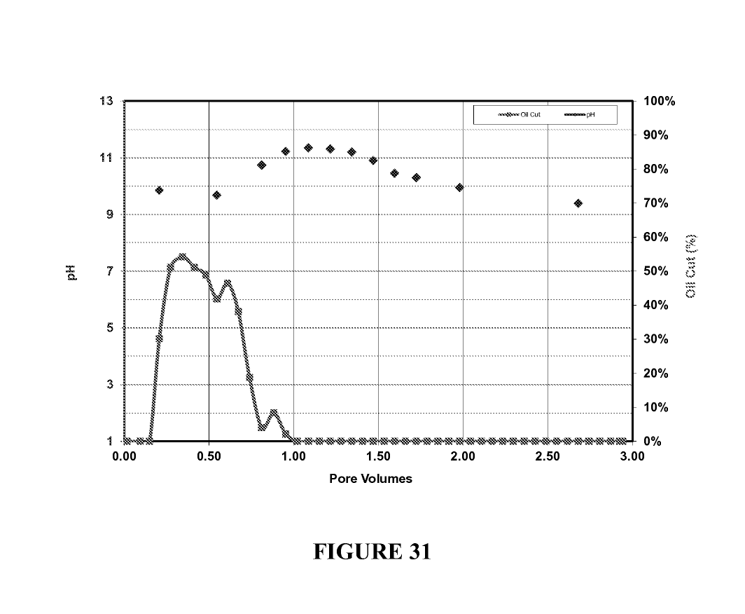

The viscosity was propagated successfully (FIG. 30) and no severe polymer degradation was observed during the chemical flood. The relatively higher viscosity at ˜0.9 PV is due to the polymer hydrolysis at higher pH. FIG. 31 is plot of the pH of the effluent during the chemical flood.

### CONCLUSION

The Gemini-3 ASP coreflood was successful. The ASP formulation with 0.5 wt % C₁₈-2EO—C₁₈-10PO-disulfate, 0.5 wt. % branched C₁₂₋₁₃-7PO sulfate, and 1.0 wt. % DIPA 5EO reduced the oil saturation from 29% to 2.5% and the waterflood residual oil recovery was 91.3%. The Gemini surfactant can successfully work in relatively higher clay content and lower permeable porous media like Berea sandstones (the Gemini-2 coreflood was performed in a Bentheimer rock, produced 95% residual oil recovery after waterflood and the Sore was 1.3%).

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of“comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

1. A compound having the formula: 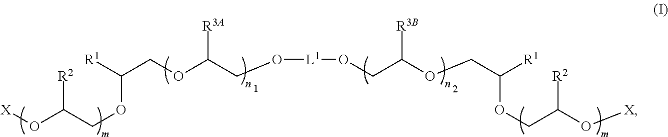
wherein
R¹ is substituted or unsubstituted alkyl, substituted or unsubstituted heteroalkyl, substituted or unsubstituted cycloalkyl, substituted or unsubstituted heterocycloalkyl, substituted or unsubstituted aryl or substituted or unsubstituted heteroaryl;
R² is hydrogen or substituted or unsubstituted alkyl;
R^{3A} and R^{3B} are independently hydrogen or substituted or unsubstituted alkyl;
L¹ is substituted or unsubstituted alkylene, substituted or unsubstituted cycloalkylene or substituted or unsubstituted arylene;
m is an integer of 1 to 200;
n₁ and n₂ are independently integers from 0 to 20;
X is —SO₃⁻M+, —CH₂C(O)O⁻M⁺, —SO₃H or —CH₂C(O)OH; and
M⁺ is a monovalent, divalent or trivalent cation.

2. The compound of claim 1, wherein R¹ is R¹⁰-substituted or unsubstituted alkyl, R⁴-substituted or unsubstituted heteroalkyl, R⁴-substituted or unsubstituted aryl or R⁴ substituted or unsubstituted cycloalkyl;
R⁴ is R⁵-substituted or unsubstituted C₁-C₅₀ alkyl, R⁵-substituted or unsubstituted heteroalkyl, R⁵-substituted or unsubstituted aryl or R⁵-substituted or unsubstituted cycloalkyl;
R⁵ is R⁶-substituted or unsubstituted C₁-C₅₀ alkyl, R⁶-substituted or unsubstituted heteroalkyl, R⁶-substituted or unsubstituted aryl or R⁶-substituted or unsubstituted cycloalkyl;
R⁶ is R⁷-substituted or unsubstituted C₁-C₅₀ alkyl, R⁷-substituted or unsubstituted heteroalkyl, R⁷-substituted or unsubstituted aryl or R⁷-substituted or unsubstituted cycloalkyl;
R⁷ is R⁸-substituted or unsubstituted C₁-C₅₀ alkyl, R⁸-substituted or unsubstituted heteroalkyl, R⁸-substituted or unsubstituted heteroalkyl, R⁸-substituted or unsubstituted aryl or R⁸-substituted or unsubstituted cycloalkyl;
R⁸ is R⁹-substituted or unsubstituted C₁-C₅₀ alkyl, R⁹-substituted or unsubstituted heteroalkyl, R⁹-substituted or unsubstituted aryl or R⁹-substituted or unsubstituted cycloalkyl;
R⁹ is unsubstituted C₁-C₅₀ alkyl, unsubstituted heteroalkyl, unsubstituted aryl or unsubstituted cycloalkyl; and
R¹⁰ is unsubstituted heteroalkyl, unsubstituted aryl or unsubstituted cycloalkyl.

3. (canceled)

4. The compound of claim 1, wherein R¹ is branched or linear unsubstituted C₈-C₅₀ alkyl.

5. (canceled)

6. The compound of claim 1, wherein R¹ is branched unsubstituted C₁₀-C₅₀ alkyl.

7. (canceled)

8. (canceled)

9. (canceled)

10. (canceled)

11. (canceled)

12. The compound of claim 1, wherein R² is hydrogen or methyl.

13. The compound of claim 1, wherein R^{3A} and R^{3B} are independently hydrogen or substituted or unsubstituted C₁-C₄ alkyl.

14. (canceled)

15. The compound of claim 1, wherein L¹ is substituted or unsubstituted C₂-C₄ alkylene.

16. (canceled)

17. (canceled)

18. (canceled)

19. The compound of claim 1, wherein L¹ is substituted or unsubstituted C₆-C₁₅ cycloalkylene or substituted or unsubstituted C₆-C₁₅ arylene.

20. (canceled)

21. The compound of claim 1, wherein m is 10 to 50.

22. The compound of claim 1, wherein n₁ and n₂ are independently 0 or 1.

23. The compound of claim 1, wherein M⁺ is Na⁺, K⁺, NH₄, Ca⁺², Mg⁺² or Ba⁺².

24. The compound of claim 1 having the formula: 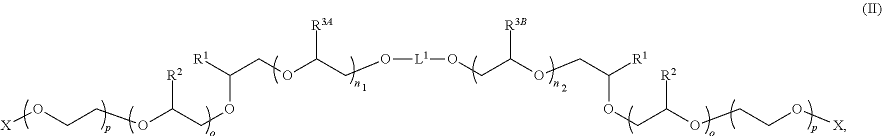
wherein
o is an integer from 1 to 100; and
p is an integer from 0 to 100.

25. The compound of claim 1 having the formula: 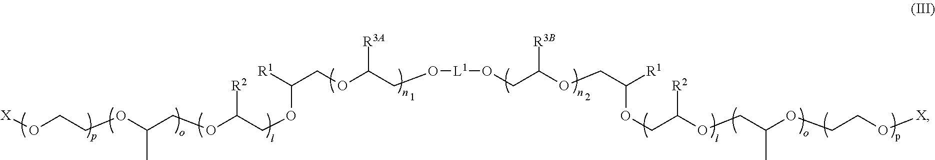
wherein
o is an integer from 1 to 50;
p is an integer from 0 to 50; and
l is an integer from 0 to 50.

26. The compound of claim 1 having the formula: 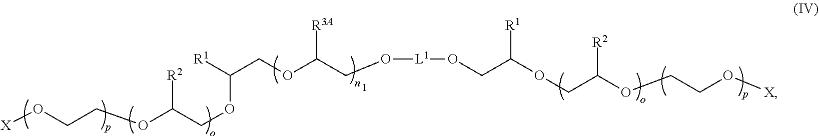
wherein
o is an integer from 1 to 100; and
p is an integer from 0 to 100.

27. (canceled)

28. (canceled)

29. The compound of claim 26, wherein n₁ is 1.

30. (canceled)

31. (canceled)

32. An aqueous composition comprising a co-surfactant and a compound of claim 1.

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. An emulsion composition comprising an unrefined petroleum phase and a compound of claim 1.

52. (canceled)

53. (canceled)

54. (canceled)

55. (canceled)

56. A method of displacing an unrefined petroleum material in contact with a solid material, said method comprising:
(i) contacting an unrefined petroleum material with an aqueous composition comprising water, a co-surfactant and a compound of claim 1, wherein said unrefined petroleum material is in contact with a natural solid material;
(ii) allowing said unrefined petroleum material to separate from said solid material thereby displacing said unrefined petroleum material in contact with said solid material.

57. (canceled)

58. (canceled)

59. (canceled)

60. (canceled)

61. (canceled)

62. (canceled)

63. (canceled)

64. (canceled)

65. (canceled)

66. (canceled)

67. A method of converting an unrefined petroleum acid into a surfactant, said method comprising:
(i) contacting a petroleum material with an aqueous composition thereby forming an emulsion in contact with said petroleum material, wherein said aqueous composition comprises a compound of claim 1 and a co-surfactant;
(ii) allowing an unrefined petroleum acid within said unrefined petroleum material to enter into said emulsion, thereby converting said unrefined petroleum acid into a surfactant.

68. (canceled)

69. A method of making a compound of claim 1, the method comprising:
contacting an epoxide compound with a diol thereby forming an epoxide-diol mixture;
increasing the temperature of said epoxide-diol mixture thereby forming an epoxide-diol adduct;
contacting said epoxide-diol adduct with a C₁-C₄ alkoxide thereby forming an alkoxylated hydrophobe; and
contacting said alkoxylated hydrophobe with one or more anionic functional groups thereby forming said compound.
